(19) United States
(12) Patent Application Publication
(10) Pub. No.: US 2026/0255333 A1
(43) Pub. Date: Aug. 27, 2026

(54) CAPABILITY SIGNALING FOR DOWNLINK AND UPLINK CARRIERS AND CELLS IN DIFFERENT FREQUENCY BANDS

(71) Applicant: QUALCOMM Incorporated, San Diego, CA (US)

(72) Inventors: Kazuki TAKEDA, Minato-ku (JP); Peter GAAL, San Diego, CA (US); Yiqing CAO, Beijing (CN)

(21) Appl. No.: 19/159,558

(22) PCT Filed: May 26, 2023
(86) PCT No.: PCT/CN2023/096450

§ 371 Date: Aug. 25, 2025

(30) Foreign Application Priority Data
Apr. 11, 2023 (WO) PCT/CN2023/087464

(51) Int. Cl. H04W 72/0453; H04L 5/00

(52) U.S. Cl. CPC H04W 72/0453; H04L 5/001

(57) ABSTRACT

Methods, systems, and devices for wireless communication are described. A network node may transmit capability information indicating a capability of the network node to communicate using an uplink and downlink carrier pair in different frequency bands or a same frequency band. The network node may receive carrier information based on the capability information, the carrier information indicative of one or more downlink carriers and one or more uplink carriers that include the uplink and downlink carrier pair for wireless communications. If the frequency band is the same for the uplink and downlink carrier, the carrier information may include second carrier information associated with another uplink carrier (e.g., an enhanced supplementary uplink (eSUL) carrier). The network node may participate in wireless communication using the downlink carrier and one of the uplink carriers.

### CROSS REFERENCES

The present Application is a 371 national stage filing of International PCT Application No. PCT/CN2023/096450 by TAKEDA et al., entitled “CAPABILITY SIGNALING FOR DOWNLINK AND UPLINK CARRIERS AND CELLS IN DIFFERENT FREQUENCY BANDS,” filed May 26, 2023; and claims priority to PCT Patent Application No. PCT/CN2023/087464 by TAKEDA et al., entitled A FRAMEWORK FOR SUPPLEMENTARY UPLINK AND UPLINK CARRIER AGGREGATION,” filed Apr. 11, 2023, each of which is assigned to the assignee hereof, and each of which is expressly incorporated by reference in its entirety herein.

### INTRODUCTION

The following relates to wireless communications that pertain to downlink and uplink carriers and cells in different frequency bands, and also supplementary uplink (SUL) and uplink carrier aggregation (CA).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support capability signaling for downlink and uplink carriers and cells in different frequency bands or in a same frequency band. In some aspects, a user equipment (UE) may indicate a capability for communicating using an uplink-downlink carrier pair via uplink and downlink cells, where the uplink and downlink carriers are used in different frequency bands or in the same frequency band. The UE may receive carrier information based on the capability, the carrier information indicating one or more uplink and downlink carriers the UE is to use for wireless communication. In some aspects, the uplink carriers indicated in the carrier information may include normal uplink carriers or normal cells, and supplementary uplink (SUL) (or enhanced SUL (eSUL)) carriers or cells. In cases where the UE is capable of communicating using an uplink-downlink carrier pair in the same frequency band, the carrier information may include second carrier information based on the capability and a normal uplink carrier and an eSUL carrier being in the same frequency band. The UE may participate in wireless communication using the indicated downlink carrier and uplink carrier in the same or different frequency bands or the indicated downlink carrier and the eSUL carrier in the same frequency band or different frequency bands.

In some aspects, to support a framework for SUL and uplink carrier aggregation (CA), a network entity may transmit a broadcast or dedicated message to a UE indicating (configuring the UE with) an uplink and downlink carrier pair for a cell and one or more additional uplink carriers, which may be SUL carriers or enhanced SUL carriers (eSUL carriers). The UE may use the additional uplink carriers as SUL carriers when the UE is in a idle mode or as component carriers for CA when the UE is in a connected mode. For example, when the UE determines to access a cell (while in an idle mode), the UE may select or determine one candidate carrier (either a normal uplink carrier-the uplink carrier of an uplink-downlink pair of carriers- or a SUL carrier) for performing a random access procedure. For example, if the UE selects a SUL carrier, the UE may perform a 2-step or a 4-step random access procedure using the SUL carrier. Based on successful contention resolution, the UE may enter a connected mode and perform subsequent, uplink transmissions using either the normal uplink carrier or one or more of the additional uplink carriers as component carriers in CA. The UE may use the additional uplink carriers or the normal uplink carrier to perform the uplink transmissions based on the carrier used for the random access procedure.

A method is described. The method may include transmitting capability information, the capability information indicative of a capability of the first network node to communicate using a pair of carriers in different frequency bands, where the pair of carriers includes a first downlink carrier in a first frequency band and a first uplink carrier in a second frequency band that is different from the first frequency band, receiving carrier information indicative of one or more downlink carriers and one or more uplink carriers for use by the first network node for wireless communication, where the one or more downlink carriers includes the first downlink carrier and the one or more uplink carriers includes the first uplink carrier, where the carrier information is based on the capability information, and participating in the wireless communication, in accordance with the carrier information, via the first downlink carrier and the first uplink carrier.

A first network node for wireless communication is described. The first wireless node may include at least one communication interface, and at least one processor coupled to the communication interface. The first network node may be configured to transmit capability information, the capability information indicative of a capability of the first network node to communicate using a pair of carriers in different frequency bands, where the pair of carriers includes a first downlink carrier in a first frequency band and a first uplink carrier in a second frequency band that is different from the first frequency band, receive carrier information indicative of one or more downlink carriers and one or more uplink carriers for use by the first network node for wireless communication, where the one or more downlink carriers includes the first downlink carrier and the one or more uplink carriers includes the first uplink carrier, where the carrier information is based on the capability information, and participate in the wireless communication, in accordance with the carrier information, via the first downlink carrier and the first uplink carrier.

Another apparatus is described. The apparatus may include means for transmitting capability information, the capability information indicative of a capability of the first network node to communicate using a pair of carriers in different frequency bands, where the pair of carriers includes a first downlink carrier in a first frequency band and a first uplink carrier in a second frequency band that is different from the first frequency band, means for receiving carrier information indicative of one or more downlink carriers and one or more uplink carriers for use by the first network node for wireless communication, where the one or more downlink carriers includes the first downlink carrier and the one or more uplink carriers includes the first uplink carrier, where the carrier information is based on the capability information, and means for participating in the wireless communication, in accordance with the carrier information, via the first downlink carrier and the first uplink carrier.

A non-transitory computer-readable medium having code for wireless communication stored thereon is described. The code, when executed by a first network node, may cause the first network node to transmit capability information, the capability information indicative of a capability of the first network node to communicate using a pair of carriers in different frequency bands, where the pair of carriers includes a first downlink carrier in a first frequency band and a first uplink carrier in a second frequency band that is different from the first frequency band, receive carrier information indicative of one or more downlink carriers and one or more uplink carriers for use by the first network node for wireless communication, where the one or more downlink carriers includes the first downlink carrier and the one or more uplink carriers includes the first uplink carrier, where the carrier information is based on the capability information, and participate in the wireless communication, in accordance with the carrier information, via the first downlink carrier and the first uplink carrier.

In some aspects of the method, apparatuses, and non-transitory computer-readable medium described herein, the capability information includes a first indication that the first network node supports communications in the first frequency band and a second indication that the first network node supports communications in the second frequency band and the capability of the first network node to communicate using the pair of carriers may be indicated by the first indication and the second indication.

In some aspects of the method, apparatuses, and non-transitory computer-readable medium described herein, the capability information includes a first list of individual frequency bands in which the first network node supports both downlink communication and uplink communication via each of the individual frequency bands, and a second list of pairs of frequency bands in which the first network node supports, for each pair, downlink communication via a first pair component in a respective pair and uplink communication associated with the downlink communication, via a second pair component in the respective pair and the first frequency band and the second frequency band may be one of the pairs of frequency bands included in the second list.

In some aspects of the method, apparatuses, and non-transitory computer-readable medium described herein, the capability information may be indicative of one or more first sets of features supported by the first network node and one or more second sets of features supported by the first network node, individual sets of the one or more first sets of features may be associated with respective downlink frequency bands in the second list of pairs of frequency bands, individual sets of the one or more second sets of features may be associated with respective uplink frequency bands in the second list of pairs of frequency bands, and the capability information indicates the one or more first sets of features and the one or more second sets of features separate from a third set of features supported by the first network node and each associated with a respective individual frequency band from the first list.

In some aspects of the method, apparatuses, and non-transitory computer-readable medium described herein, the capability information includes a list of individual frequency bands in which the first network node supports both downlink communication and uplink communication via each of the individual frequency bands, the list includes additional sets of uplink frequency bands, each set of uplink frequency bands associated with a respective one of the individual frequency bands in the list, and the second frequency band may be included in one of the additional sets of uplink frequency bands whose respective one of the individual frequency bands may be the first frequency band.

In some aspects of the method, apparatuses, and non-transitory computer-readable medium described herein, the capability information may be indicative of one or more first sets of features supported by the first network node and each associated with a respective individual frequency band from the list and the capability information may be also indicative of one or more second sets of features supported by the first network node and each associated with at least one uplink frequency band of a respective set of the additional sets of uplink frequency bands.

In some aspects of the method, apparatuses, and non-transitory computer-readable medium described herein, the first frequency band may be a time-division duplexing (TDD) band and the second frequency band may be a frequency-division duplexing (FDD) band or a SUL band.

In some aspects of the method, apparatuses, and non-transitory computer-readable medium described herein, the one or more downlink carriers includes a SDL carrier and the first frequency band may be a SDL band that includes the SDL carrier.

In some aspects of the method, apparatuses, and non-transitory computer-readable medium described herein, receiving the carrier information may include operations, features, means, or instructions for receiving first information indicative of first resources for use by the first network node to communicate via at least one of the first uplink carrier and the first downlink carrier that may be paired with the first uplink carrier and receiving second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers.

In some aspects of the method, apparatuses, and non-transitory computer-readable medium described herein, participating in the wireless communication may include operations, features, means, or instructions for determine, while the first network node may be in an idle mode, a first candidate uplink carrier from a set of multiple candidate uplink carriers for a random access procedure and determine, while the first network node may be in a connected mode, a second candidate uplink carrier from the set of multiple candidate uplink carriers for an uplink transmission.

In some aspects of the method, apparatuses, and non-transitory computer-readable medium described herein, the idle mode and the connected mode may be communication states of the first network node with respect to a second network node, communications during the connected mode may be over resources that may be allocated for use by the first network node, and communications during the idle mode may be over resources that may be allocated for common network node use.

A method is described. The method may include transmitting capability information, the capability information indicative of a capability of the first network node to communicate using a pair of carriers in a same frequency band, where the pair of carriers includes a first downlink carrier in a first frequency band and a first uplink carrier in the first frequency band, receiving carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band, and participating in the wireless communication, in accordance with the carrier information, via the first downlink carrier and the second uplink carrier.

A first network node for wireless communication is described. The first wireless node may include at least one communication interface, and at least one processor coupled to the communication interface. The first network node may be configured to transmit capability information, the capability information indicative of a capability of the first network node to communicate using a pair of carriers in a same frequency band, where the pair of carriers includes a first downlink carrier in a first frequency band and a first uplink carrier in the first frequency band, receive carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band, and participate in the wireless communication, in accordance with the carrier information, via the first downlink carrier and the second uplink carrier.

Another apparatus is described. The apparatus may include means for transmitting capability information, the capability information indicative of a capability of the first network node to communicate using a pair of carriers in a same frequency band, where the pair of carriers includes a first downlink carrier in a first frequency band and a first uplink carrier in the first frequency band, means for receiving carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band, and means for participating in the wireless communication, in accordance with the carrier information, via the first downlink carrier and the second uplink carrier.

A non-transitory computer-readable medium having code for wireless communication stored thereon is described. The code, when executed by a first network node, may cause the first network node to transmit capability information, the capability information indicative of a capability of the first network node to communicate using a pair of carriers in a same frequency band, where the pair of carriers includes a first downlink carrier in a first frequency band and a first uplink carrier in the first frequency band, receive carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band, and participate in the wireless communication, in accordance with the carrier information, via the first downlink carrier and the second uplink carrier.

In some aspects of the method, apparatuses, and non-transitory computer-readable medium described herein, the capability information includes a first indication that the first network node supports communications in the first frequency band and a second indication that the first network node supports communications in a second frequency band and the capability of the first network node to communicate using the pair of carriers may be indicated by the first indication and the second indication.

In some aspects of the method, apparatuses, and non-transitory computer-readable medium described herein, the second uplink carrier may be a SUL carrier when the first network node may be in an idle mode and an uplink component carrier for CA while the first network node may be in a connected mode.

In some aspects of the method, apparatuses, and non-transitory computer-readable medium described herein, receiving the carrier information may include operations, features, means, or instructions for receiving first information indicative of first resources for use by the first network node to communicate via at least one of the first uplink carrier and the first downlink carrier that may be paired with the first uplink carrier and receiving second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers.

In some aspects of the method, apparatuses, and non-transitory computer-readable medium described herein, participating in the wireless communication may include operations, features, means, or instructions for determine, while the first network node may be in an idle mode, a first candidate uplink carrier from a set of multiple candidate uplink carriers for a random access procedure and determine, while the first network node may be in a connected mode, a second candidate uplink carrier from the set of multiple candidate uplink carriers for an uplink transmission.

In some aspects of the method, apparatuses, and non-transitory computer-readable medium described herein, the idle mode and the connected mode may be communication states of the first network node with respect to a second network node, communications during the connected mode may be over resources that may be allocated for use by the first network node, and communications during the idle mode may be over resources that may be allocated for common network node use.

In some aspects of the method, apparatuses, and non-transitory computer-readable medium described herein, the first frequency band may be a TDD band.

A method is described. The method may include receiving capability information, the capability information indicative of a capability of a second network node to communicate using a pair of carriers in different frequency bands, where the pair of carriers includes a first downlink carrier in a first frequency band and a first uplink carrier in a second frequency band that is different from the first frequency band, transmitting carrier information indicative of one or more downlink carriers and one or more uplink carriers for use by the second network node for wireless communication, where the one or more downlink carriers includes the first downlink carrier and the one or more uplink carriers includes the first uplink carrier, where the carrier information is based on the capability information, and participating in the wireless communication, in accordance with the carrier information, via the first downlink carrier and the first uplink carrier.

A first network node for wireless communication is described. The first wireless node may include at least one communication interface, and at least one processor coupled to the communication interface. The first network node may be configured to receive capability information, the capability information indicative of a capability of a second network node to communicate using a pair of carriers in different frequency bands, where the pair of carriers includes a first downlink carrier in a first frequency band and a first uplink carrier in a second frequency band that is different from the first frequency band, transmit carrier information indicative of one or more downlink carriers and one or more uplink carriers for use by the second network node for wireless communication, where the one or more downlink carriers includes the first downlink carrier and the one or more uplink carriers includes the first uplink carrier, where the carrier information is based on the capability information, and participate in the wireless communication, in accordance with the carrier information, via the first downlink carrier and the first uplink carrier.

Another apparatus is described. The apparatus may include means for receiving capability information, the capability information indicative of a capability of a second network node to communicate using a pair of carriers in different frequency bands, where the pair of carriers includes a first downlink carrier in a first frequency band and a first uplink carrier in a second frequency band that is different from the first frequency band, means for transmitting carrier information indicative of one or more downlink carriers and one or more uplink carriers for use by the second network node for wireless communication, where the one or more downlink carriers includes the first downlink carrier and the one or more uplink carriers includes the first uplink carrier, where the carrier information is based on the capability information, and means for participating in the wireless communication, in accordance with the carrier information, via the first downlink carrier and the first uplink carrier.

A non-transitory computer-readable medium having code for wireless communication stored thereon is described. The code, when executed by a first network node, may cause the first network node to receive capability information, the capability information indicative of a capability of a second network node to communicate using a pair of carriers in different frequency bands, where the pair of carriers includes a first downlink carrier in a first frequency band and a first uplink carrier in a second frequency band that is different from the first frequency band, transmit carrier information indicative of one or more downlink carriers and one or more uplink carriers for use by the second network node for wireless communication, where the one or more downlink carriers includes the first downlink carrier and the one or more uplink carriers includes the first uplink carrier, where the carrier information is based on the capability information, and participate in the wireless communication, in accordance with the carrier information, via the first downlink carrier and the first uplink carrier.

In some aspects of the method, apparatuses, and non-transitory computer-readable medium described herein, the capability information includes a first indication that the second network node supports communications in the first frequency band and a second indication that the second network node supports communications in the second frequency band and the capability of the second network node to communicate using the pair of carriers may be indicated by the first indication and the second indication.

In some aspects of the method, apparatuses, and non-transitory computer-readable medium described herein, the capability information includes a first list of individual frequency bands in which the second network node supports both downlink communication and uplink communication via each of the individual frequency bands, and a second list of pairs of frequency bands in which the second network node supports, for each pair, downlink communication via a first pair component in a respective pair and uplink communication associated with the downlink communication, via a second pair component in the respective pair and the first frequency band and the second frequency band may be one of the pairs of frequency bands included in the second list.

In some aspects of the method, apparatuses, and non-transitory computer-readable medium described herein, the capability information may be indicative of one or more first sets of features supported by the second network node and one or more second sets of features supported by the second network node, individual sets of the one or more first sets of features may be associated with respective downlink frequency bands in the second list of pairs of frequency bands, individual sets of the one or more second sets of features may be associated with respective uplink frequency bands in the second list of pairs of frequency bands, and the capability information indicates the one or more first sets of features and the one or more second sets of features separate from a third set of features supported by the second network node and each associated with a respective individual frequency band from the first list.

In some aspects of the method, apparatuses, and non-transitory computer-readable medium described herein, the capability information includes a list of individual frequency bands in which the second network node supports both downlink communication and uplink communication via each of the individual frequency bands, the list includes additional sets of uplink frequency bands, each set of uplink frequency bands associated with a respective one of the individual frequency bands in the list, and the second frequency band may be included in one of the additional sets of uplink frequency bands whose respective one of the individual frequency bands may be the first frequency band.

In some aspects of the method, apparatuses, and non-transitory computer-readable medium described herein, the capability information may be indicative of one or more first sets of features supported by the second network node and each associated with a respective individual frequency band from the list and the capability information may be also indicative of one or more second sets of features supported by the second network node and each associated with at least one uplink frequency band of a respective set of the additional sets of uplink frequency bands.

In some aspects of the method, apparatuses, and non-transitory computer-readable medium described herein, the first frequency band may be a TDD band and and the second frequency band may be a FDD band or a SUL band.

In some aspects of the method, apparatuses, and non-transitory computer-readable medium described herein, the one or more downlink carriers includes a SDL carrier and the first frequency band may be a SDL band that includes the SDL carrier.

In some aspects of the method, apparatuses, and non-transitory computer-readable medium described herein, transmitting the carrier information may include operations, features, means, or instructions for transmitting first information indicative of first resources for use by the first network node to communicate via at least one of the first uplink carrier and the first downlink carrier that may be paired with the first uplink carrier and transmitting second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers.

In some aspects of the method, apparatuses, and non-transitory computer-readable medium described herein, participating in the wireless communication may include operations, features, means, or instructions for participating in a random access procedure with the second network node using a first candidate uplink carrier of a set of multiple candidate uplink carriers and receiving, after the random access procedure and while the second network node may be in a connected mode, an uplink transmission via a second candidate uplink carrier from the set of multiple candidate uplink carriers.

In some aspects of the method, apparatuses, and non-transitory computer-readable medium described herein, an idle mode and the connected mode may be communication states of the second network node with respect to the first network node, communications during the connected mode may be over resources that may be allocated for use by the second network node, and communications during the idle mode may be over resources that may be allocated for common network node use.

A method is described. The method may include receiving capability information, the capability information indicative of a capability of a second network node to communicate using a pair of carriers in a same frequency band, where the pair of carriers includes a first downlink carrier in a first frequency band and a first uplink carrier in the first frequency band, transmitting carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band, and participating in the wireless communication, in accordance with the carrier information, via the first downlink carrier and the second uplink carrier.

A first network node for wireless communication is described. The first wireless node may include at least one communication interface, and at least one processor coupled to the communication interface. The first network node may be configured to receive capability information, the capability information indicative of a capability of a second network node to communicate using a pair of carriers in a same frequency band, where the pair of carriers includes a first downlink carrier in a first frequency band and a first uplink carrier in the first frequency band, transmit carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band, and participate in the wireless communication, in accordance with the carrier information, via the first downlink carrier and the second uplink carrier.

Another apparatus is described. The apparatus may include means for receiving capability information, the capability information indicative of a capability of a second network node to communicate using a pair of carriers in a same frequency band, where the pair of carriers includes a first downlink carrier in a first frequency band and a first uplink carrier in the first frequency band, means for transmitting carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band, and means for participating in the wireless communication, in accordance with the carrier information, via the first downlink carrier and the second uplink carrier.

A non-transitory computer-readable medium having code for wireless communication stored thereon is described. The code, when executed by a first network node, may cause the first network node to receive capability information, the capability information indicative of a capability of a second network node to communicate using a pair of carriers in a same frequency band, where the pair of carriers includes a first downlink carrier in a first frequency band and a first uplink carrier in the first frequency band, transmit carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band, and participate in the wireless communication, in accordance with the carrier information, via the first downlink carrier and the second uplink carrier.

In some aspects of the method, apparatuses, and non-transitory computer-readable medium described herein, the capability information includes a first indication that the first network node supports communications in the first frequency band and a second indication that the first network node supports communications in a second frequency band and the capability of the first network node to communicate using the pair of carriers may be indicated by the first indication and the second indication.

In some aspects of the method, apparatuses, and non-transitory computer-readable medium described herein, the second uplink carrier may be a SUL carrier when the second network node may be in an idle mode and an uplink component carrier for ca while the second network node may be in a connected mode.

In some aspects of the method, apparatuses, and non-transitory computer-readable medium described herein, receiving the carrier information may include operations, features, means, or instructions for transmitting first information indicative of first resources for use by the second network node to communicate via at least one of the first uplink carrier and the first downlink carrier that may be paired with the first uplink carrier and transmitting second information indicative of second resources for use by the second network node to communicate via one or more second uplink carriers associated with the first downlink carrier but different from the first uplink carrier, where the first uplink carrier and the one or more second uplink carriers are, collectively, a set of multiple candidate uplink carriers.

In some aspects of the method, apparatuses, and non-transitory computer-readable medium described herein, participating in the wireless communication may include operations, features, means, or instructions for participating in a random access procedure with the second network node using a first candidate uplink carrier of a set of multiple candidate uplink carriers and receiving, after the random access procedure and while the second network node may be in a connected mode, an uplink transmission via a second candidate uplink carrier from the set of multiple candidate uplink carriers.

In some aspects of the method, apparatuses, and non-transitory computer-readable medium described herein, an idle mode and the connected mode may be communication states of the second network node with respect to the first network node, communications during the connected mode may be over resources that may be allocated for use by the second network node, and communications during the idle mode may be over resources that may be allocated for common network node use.

In some aspects of the method, apparatuses, and non-transitory computer-readable medium described herein, the first frequency band may be a TDD band.

A method of wireless communication performed by a first network node is described. The method may include receiving first information indicative of first resources for use by the first network node to communicate via at least one of a first uplink carrier and a first downlink carrier that is paired with the first uplink carrier in a same frequency band, receiving second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers, determining, while the first network node is in an idle mode, a first candidate uplink carrier from the set of multiple candidate uplink carriers for a random access procedure, and determining, while the first network node is in a connected mode, a second candidate uplink carrier from the set of multiple candidate uplink carriers for an uplink transmission.

A first network node is described. The first network node may include a memory and at least one processor coupled to the memory. The at least one processor may be configured to receive first information indicative of first resources for use by the first network node to communicate via at least one of a first uplink carrier and a first downlink carrier that is paired with the first uplink carrier in a same frequency band, receive second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers, determine, while the first network node is in an idle mode, a first candidate uplink carrier from the set of multiple candidate uplink carriers for a random access procedure, and determine, while the first network node is in a connected mode, a second candidate uplink carrier from the set of multiple candidate uplink carriers for an uplink transmission.

Another first network node is described. The first network node may include means for receiving first information indicative of first resources for use by the first network node to communicate via at least one of a first uplink carrier and a first downlink carrier that is paired with the first uplink carrier in a same frequency band, means for receiving second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers, means for determining, while the first network node is in an idle mode, a first candidate uplink carrier from the set of multiple candidate uplink carriers for a random access procedure, and means for determining, while the first network node is in a connected mode, a second candidate uplink carrier from the set of multiple candidate uplink carriers for an uplink transmission.

A non-transitory computer-readable medium having code for wireless communication stored thereon is described. The code, when executed by a first network node, causes the first network node to receive first information indicative of first resources for use by the first network node to communicate via at least one of a first uplink carrier and a first downlink carrier that is paired with the first uplink carrier in a same frequency band, receive second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers, determine, while the first network node is in an idle mode, a first candidate uplink carrier from the set of multiple candidate uplink carriers for a random access procedure, and determine, while the first network node is in a connected mode, a second candidate uplink carrier from the set of multiple candidate uplink carriers for an uplink transmission.

In some examples of the method, apparatuses, first network nodes, and non-transitory computer-readable medium described herein, receiving the second information may include operations, features, means, or instructions for receiving a broadcast or dedicated message that includes the second information, where the second information may be indicative of at least one of frequency information for each of the one or more second uplink carriers, uplink bandwidth part information for each of the one or more second uplink carriers, or timer information that pertains to a time alignment for each of the one or more second uplink carriers.

In some examples of the method, apparatuses, first network nodes, and non-transitory computer-readable medium described herein, the second information includes criteria for determination, by the first network node, of the first candidate uplink carrier.

In some examples of the method, apparatuses, first network nodes, and non-transitory computer-readable medium described herein, determining the first candidate uplink carrier may include operations, features, means, or instructions for determining a received power value and determining either the first uplink carrier or one of the one or more second uplink carriers as the first candidate uplink carrier based on a first comparison of the received power value and the first received power threshold.

In some examples of the method, apparatuses, first network nodes, and non-transitory computer-readable medium described herein, the criteria includes one or more second received power thresholds and an association between each of the one or more second uplink carriers and a respective range of received power values, each respective range of received power values bounded by at least one of the one or more second received power thresholds.

In some examples of the method, apparatuses, first network nodes, and non-transitory computer-readable medium described herein, the determination of the first candidate uplink carrier from among the one or more second uplink carriers may be based on a second comparison of the received power value and the one or more second received power thresholds.

Some examples of the method, apparatuses, first network nodes, and non-transitory computer-readable medium described herein may further include operations, features, means, or instructions for performing the random access procedure using the first candidate uplink carrier and the first downlink carrier, where one of the one or more second uplink carriers may be the first candidate uplink carrier.

In some examples of the method, apparatuses, first network nodes, and non-transitory computer-readable medium described herein, performing the random access procedure may include operations, features, means, or instructions for transmitting a random access message via the first candidate uplink carrier, monitoring a downlink channel for a random access response message transmitted via the first downlink carrier, where the random access response message schedules transmission of an uplink shared channel message via the first candidate uplink carrier, transmitting the uplink shared channel message via the first candidate uplink carrier based on the random access response message, and receiving a contention resolution downlink message via the first downlink carrier based on the uplink shared channel message.

In some examples of the method, apparatuses, first network nodes, and non-transitory computer-readable medium described herein, performing the random access procedure may include operations, features, means, or instructions for transmitting a random access message via the first candidate uplink carrier and monitoring a downlink channel for a downlink message transmitted via the first downlink carrier based on the random access message.

In some examples of the method, apparatuses, first network nodes, and non-transitory computer-readable medium described herein, determining the second candidate uplink carrier may include operations, features, means, or instructions for determining the first uplink carrier as the second candidate uplink carrier, where determination of the first uplink carrier may be based on one of the one or more second uplink carriers being determined as the first candidate uplink carrier for the random access procedure.

Some examples of the method, apparatuses, first network nodes, and non-transitory computer-readable medium described herein may further include operations, features, means, or instructions for transmitting, via the first uplink carrier, a feedback message in response to conclusion of the random access procedure and transmitting the uplink transmission via at least the first uplink carrier.

Some examples of the method, apparatuses, first network nodes, and non-transitory computer-readable medium described herein may further include operations, features, means, or instructions for transmitting, via the first candidate uplink carrier, a feedback message in response to conclusion of the random access procedure and transmitting the uplink transmission via at least the first candidate uplink carrier.

Some examples of the method, apparatuses, first network nodes, and non-transitory computer-readable medium described herein may further include operations, features, means, or instructions for transmitting the set of multiple uplink transmissions via at least the first uplink carrier, where a first value of a first carrier information field used to schedule a downlink shared channel message on the first downlink carrier may be a same as a second value of a second carrier information field used to schedule one of the set of multiple uplink transmissions via the first uplink carrier, and where the first value may be different from a third value of a third carrier information field used to schedule another of the set of multiple uplink transmissions via one of the one or more second uplink carriers.

In some examples of the method, apparatuses, first network nodes, and non-transitory computer-readable medium described herein, determining the second candidate uplink carrier may include operations, features, means, or instructions for determining one of the one or more second uplink carriers as the second candidate uplink carrier, where determination of the one of the one or more second uplink carriers may be based on the one of the one or more second uplink carriers being determined as the first candidate uplink carrier for the random access procedure.

Some examples of the method, apparatuses, first network nodes, and non-transitory computer-readable medium described herein may further include operations, features, means, or instructions for transmitting the set of multiple uplink transmissions via at least the one of the one or more second uplink carriers, where a first value of a first carrier information field used to schedule a downlink shared channel message on the first downlink carrier may be different from a second value of a second carrier information field used to schedule one of the set of multiple uplink transmissions via the one of the one or more second uplink carriers, and where the first value may be different from a third value of a third carrier information field used to schedule another of the set of multiple uplink transmissions via another of the one or more second uplink carriers.

Some examples of the method, apparatuses, first network nodes, and non-transitory computer-readable medium described herein may further include operations, features, means, or instructions for transmitting, via the one of the one or more second uplink carriers, a feedback message in response to conclusion of the random access procedure and transmitting the uplink transmission via at least the one of the one or more second uplink carriers.

In some examples of the method, apparatuses, first network nodes, and non-transitory computer-readable medium described herein, the uplink transmission includes one or more of an uplink control channel message, an uplink shared channel message, or a random access channel message.

In some examples of the method, apparatuses, first network nodes, and non-transitory computer-readable medium described herein, the second candidate uplink carrier may be an uplink component carrier for CA while the first network node may be in the connected mode.

In some examples of the method, apparatuses, first network nodes, and non-transitory computer-readable medium described herein, the second candidate uplink carrier may be associated with a corresponding set of feedback processes.

In some examples of the method, apparatuses, first network nodes, and non-transitory computer-readable medium described herein, a combination of one or more second candidate uplink carriers including the second candidate uplink carrier may be based on a capability of the first network node.

Some examples of the method, apparatuses, first network nodes, and non-transitory computer-readable medium described herein may further include operations, features, means, or instructions for switching from the second candidate uplink carrier to a different second candidate uplink carrier based on a capability of the first network node.

In some examples of the method, apparatuses, first network nodes, and non-transitory computer-readable medium described herein, the second candidate uplink carrier may be scheduled based on a downlink message associated with a same cell.

In some examples of the method, apparatuses, first network nodes, and non-transitory computer-readable medium described herein, half-duplex operation or full-duplex operation between the first downlink carrier and the second candidate uplink carrier may be based on a capability of the first network node.

In some examples of the method, apparatuses, first network nodes, and non-transitory computer-readable medium described herein, the first uplink carrier and the one or more second uplink carriers may be in different frequency bands.

In some examples of the method, apparatuses, first network nodes, and non-transitory computer-readable medium described herein, the first uplink carrier and the one or more second uplink carriers may be in a same frequency band.

In some examples of the method, apparatuses, first network nodes, and non-transitory computer-readable medium described herein, the first uplink carrier and the one or more second uplink carriers may be for communication between the first network node and different cells.

In some examples of the method, apparatuses, first network nodes, and non-transitory computer-readable medium described herein, the first uplink carrier and the one or more second uplink carriers may be for communication between the first network node and a same cell.

In some examples of the method, apparatuses, first network nodes, and non-transitory computer-readable medium described herein, the idle mode and the connected mode may be communication states of the first network node with respect to a second network node, where communications during the connected mode may be over resources that may be allocated for use by the first network node, and where communications during the idle mode may be over resources that may be allocated for common network node use.

In some examples of the method, apparatuses, first network nodes, and non-transitory computer-readable medium described herein, the second candidate uplink carrier may be a set of multiple second candidate uplink carriers of the set of multiple candidate uplink carriers.

A method of wireless communication performed by a first network node is described. The method may include transmitting first information indicative of first resources for use by a second network node to communicate via at least one of a first uplink carrier and a first downlink carrier that is paired with the first uplink carrier in a same frequency band, transmitting second information indicative of second resources for use by the second network node to communicate via one or more second uplink carriers associated with the first downlink carrier but different from the first uplink carrier, where the first uplink carrier and the one or more second uplink carriers are, collectively, a set of multiple candidate uplink carriers, participating in a random access procedure with the second network node using a first candidate uplink carrier of the set of multiple candidate uplink carriers, and receiving, after the random access procedure and while the second network node is in a connected mode, an uplink transmission via a second candidate uplink carrier from the set of multiple candidate uplink carriers.

A first network node is described. The first network node may include a memory and at least one processor coupled to the memory. The at least one processor may be configured to transmit first information indicative of first resources for use by a second network node to communicate via at least one of a first uplink carrier and a first downlink carrier that is paired with the first uplink carrier in a same frequency band, transmit second information indicative of second resources for use by the second network node to communicate via one or more second uplink carriers associated with the first downlink carrier but different from the first uplink carrier, where the first uplink carrier and the one or more second uplink carriers are, collectively, a set of multiple candidate uplink carriers, participate in a random access procedure with the second network node using a first candidate uplink carrier of the set of multiple candidate uplink carriers, and receive, after the random access procedure and while the second network node is in a connected mode, an uplink transmission via a second candidate uplink carrier from the set of multiple candidate uplink carriers.

Another first network node is described. The first network node may include means for transmitting first information indicative of first resources for use by a second network node to communicate via at least one of a first uplink carrier and a first downlink carrier that is paired with the first uplink carrier in a same frequency band, means for transmitting second information indicative of second resources for use by the second network node to communicate via one or more second uplink carriers associated with the first downlink carrier but different from the first uplink carrier, where the first uplink carrier and the one or more second uplink carriers are, collectively, a set of multiple candidate uplink carriers, means for participating in a random access procedure with the second network node using a first candidate uplink carrier of the set of multiple candidate uplink carriers, and means for receiving, after the random access procedure and while the second network node is in a connected mode, an uplink transmission via a second candidate uplink carrier from the set of multiple candidate uplink carriers.

A non-transitory computer-readable medium having code for wireless communication stored thereon is described. The code, when executed by a first network node, causes the first network node to transmit first information indicative of first resources for use by a second network node to communicate via at least one of a first uplink carrier and a first downlink carrier that is paired with the first uplink carrier in a same frequency band, transmit second information indicative of second resources for use by the second network node to communicate via one or more second uplink carriers associated with the first downlink carrier but different from the first uplink carrier, where the first uplink carrier and the one or more second uplink carriers are, collectively, a set of multiple candidate uplink carriers, participate in a random access procedure with the second network node using a first candidate uplink carrier of the set of multiple candidate uplink carriers, and receive, after the random access procedure and while the second network node is in a connected mode, an uplink transmission via a second candidate uplink carrier from the set of multiple candidate uplink carriers.

In some examples of the method, apparatuses, first network nodes, and non-transitory computer-readable medium described herein, transmitting the second information may include operations, features, means, or instructions for transmitting a broadcast or dedicated message that includes the second information, where the second information may be indicative of at least one of frequency information for each of the one or more second uplink carriers, uplink bandwidth part information for each of the one or more second uplink carriers, or timer information that pertains to a time alignment for each of the one or more second uplink carriers.

In some examples of the method, apparatuses, first network nodes, and non-transitory computer-readable medium described herein, the second information includes criteria for determination, by the second network node, of the first candidate uplink carrier.

In some examples of the method, apparatuses, first network nodes, and non-transitory computer-readable medium described herein, the criteria includes a first received power threshold, and where the determination of either the first uplink carrier or one of the one or more second uplink carriers as the first candidate uplink carrier may be based on a first comparison of a received power value and the first received power threshold.

In some examples of the method, apparatuses, first network nodes, and non-transitory computer-readable medium described herein, the criteria includes one or more second received power thresholds and an association between each of the one or more second uplink carriers and a respective range of received power values, each respective range of received power values bounded by at least one of the one or more second received power thresholds.

In some examples of the method, apparatuses, first network nodes, and non-transitory computer-readable medium described herein, the determination of the first candidate uplink carrier from among the one or more second uplink carriers may be based on a second comparison of the received power value and the one or more second received power thresholds.

In some examples of the method, apparatuses, first network nodes, and non-transitory computer-readable medium described herein, participating in the random access procedure may include operations, features, means, or instructions for participating in the random access procedure using the first candidate uplink carrier and the first downlink carrier, where one of the one or more second uplink carriers may be the first candidate uplink carrier.

In some examples of the method, apparatuses, first network nodes, and non-transitory computer-readable medium described herein, participating in the random access procedure may include operations, features, means, or instructions for receiving a random access message via the first candidate uplink carrier, transmitting a random access response message via the first downlink carrier, where the random access response message schedules transmission of an uplink shared channel message via the first candidate uplink carrier, receiving the uplink shared channel message via the first candidate uplink carrier based on the random access response message, and transmitting a contention resolution downlink message via the first downlink carrier for a contention resolution procedure based on the uplink shared channel message.

In some examples of the method, apparatuses, first network nodes, and non-transitory computer-readable medium described herein, participating in the random access procedure may include operations, features, means, or instructions for receiving a random access message via the first candidate uplink carrier and transmitting a downlink message via the first downlink carrier based on the random access message.

In some examples of the method, apparatuses, first network nodes, and non-transitory computer-readable medium described herein, at least the first uplink carrier may be determined as the second candidate uplink carrier based on one of the one or more second uplink carriers being determined as the first candidate uplink carrier for the random access procedure.

Some examples of the method, apparatuses, first network nodes, and non-transitory computer-readable medium described herein may further include operations, features, means, or instructions for receiving, via the first uplink carrier, a feedback message in response to conclusion of the random access procedure and receiving the uplink transmission via at least the first uplink carrier.

Some examples of the method, apparatuses, first network nodes, and non-transitory computer-readable medium described herein may further include operations, features, means, or instructions for receiving, via the first candidate uplink carrier, a feedback message in response to conclusion of the random access procedure and receiving the uplink transmission via at least the first candidate uplink carrier.

Some examples of the method, apparatuses, first network nodes, and non-transitory computer-readable medium described herein may further include operations, features, means, or instructions for receiving the set of multiple uplink transmissions via at least the first uplink carrier, where a first value of a first carrier information field used to schedule a downlink shared channel message on the first downlink carrier may be a same as a second value of a second carrier information field used to schedule one of the set of multiple uplink transmissions via the first uplink carrier, and where the first value may be different from a third value of a third carrier information field used to schedule another of the set of multiple uplink transmissions via one of the one or more second uplink carriers.

In some examples of the method, apparatuses, first network nodes, and non-transitory computer-readable medium described herein, at least one of the one or more second uplink carriers may be determined as the second candidate uplink carrier based on the one of the one or more second uplink carriers being determined as the first candidate uplink carrier for the random access procedure.

Some examples of the method, apparatuses, first network nodes, and non-transitory computer-readable medium described herein may further include operations, features, means, or instructions for receiving the set of multiple uplink transmissions via at least the one of the one or more second uplink carriers, where a first value of a first carrier information field used to schedule a downlink shared channel message on the first downlink carrier may be different from a second value of a second carrier information field used to schedule one of the set of multiple uplink transmissions via the one of the one or more second uplink carriers, and where the first value may be different from a third value of a third carrier information field used to schedule another of the set of multiple uplink transmissions via another of the one or more second uplink carriers.

Some examples of the method, apparatuses, first network nodes, and non-transitory computer-readable medium described herein may further include operations, features, means, or instructions for receiving, via the one of the one or more second uplink carriers, a feedback message in response to conclusion of the random access procedure and receiving the uplink transmission via at least the one of the one or more second uplink carriers.

In some examples of the method, apparatuses, first network nodes, and non-transitory computer-readable medium described herein, the uplink transmission includes one or more of an uplink control channel message, an uplink shared channel message, or a random access channel message.

In some examples of the method, apparatuses, first network nodes, and non-transitory computer-readable medium described herein, the second candidate uplink carrier may be an uplink component carrier for CA while the second network node may be in the connected mode.

In some examples of the method, apparatuses, first network nodes, and non-transitory computer-readable medium described herein, the second candidate uplink carrier may be associated with a corresponding set of feedback processes.

In some examples of the method, apparatuses, first network nodes, and non-transitory computer-readable medium described herein, a combination of one or more second candidate uplink carriers including the second candidate uplink carrier may be based on a capability of the second network node.

In some examples of the method, apparatuses, first network nodes, and non-transitory computer-readable medium described herein, the second candidate uplink carrier may be scheduled based on a downlink message associated with a same cell.

In some examples of the method, apparatuses, first network nodes, and non-transitory computer-readable medium described herein, half-duplex operation or full-duplex operation between the first downlink carrier and the second candidate uplink carrier may be based on a capability of the second network node.

In some examples of the method, apparatuses, first network nodes, and non-transitory computer-readable medium described herein, the first uplink carrier and the one or more second uplink carriers may be in different frequency bands.

In some examples of the method, apparatuses, first network nodes, and non-transitory computer-readable medium described herein, the first uplink carrier and the one or more second uplink carriers may be in a same frequency band.

In some examples of the method, apparatuses, first network nodes, and non-transitory computer-readable medium described herein, the first uplink carrier and the one or more second uplink carriers may be for communication between the second network node and different cells.

In some examples of the method, apparatuses, first network nodes, and non-transitory computer-readable medium described herein, the first uplink carrier and the one or more second uplink carriers may be for communication between the second network node and a same cell.

In some examples of the method, apparatuses, first network nodes, and non-transitory computer-readable medium described herein, an idle mode and the connected mode may be communication states of the first network node with respect to the second network node, where communications during the connected mode may be over resources that may be allocated for use by the second network node, and where communications during the idle mode may be over resources that may be allocated for common network node use.

### BRIEF DESCRIPTION OF THE DRAWINGS

FIG. 1 shows an example of a wireless communications system that supports capability signaling for downlink and uplink carriers and cells in different frequency bands and also a framework for supplementary uplink (SUL) and uplink carrier aggregation (CA) in accordance with one or more aspects of the present disclosure.

FIG. 2 shows an example of a wireless communications system that supports capability signaling for downlink and uplink carriers and cells in different frequency bands and also a framework for SUL and uplink CA in accordance with one or more aspects of the present disclosure.

FIG. 3 shows examples of random access procedures that support capability signaling for downlink and uplink carriers and cells in different frequency bands and also a framework for SUL and uplink CA in accordance with one or more aspects of the present disclosure.

FIGS. 4 and 5 show example of communication frameworks that support capability signaling for downlink and uplink carriers and cells in different frequency bands and also a framework for SUL and uplink CA in accordance with one or more aspects of the present disclosure.

FIG. 6 shows an example of a carrier configuration that supports capability signaling for downlink and uplink carriers and cells in different frequency bands and also a framework for SUL and uplink CA in accordance with one or more aspects of the present disclosure.

FIGS. 7 and 8 show examples of process flows that supports capability signaling for downlink and uplink carriers and cells in different frequency bands and also a framework for SUL and uplink CA in accordance with one or more aspects of the present disclosure.

FIGS. 9 and 10 show block diagrams of devices that support capability signaling for downlink and uplink carriers and cells in different frequency bands and also a framework for SUL and uplink CA in accordance with one or more aspects of the present disclosure.

FIG. 11 shows a block diagram of a communications manager that supports capability signaling for downlink and uplink carriers and cells in different frequency bands and also a framework for SUL and uplink CA in accordance with one or more aspects of the present disclosure.

FIG. 12 shows a block diagram of a device that supports capability signaling for downlink and uplink carriers and cells in different frequency bands and also a framework for SUL and uplink CA in accordance with one or more aspects of the present disclosure.

FIG. 13 shows a block diagram of a communications manager that supports capability signaling for downlink and uplink carriers and cells in different frequency bands and also a framework for SUL and uplink CA in accordance with one or more aspects of the present disclosure.

FIG. 14 shows a diagram of a system including a device that supports capability signaling for downlink and uplink carriers and cells in different frequency bands and also a framework for SUL and uplink CA in accordance with one or more aspects of the present disclosure.

FIGS. 15 and 16 show block diagrams of devices that support capability signaling for downlink and uplink carriers and cells in different frequency bands and also a framework for SUL and uplink CA in accordance with one or more aspects of the present disclosure.

FIG. 17 shows a block diagram of a communications manager that supports capability signaling for downlink and uplink carriers and cells in different frequency bands and also a framework for SUL and uplink CA in accordance with one or more aspects of the present disclosure.

FIG. 18 shows a block diagram of a device that supports capability signaling for downlink and uplink carriers and cells in different frequency bands and also a framework for SUL and uplink CA in accordance with one or more aspects of the present disclosure.

FIG. 19 shows a block diagram of a communications manager that supports capability signaling for downlink and uplink carriers and cells in different frequency bands and also a framework for SUL and uplink CA in accordance with one or more aspects of the present disclosure.

FIG. 20 shows a diagram of a system including a device that supports capability signaling for downlink and uplink carriers and cells in different frequency bands and also a framework for SUL and uplink CA in accordance with one or more aspects of the present disclosure.

FIGS. 21 through 31 show flowcharts illustrating methods that support capability signaling for downlink and uplink carriers and cells in different frequency bands and also a framework for SUL and uplink CA in accordance with one or more aspects of the present disclosure.

### DETAILED DESCRIPTION

A user equipment (UE) may support an uplink and downlink carrier pair for communications with a cell, where both of the carriers may be within a same frequency range. In some cases, the UE may support an additional uplink carrier, such as a supplementary uplink (SUL) carrier or an uplink component carrier (which may be used for carrier aggregation (CA)). When the additional uplink carrier is a SUL carrier, the UE may be configured with two uplink carriers and one downlink carrier for the same cell. The SUL carrier may support both idle and connected mode operations in the UE. While in a connected mode (e.g., while communicating with a network entity), the UE may transmit uplink messages on either the paired uplink carrier (e.g., normal uplink carrier) or on a SUL carrier at any given time.

In addition, the UE may monitor for downlink messages on a cell, the downlink messages scheduling uplink messages (e.g., physical uplink shared channel (PUSCH) transmissions) on a different cell. Such cross-carrier scheduling may be available to the UE when the UE supports CA. The SUL carriers and CA are different mechanisms that enable the UE to perform many of the same functions. However, SUL carriers and CA are each configured differently and subject to different limitations. For example, SUL carriers may support an idle mode and a connected mode of the UE, however uplink CA may support only the connected mode. Additionally, SUL carrier communications may lack support for simultaneous transmissions, however uplink CA may allow simultaneous transmissions.

In some cases, the UE may support communications using an uplink-downlink carrier pair and in some cases, an SUL carrier across different frequency bands or frequency band combinations. The UE may report a list of frequency bands the UE supports and a list of frequency band combinations the UE may be configured with CA with the network entity. For example, the UE may support communications using uplink and downlink carriers for a cell in a frequency band n79 or a frequency band n3. However, the UE may lack methods to report a UE capability for communications using the uplink and downlink carriers in different frequency bands (e.g., the downlink carrier in the frequency band n79 and the uplink carrier in the frequency band n3). Additionally, the UE may currently lack the ability to communicate in a supplemental downlink (SDL) band and uplink and SUL carriers in different frequency bands.

The techniques described herein support capability signaling for downlink and uplink carriers and cells in different frequency bands. For example, a UE may report a UE capability to support communications using downlink and uplink (including SUL or enhanced SUL (eSUL)) carriers in different frequency bands. In some aspects, the UE may indicate a capability for communicating using an uplink-downlink carrier pair, where the uplink and downlink carriers are used in different frequency bands. The UE may receive carrier information based on the capability, the carrier information indicating one or more uplink and downlink carriers the UE is to use for wireless communication. The UE may participate in wireless communication using the indicated uplink and downlink carriers.

Alternatively, the UE may indicate a capability to communicate using an uplink-downlink carrier pair in a same frequency band. In such cases, the UE may receive carrier information indicating one or more uplink and downlink carriers the UE is to use for wireless communication, where the one or more uplink carriers includes a normal uplink carrier (e.g., the uplink carrier of an uplink-downlink pair of carriers) and an eSUL carrier. In addition, the carrier information may include second carrier information based on the capability and the normal uplink carrier and the eSUL carrier being in the same frequency band. The UE may participate in the wireless communication using the downlink carrier and the eSUL carrier.

In addition, the techniques described herein support a unified framework for SUL carriers and uplink CA in a wireless communications system. A network entity may transmit a broadcast or dedicated message to a UE indicating (configuring the UE with) an uplink and downlink carrier pair for a cell and one or more additional uplink carriers, which may be referred to as eSUL carriers. The UE may use the additional uplink carriers as SUL carriers when the UE is in a idle mode or as component carriers for CA when the UE is in a connected mode. For example, when the UE determines to access a cell (while in an idle mode), the UE may select or determine one candidate carrier (either a normal uplink carrier or one of the additional uplink carriers) for performing a random access procedure. For example, if the UE selects one of the additional uplink carriers, the UE may perform a 2-step or a 4-step random access procedure using the additional uplink carrier as a SUL carrier. Based on successful contention resolution, the UE may enter a connected mode and perform subsequent, uplink transmissions using a normal uplink or one or more of the additional uplink carriers (as component carriers in CA). The UE may use the additional uplink carriers or the normal uplink carrier to perform the uplink transmissions based on the carrier used for the random access procedure.

Aspects of the disclosure are initially described in the context of wireless communications systems. Aspects of the disclosure are then described in the context of random access procedures, communication frameworks, and process flows. Aspects of the disclosure are further illustrated by and described with reference to apparatus diagrams, system diagrams, and flowcharts that relate to capability signaling for downlink and uplink carriers and cells in different frequency bands.

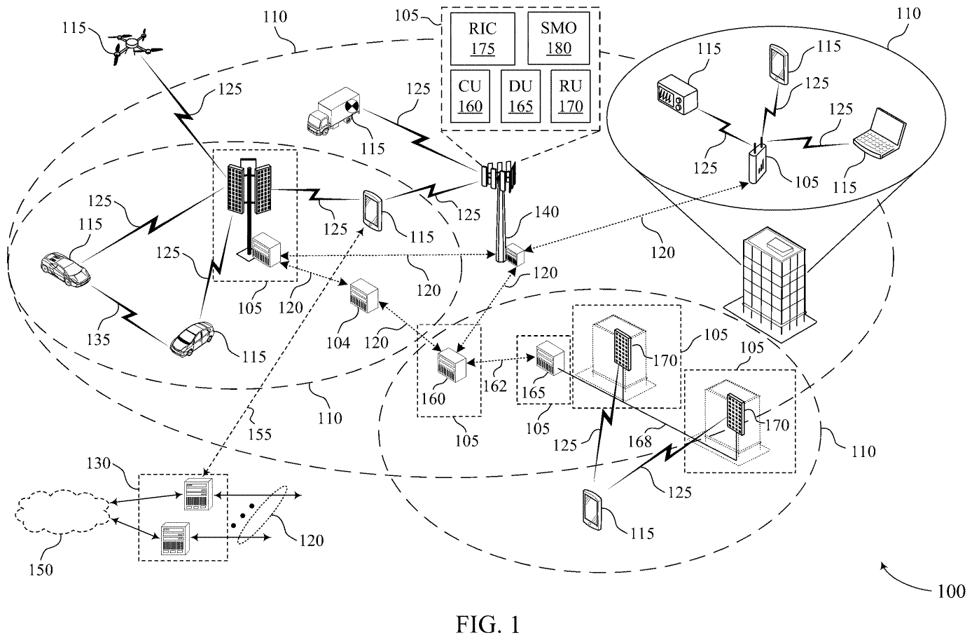

FIG. 1 shows an example of a wireless communications system 100 that supports capability signaling for downlink and uplink carriers and cells in different frequency bands and also a framework for SUL and uplink CA (e.g., an eSUL framework) in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support capability signaling for downlink and uplink carriers and cells in different frequency bands as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using CA or multi-carrier operation. A UE 115 may be configured with multiple downlink component carriers and one or more uplink component carriers according to a CA configuration. CA may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some aspects, such as in a CA configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some aspects, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some aspects, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a CA configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some aspects, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In a wireless communications system 100, the UE 115 may support an uplink and downlink carrier pair for a serving cell in the wireless communications system 100. In addition, the UE 115 may support SUL carriers, which may be additional uplink carriers associated with the serving cell. As such, with the SUL carriers, the UE 115 may be configured with two uplink carriers and one downlink carrier of the same cell. The SUL carriers may be configured to improve uplink coverage for high frequency scenarios. In addition, the UE 115 may support two approaches for operating multiple uplink carriers. For example, the UE 115 may support an SUL, which may be an uplink carrier or band supplementing uplink coverage of a serving cell. Alternatively, the UE 115 may support uplink CA, which may include multiple uplink component carriers that the UE 115 may use for simultaneous or switched transmissions.

SUL carriers may support both an idle mode (e.g., RRC_IDLE) and a connected mode (e.g., RRC_CONNECTED). For example, while in an idle mode, the UE 115 may receive a broadcast message such as a system information block (SIB) (e.g., SIB1) or a dedicated message and identify an SUL configuration from information in the SIB1 (e.g., supplementaryUplink in ServingCellConfigCommonSIB). For example, ServingCellConfigCommonSIB may include both UplinkConfigCommon and supplementaryUplink information elements. The UE may trigger a random access procedure on either a normal uplink carrier or an SUL of a cell to enter into a connected mode. On which carrier the UE 115 transmits a physical random access channel (PRACH) message may be based on some criteria. For example, if the serving cell for the random access procedure is configured with SUL, and if a reference signal received power (RSRP) of the downlink pathloss reference is less than a threshold (e.g., rsrp-ThresholdSSB-SUL), then the UE 115 may select the SUL carrier for performing a random access procedure and set a maximum transmit power PCMAX to P_{CMAX,f,c} of the SUL carrier. If the RSRP is greater than the threshold, then the UE 115 may select the normal uplink carrier (from the uplink and downlink carrier pair) for performing the random access procedure set the maximum transmit power PCMAX to P_{CMAX,f,c} of the normal uplink carrier.

While operating in the connected mode, the UE 115 may be configured to or may receive an indication to transmit uplink messages using either a normal uplink carrier or an SUL carrier at any given time (e.g., not simultaneously on both carrier types). For example, a network entity 105 may semi-statically configure physical uplink control channel (PUCCH) transmissions on either a normal uplink carrier or an SUL carrier.

The network entity 105 may semi-statically configure or dynamically indicate PUSCH transmissions for transmission by the UE 115 on either the normal uplink carrier or an SUL carrier. If the UE 115 supports dynamic scheduling of the PUSCH transmissions on either the normal uplink carrier or the SUL carrier of a serving cell, and if the network entity 105 configures the normal uplink carrier or the SUL carrier of the serving cell, then a downlink control information (DCI) format used for the PUSCH scheduling may include a one-bit uplink/SUL indicator that may indicate the carrier on which the DCI is scheduling a PUSCH transmission. If the network entity 105 configures PUSCH transmissions on just one of an uplink carrier or an SUL carrier, then the PUSCH transmission is scheduled on the carrier where the PUSCH transmission is configured. If the network entity 105 configures PUSCH transmissions on neither of an uplink carrier nor an SUL carrier, then the PUSCH transmission is scheduled on the carrier where a PUCCH transmission is configured. Alternatively, if the network entity 105 configures PUSCH transmissions on neither an uplink carrier nor an SUL carrier, and if the network entity 105 does not configure the PUCCH transmission, then the network entity 105 may schedule the PUSCH transmission on the carrier on which the latest PRACH message was transmitted.

Additionally, or alternatively, the network entity 105 may semi-statically configure or dynamically indicate, or the UE 115 may select to transmit, a PRACH transmission on either a normal uplink carrier or an SUL carrier. If the network entity 105 configures the PRACH transmission only on the normal uplink carrier or an SUL carrier, then the PRACH transmission may be performed using the configured carrier. Alternatively, if the network entity 105 configures the PRACH transmission on both the normal uplink carrier and the SUL carrier, the UE 115 may select the normal uplink carrier or the SUL carrier for the PRACH transmission according to an RSRP of a downlink pathloss reference signal (e.g., a synchronization signal block (SSB)-RSRP). For physical downlink control channel (PDCCH)-ordered PRACH transmissions, a corresponding DCI format may include a one-bit uplink/SUL indicator indicative of a carrier on which the DCI format may trigger the PRACH transmission.

In some cases, the UE 115 may be configured to monitor a PDCCH on a cell for PUSCH scheduling on another cell. The PDCCH may correspond to a DCI format 0_1 or 0_2 that includes a carrier indicator field (CIF), where a value of the CIF may indicate a cell for which the DCI schedules a PUSCH transmission. In such cases, a DCI format 0_0 may lack support for cross-carrier scheduling. More specifically, the UE 115 may be configured to monitor a search space set for a PDCCH on a cell for PUSCH scheduling on another cell, and in such a case, the network entity 105 may transmit (and the UE 115 may detect) a PDCCH for a DCI format 0_1 or 0_2 (but not a DCI format 0_0) for PUSCH scheduling on another cell). On the scheduling cell, the UE 115 may monitor the PDCCH for different scheduled cells separately. A set of control channel elements (CCEs) for PDCCH candidates for each scheduled cell may be derived based on different parameters (e.g., n_Cl values). As such, the sets of CCEs are generally different. In addition, DCI format sizes for different scheduled cells may be different, and a quantity of blind decodes (BDs) and CCEs for PDCCH candidates for different scheduled cells may be counted differently. In addition, HARQ spaces may be prepared separately for different scheduled cells.

In some aspects, the wireless communications system 100 may support multi-carrier scheduling. The UE 115 may be configured to monitor a PDCCH on a cell for scheduling PUSCHs on more than one cell. In such a case, each PUSCH may be scheduled on each respective cell. A DCI format for multi-cell PUSCH scheduling (e.g., DCI format 0_3) may include a “set-CIF” field, where a value of the “set-CIF” field may indicate a set of cells that may be scheduled by the DCI. Different “set-CIF” field values may be configured for different sets of cells. In addition, within the set of cells indicated by the “set-CIF” field, all or a subset of the cells may be scheduled by each DCI. More specifically, a UE 115 may be configured with a mapping between a value of a “set-CIF” field of a DCI format 0_3 and a set of cells for multi-cell PUSCH scheduling. If the UE 115 detects the DCI format 0_3 with the value of the “set-CIF” field associated with the set of cells, the DCI format 0_3 may schedule one or multiple or all of the cells in the set of cells. The UE 115 may identify the one or multiple cells where PUSCHs are actually scheduled by the DCI format 0_3 either by another specific field that indicates a subset of cells that are actually scheduled by the DCI format 0_3, or based on whether a frequency-domain resource allocation (FDRA) field for each cell in the DCI format 0_3 is set to “no RBs are scheduled.”

However, SUL carriers and uplink CA are configured separately and subject to different limitations, and as such may support different communications. For example, regarding a band combination framework, SUL carriers may support an SUL-specific band, where a normal and SUL band combination may be defined per demand. For uplink CA, normal bands may be aggregated under a CA band combination framework. In addition, SUL carriers may support an idle mode and a connected mode of the UE 115, while uplink CA may only support the connected mode. Additionally, SUL may lack support for simultaneous transmissions, and uplink CA may support simultaneous transmissions. In addition, SUL and CA may utilize different indications of a carrier. For example, an uplink/SUL indicator in DCI may indicate an uplink carrier from a normal uplink carrier and an SUL carrier for a cell, and a CIF in DCI may be used for CA. While multi-cell scheduling may be unsupported by SUL, carriers for multi-cell scheduling may be indicated via a co-scheduled-cell indication field or an FDRA field for CA. In addition, uplink transmit switching may be an SUL-specific behavior for SUL and may be supported by both ‘switchedUL’ and ‘dualUL’ for CA. As such, SUL and uplink CA are based on diverged mechanisms and hence require specifically designated implementations and UE capabilities. Therefore, a unified framework for SUL and uplink CA is desired.

The wireless communications system 100 supports techniques for capability signaling for downlink and uplink carriers and cells in different frequency bands or in a same frequency band. In some aspects, a UE 115 may indicate a capability for communicating using an uplink-downlink carrier pair, where the uplink and downlink carriers are used in different frequency bands or in the same frequency band. The UE 115 may receive carrier information based on the capability, the carrier information indicating one or more uplink and downlink carriers the UE 115 is to use for wireless communication. In some aspects, the uplink carriers indicated in the carrier information may include normal uplink carriers and cells and SUL (e.g., eSUL) carriers and cells. In cases where the UE 115 is capable of communicating using an uplink-downlink carrier pair in the same frequency band, the carrier information may include second carrier information based on the capability and a normal uplink carrier and an eSUL carrier being in the same frequency band. The UE 115 may participate in wireless communication using the indicated downlink carrier and uplink carrier in the same frequency band or different frequency bands or the indicated downlink carrier and the eSUL carrier in the same frequency band or different frequency bands.

In addition, the wireless communications system 100 supports techniques for enabling a unified framework for SUL and uplink CA. A network entity 105 may transmit a broadcast or dedicated message to a UE 115 indicating (configuring the UE 115 with) an uplink and downlink carrier pair for a cell and one or more additional uplink carriers, which may be additional SULs or enhanced SUL (eSUL) carriers (e.g., second uplink carriers) or enhanced SUL cells. eSUL carriers are additional SUL carriers the UE 115 may use as eSULs when in an idle mode or as CCs in CA when in a connected mode. For example, when the UE 115 determines to access a cell (while in an idle mode), the UE 115 may select or determine one candidate carrier (either a normal uplink carrier or a eSUL carrier) for performing a random access procedure. For an uplink carrier the UE 115 selects, the UE 115 may perform a 2-step or a 4-step random access procedure using the carrier. Based on successful contention resolution, the UE 115 may enter a connected mode and perform subsequent, uplink transmissions using a normal uplink carrier or an eSUL carrier determined as a second candidate uplink carrier. The UE 115 may use the normal uplink carrier or the eSUL carrier to perform the uplink transmissions based on the carriers used for the random access procedure.

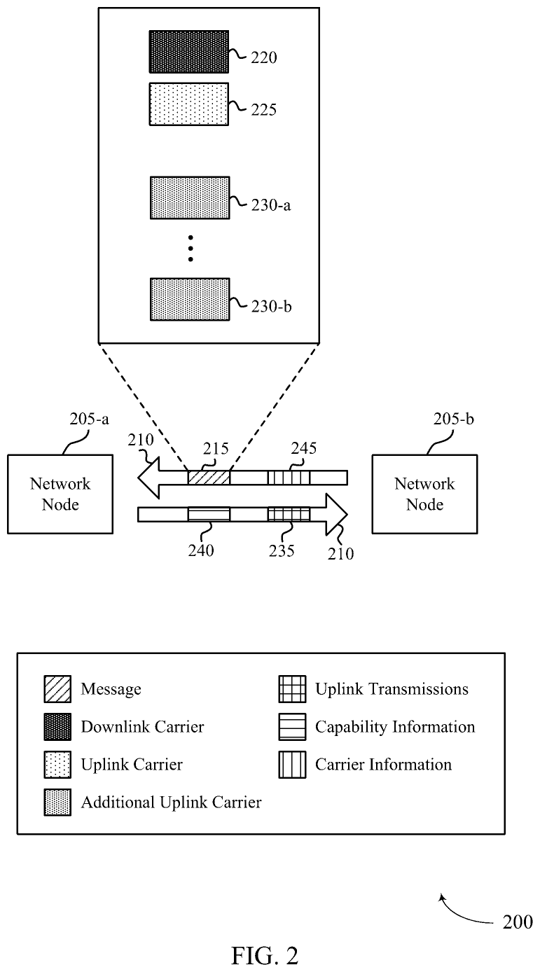

FIG. 2 shows an example of a wireless communications system 200 that supports capability signaling for downlink and uplink carriers and cells in different frequency bands and also a framework for SUL and uplink CA (e.g., an eSUL framework) in accordance with one or more aspects of the present disclosure. In some aspects, the wireless communications system 200 may implement aspects of the wireless communications system 100 or may be implemented by aspects of the wireless communications system 100. For example, the wireless communications system 200 may include a network node 205-a and a network node 205-b, which may be examples of a UE 115 and a network entity 105 described herein, respectively. The network node 205-a and the network node 205-b may support uplink and downlink carriers.

The wireless communications system 200 may support communications between the network node 205-a and the network node 205-b via communication links 210, which may be examples of communication links 125 described herein with reference to FIG. 1. For example, the network node 205-a and the network node 205-b may perform uplink and downlink communications via the communication links 210.

In some aspects, the network node 205-a may operate in different communication states including an idle mode or a connected mode. Communications during the idle mode may occur over resources that are allocated for common network node use. That is, during the idle mode, the network node 205-a may periodically become available for monitoring a downlink channel without connecting to a specific network entity 105. Communications during the connected mode may occur over resources that are allocated for use by the network node 205-a. That is, the network node 205-a may be wirelessly connected to the network node 205-b while in the connected mode.

In some aspects, the network node 205-b may configure the network node 205-a with an uplink and downlink carrier pair. For example, the network node 205-a may receive a message 215 (e.g., a broadcast message such as a SIB1, or a higher-layer, dedicated message) associated with a cell and indicative of first resources the network node 205-a may use to communicate via at least one of a downlink carrier 220 and an uplink carrier 225 that are defined in a same frequency band or different frequency bands. The downlink carrier 220 may correspond to an FDD cell, carrier, or band, an TDD cell, carrier, or band, or a supplemental downlink (SDL) cell, carrier, or band.

Additionally, the network node 205-b may configure the network node 205-a with one or more additional uplink carriers associated with the cell, which may be additional uplink carriers 230 that lack a corresponding downlink carrier. The additional uplink carriers 230 may be SUL carriers of SUL frequency bands, uplink carriers of an FDD cell, carrier, or band, or uplink resources of TDD cell, carrier, or band. In addition, the network node 205-a may use one uplink carrier from uplink carriers 225 and the additional uplink carriers 230 while operating in the idle mode, or one or more of the uplink carriers 225 and the additional uplink carriers 230 while operating in the connected mode, where each one or more of uplink carriers 225 and the additional uplink carriers 230 is treated as a regular uplink component carrier in uplink CA while the UE 115 operates in the connected mode.

In some aspects, the message 215 may additionally indicate second resources for use by the network node 205-a to communicate via the additional uplink carriers 230 (also referred to herein as second uplink carriers or eSULs) associated with the downlink carrier 220 but different from the uplink carrier 225. For example, the additional uplink carriers 230 may include an additional uplink carrier 230-a, an additional uplink carrier 230-b, or any other quantity of additional uplink carriers 230 supported by the wireless communications system 200. Each additional uplink carrier 230 may be an eSUL. Collectively, the uplink carrier 225 and the additional uplink carriers 230 may be a set of multiple candidate uplink carriers. In some cases, the uplink carrier 225 and the additional uplink carriers 230 may be in a same frequency band or different frequency bands. Additionally, the uplink carrier 225 and the additional uplink carriers 230 may be for communication between the network node 205-a and a same cell or different cells. In some aspects, the information associated with the additional uplink carriers 230 may be indicated in the message 215 via UplinkConfigCommonSIB or equivalent information. The message 215 may include frequency information, uplink BWP information (e.g., an uplink BWP common configuration), or timer information pertaining to a time alignment (e.g., a time alignment timer configuration) associated with each of the additional uplink carriers 230.

While operating in the idle mode, the network node 205-a may determine or select a first candidate uplink carrier from the set of multiple candidate uplink carriers for a random access procedure. That is, when the network node 205-a determines to access the cell, the network node 205-a may select either the uplink carrier 225 or one of the additional uplink carriers 230 of the cell to use for the random access procedure. In some aspects, the message 215 may include criteria for determining the first candidate uplink carrier. For example, the message 215 may indicate one or more RSRP thresholds and a mapping between an RSRP range and one of the uplink carrier 225 or the additional uplink carriers 230 (provided by a parameter or a parameter list), where an RSRP range includes RSRP values between (or bounded by) two RSRP thresholds. The network node 205-b may provide an RSRP-threshold list for SSBs (or channel state information (CSI)-reference signals (CSI-RSs) or any other downlink reference signal that can be used to measure RSRP of the downlink) of the cell and an uplink or SUL carrier index that is mapped to each RSRP range.

When the criteria indicates one or more RSRP thresholds, the network node 205-a may determine an RSRP (or other received power value) of the cell and determine the first candidate uplink carrier as the uplink carrier 225 or one of the additional uplink carriers 230 based on comparing the measured RSRP to the one or more RSRP thresholds indicated in the message 215. For example, if an RSRP of the cell is below a first threshold (e.g., Threshold 1), the network node 205-a may select the uplink carrier 225. If the RSRP of the cell is between the first threshold and a second threshold (e.g., Threshold 2), the network node 205-a may select the additional uplink carrier 230-a (e.g., eSUL carrier #1). If the RSRP of the cell is between the second threshold and a third threshold (e.g., Threshold 3), the network node 205-a may select the additional uplink carrier 230-b (e.g., eSUL carrier #2). If the RSRP if the cell is greater than the third threshold, the network node 205-a may select a third additional uplink carrier 230 (e.g., eSUL carrier #3).

In some aspects, the network node 205-a may select the uplink carrier 225 or one of the additional uplink carriers 230 as the first candidate uplink carrier for the random access procedure independently (e.g., based on its own decision). Alternatively, the network node 205-a may utilize the criteria indicated in the message 215 and its own RSRP measurements to determine the first candidate uplink carrier. For example, the network node 205-a may use one or more RSRP thresholds indicated in the message 215 and a determined RSRP value of the cell to select the uplink carrier 225 or the additional uplink carriers 230. If the network node 205-a selects the additional uplink carriers 230, the network node 205-a may determine independently which of the Additional uplink carriers 230 to use for the random access procedure (e.g., the additional uplink carrier 230-a, the additional uplink carrier 230-b, and so on).

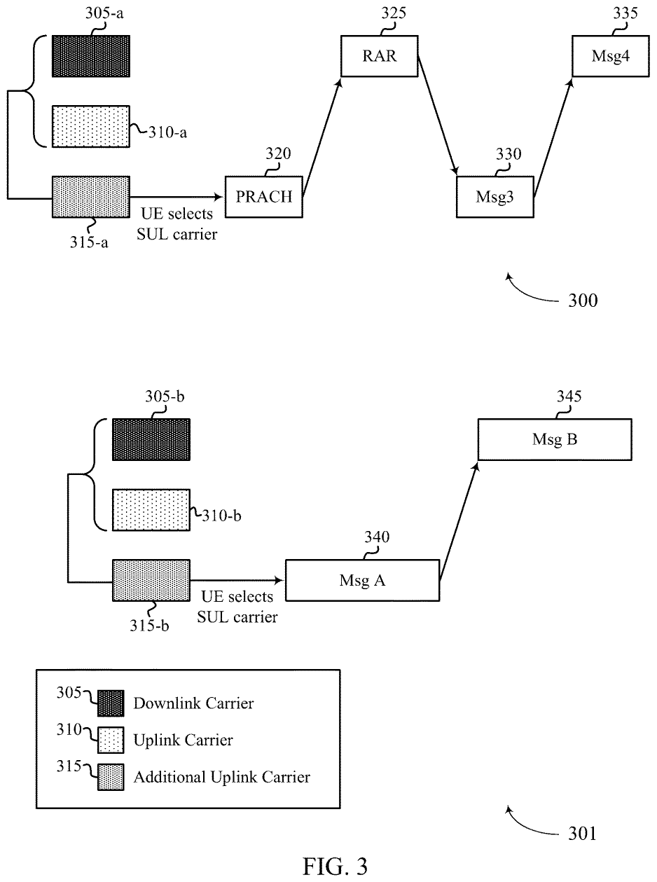

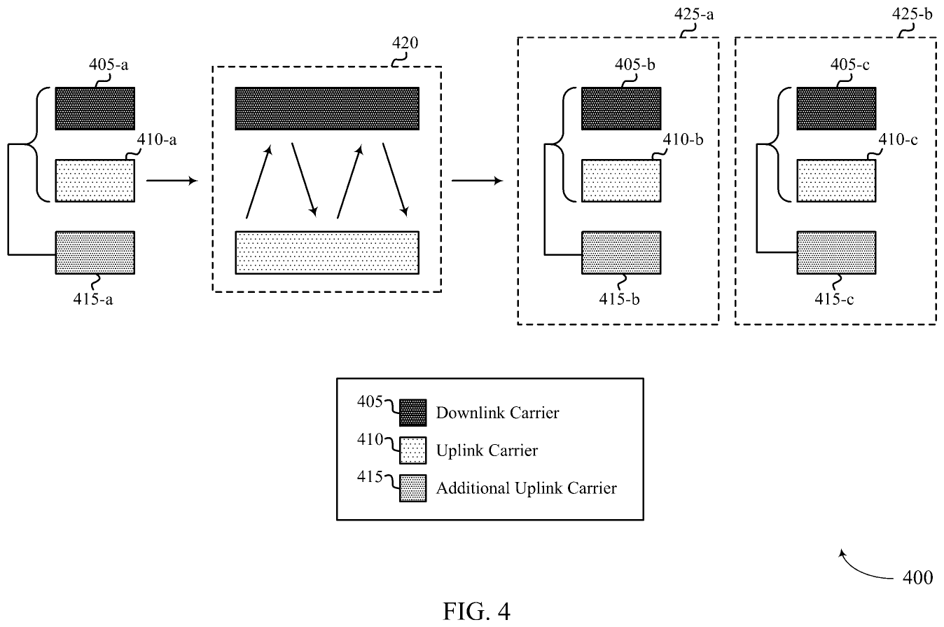

The network node 205-a may perform the random access procedure using the determined first candidate uplink carrier and the downlink carrier 220. The random access procedure is described herein with reference to FIG. 3. After successful contention resolution, the network node 205-a may enter the connected mode and determine, while in the connected mode, a second candidate uplink carrier from the set of multiple uplink carriers for a subsequent uplink transmission 235. That is, once wirelessly connected to the network node 205-b, the network node 205-a may determine to use the uplink carrier 225 or one of the additional uplink carriers 230 to communicate uplink transmissions 235. Determining the second candidate uplink carrier is described herein with reference to FIG. 4. Based on determining the second candidate uplink carrier, the network node 205-a may transmit one or more uplink transmissions 235 to the network node 205-b using the selected second candidate uplink carrier.

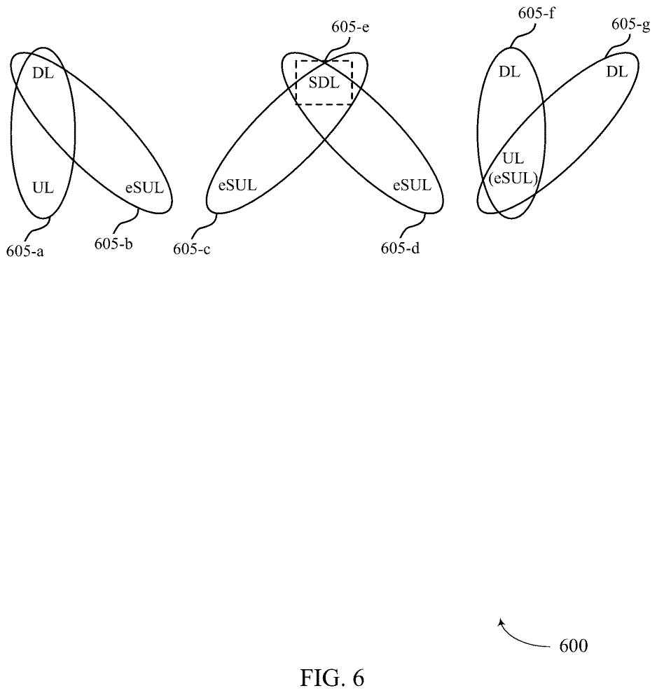

In some aspects, the network node 205-a may support communications using the downlink carrier 220 and an uplink carrier 225 or an additional uplink carrier 230 (e.g., eSULs) in different frequency bands, and the network node 205-a may indicate a capability to support such communications. In some aspects, the network node 205-a may transmit capability information 240 indicative of a capability of the network node 205-a to communicate using a pair of carriers (e.g., a downlink carrier 220 and an uplink carrier 225 or an eSUL) in different frequency bands. For example, the network node 205-a may indicate support of a first frequency band (e.g., NR band X) and a second frequency band (e.g., NR band Y) and support of communications using the downlink carrier 220 in the first frequency band and an uplink carrier 225 or an additional uplink carrier 230 in the second frequency band (or using the downlink carrier 220 in the second frequency band and an uplink carrier 225 or an additional uplink carrier 230 in the first frequency band). In some aspects, the first frequency band may be a TDD band and the second frequency band may be a FDD band or an SUL band, as described herein with reference to FIG. 6. Alternatively, the downlink carrier 220 may be an SDL carrier and the first frequency band may be an SDL band that includes the SDL carrier. The first and second frequency bands may be in a frequency range (FR) 1, FR2, FR2-1, FR2-2, or FR3.

In some aspects, the capability of the network node 205-a may be assumed based on the network node 205-a reporting a first indication in the capability information 240 that the network node 205-a supports communication using the downlink carrier 220 in the first frequency band (or the second frequency band) and a second indication that the network node 205-a supports communication using the uplink carrier 225 or an additional uplink carrier 230 in the second frequency band (or the first frequency band).

In addition to reporting a list of frequency bands the network node 205-a supports (e.g., supportedBandListNR) in the capability information 240, the network node 205-a may report a list of downlink and uplink (e.g., {DL, UL}) frequency band pairs that it supports. In this way, the capability information 240 may include a first list of individual frequency bands in which the network node 205-a supports both downlink and uplink communication via each of the individual frequency bands. In addition, the capability information 240 may include a second list of frequency band pairs in which the network node 205-a supports downlink communication via a first pair component in a respective pair and uplink communication associated with the downlink communication, via a second pair component in the respective pair. The first frequency band and the second frequency band may be one of the pairs of frequency bands included in the second list.

In some aspects, the network node 205-a may also indicate support of optional features for downlink communications using a downlink carrier in a given frequency band pair and optional features for uplink communications using an uplink or eSUL carrier of the given frequency band pair. That is, the capability information 240 may indicate one or more sets of features supported by the network node 205-a, the sets of features associated with respective uplink frequency bands or downlink frequency bands of a frequency band pair.

In some implementations, the capability information 240 may indicate a sequence of frequency bands (e.g., BandNR) and for each frequency band, a list of the optional features the network node 205-a supports and other corresponding information (additional capabilities, identifiers, etc.), which may be indicated as information elements. For example, the features may include an NR frequency band index, per-band MIMO capabilities, per-band optional capabilities (e.g., pdsch-256QAM-FR2, pusch-256QAM, rateMatchingLTE-CRS, etc.) a power class of the network node 205-a (e.g., ue-PowerClass), supported subcarrier spacings and channel bandwidths for uplink and downlink (e.g., channelBWs-DL, channelBWs-UL), or any combination thereof. In addition, the capability information 240 may indicate NR band-pair capability for communicating using the downlink and uplink carriers and cells in different frequency bands. For example, in addition to the features described herein and for each frequency band, the capability information 240 may indicate an NR frequency band index for downlink communications, which may include downlink-related per-band parameters (the features described herein), supported subcarrier spacings and channel bandwidths for downlink (e.g., channelBWs-DL), per-band optional capabilities for downlink communications (e.g., pdsch-256QAM-FR2), among other features. In addition, the capability information 240 may indicate an NR frequency band index for uplink communications, which may include uplink-related per-band parameters (the features described herein), supported subcarrier spacings and channel bandwidths for uplink (e.g., channelBWs-UL), per-band optional capabilities for downlink communications (e.g., pdsch-256QAM-FR2), a power class of the network node 205-a (e.g., ue-PowerClass), among other features.

Additionally, or alternatively, for each frequency band (e.g., BandNR) indicated in the capability information 240, the network node 205-a may include one or multiple frequency bands that may be associated with the downlink carrier 220 in the frequency band. That is, the capability information 240 may include a list of individual frequency bands in which the network node 205-a supports both downlink and uplink communication via each of the individual frequency bands and additional sets of uplink frequency bands associated with each of the individual frequency bands, the sets of uplink frequency bands associated with eSUL carriers. In addition, the network node 205-a may indicate (in the capability information 240) support of optional features for downlink communications via the downlink carrier 220 for a given frequency band pair and optional features for uplink communications via the uplink carrier 225 or an additional uplink carrier 230 for the given frequency band pair. That is, the capability information 240 may indicate sets of features for the individual frequency bands and additional sets of uplink frequency bands.

In some aspects, the capability information 240 may indicate a list of the optional features the network node 205-a supports for each frequency band and other corresponding information (additional capabilities, identifiers, etc.), which may be indicated as information elements, as described herein. In addition, the capability information 240 may indicate a list of frequency bands the network node 205-a supports for eSUL carriers and, for each frequency band, a list of optional features including an NR frequency band index, uplink-related per-band parameters, supported subcarrier spacings and channel bandwidths for uplink (e.g., channelBWs-UL), and a power class of the network node 205-a (e.g., ue-PowerClass), among other parameters or features. In this way, the capability information 240 may indicate a first frequency band the network node 205-a supports for downlink communications via the downlink carrier 220 and one or more second frequency bands (eSUL bands) the network node 205-a supports for uplink communications via an eSUL carrier (an additional uplink carrier 230), where the first and second frequency bands are associated in the capability information 240.

In response to the capability information 240, the network node 205-a may receive carrier information 245 indicative of one or more downlink carriers and one or more uplink carriers for use by the network node 205-a for wireless communication. For example, the one or more downlink carriers may include the downlink carrier 220 and the one or more uplink carriers may include the uplink carrier 225 or an additional uplink carrier 230 (e.g., an eSUL), where the downlink carrier 220 is associated with the first frequency band and the uplink carrier 225 or the additional uplink carrier 230 is associated with the second frequency band. In some cases, the network node 205-a may receive first and second information indicative of first and second resources, respectively, for use by the network node 205-a to communicate via the downlink and uplink carrier pair. The network node 205-a may participate in wireless communication in accordance with the carrier information 245 via the indicated downlink and uplink carrier.

In some cases, the network node 205-a may support multiple uplink carriers (e.g., the uplink carrier 225 and one or more eSUL carriers) associated with the downlink carrier 220 in a same frequency band. In such cases, the network node 205-a may indicate a per-band capability for one or more frequency bands (e.g., BandNR) in the capability information 240 as described herein. For example, the capability information 240 may indicate a capability of the network node 205-a to communicate using an uplink and downlink carrier pair in a same frequency band. In some aspects, the network node 205-a may support communications using the downlink carrier 220 and the uplink carrier 225 associated with the downlink carrier 220 in a same cell (e.g., configured via an RRC information element uplinkConfigCommon or uplinkConfig). In addition, the network node 205-a may support communications using the downlink carrier 220 and the one or more eSUL carriers associated with the downlink carrier 220 in a same cell (e.g., configured via an RRC information element eSUL-Config or a list of eSUL-Config). That is, the network node 205-a may support communications using a downlink and uplink carrier pair in a first frequency band (the same frequency band for uplink and downlink communications, a frequency band 605-a described with reference to FIG. 6) and using an eSUL carrier in a second frequency band that is different from the first frequency band (e.g., a frequency band 605-b described with reference to FIG. 6).

In such cases, in which the network node 205-a supports communications using the downlink carrier 220 and an uplink carrier in the same frequency band, the network node 205-a may receive carrier information 245 in response to the capability information 240. The carrier information 245 may indicate one or more downlink carriers (e.g., the downlink carrier 220) and one or more uplink carriers (e.g., the uplink carrier 225, an eSUL) for use by the network node 205-a for wireless communication.

In addition, the carrier information 245 may include second carrier information that is based on the capability information 240 and based on the downlink and uplink carriers being in the same frequency band. The network node 205-a may participate in wireless communication in accordance with the carrier information 245 via the indicated downlink and uplink carrier (an eSUL).

FIG. 3 shows examples of a random access procedure 300 and a random access procedure 301 that support capability signaling for downlink and uplink carriers and cells in different frequency bands and also a framework for SUL and uplink CA (e.g., an eSUL framework) in accordance with one or more aspects of the present disclosure. In some aspects, the random access procedure 300 and 301 may implement aspects of the wireless communications systems 100 and 200 or may be implemented by aspects of the wireless communications systems 100 and 200. For example, network nodes 205 (e.g., UEs 115, network entities 105) may perform the random access procedure 300 or the random access procedure 301 using an uplink carrier 310 or an additional uplink carrier 315 and a downlink carrier 305.

As described herein with reference to FIG. 2, a network node (e.g., a UE) may perform a random access procedure using a first candidate uplink carrier and a downlink carrier 305, the first candidate uplink carrier determined as either an uplink carrier 310 or an additional uplink carrier 315. The additional uplink carriers 315 may include eSUL carriers, SUL carriers of SUL frequency bands, uplink carriers of an FDD cell, carrier, or band, or uplink resources of TDD cell, carrier, or band. If the network node selects the uplink carrier 310, the network node may perform a random access procedure using the uplink carrier 310 and a paired downlink carrier 305. If the network node selects an additional uplink carrier 315 (e.g., an eSUL), the network node may perform a random access procedure based on the additional uplink carrier 315 and the downlink carrier 305 of the associated cell.

The random access procedure 300 may be an example of a 4-step random access procedure based on an additional uplink carrier 315-a. The network node may be configured with a downlink carrier 305-a and an uplink carrier 310-a (which may be an uplink and downlink carrier pair for the cell) and one or more additional uplink carriers 315 including the additional uplink carrier 315-a. After determining the additional uplink carrier 315-a as the candidate uplink carrier for the random access procedure 300, the network node may transmit a random access message (a PRACH 320) via the additional uplink carrier 315-a (the first candidate uplink carrier). The network node may monitor a downlink channel (e.g., a PDCCH) for a random access response (RAR) message 325 that is transmitted (e.g., by a network entity) via the downlink carrier 305-a. In some aspects, the PDCCH monitoring may be for a Type-1 common search space set on the associated cell for a DCI format 1_0 with a cyclic redundancy check (CRC) scrambled by a random access-radio network temporary identifier (RA-RNTI), which may be a similar process for the additional uplink carrier 315-a as for the uplink carrier 310-a.

In some aspects, the RAR message 325 may schedule transmission of a Msg3 330 (e.g., a PUSCH) via the additional uplink carrier 315-a (on which the network node has transmitted the PRACH 320). In some aspects, a retransmission of the Msg3 330 PUSCH may be scheduled via DCI with a DCI format 0_0 with a CRC scrambled by a temporary cell (TC)-RNTI monitored on the Type-1 common search space set on the associated cell.

The network node may transmit the Msg3 330 via the additional uplink carrier 315-a based on the RAR message 325. In some cases, the network node may receive a Msg4 335, which may be a contention resolution downlink message, via the downlink carrier 305-a based on the Msg3 330. Based on the contention resolution, the network node may enter a connected mode with a second network node (e.g., a network entity) and transmit subsequent uplink transmissions, which is described herein with reference to FIG. 4. In this way, the network node may perform the random access procedure 300 based on the additional uplink carrier 315-a. It should be noted that the network node may perform the random access procedure 300 based on the uplink carrier 310-a in a similar manner.

The random access procedure 301 may be an example of a 2-step random access procedure based on an additional uplink carrier 315-b. The network node may be configured with a downlink carrier 305-b and an uplink carrier 310-b (which may be an uplink and downlink carrier pair for the cell) and one or more additional uplink carriers 315 including the additional uplink carrier 315-b. After determining the additional uplink carrier 315-b as the candidate uplink carrier for the random access procedure 301, the network node may transmit a Msg A 340 (e.g., a random access message) via the additional uplink carrier 315-b (the first candidate uplink carrier). The Msg A 340 may include a PRACH transmission. Based on the Msg A 340, the network node may monitor a downlink channel for a Msg B 345 (e.g., a downlink message, PDCCH) transmitted via the downlink carrier 305-b. In some aspects, the PDCCH monitoring may be for a Type-1 common search space set on the associated cell for a DCI format 1_0 with a cyclic redundancy check (CRC) scrambled by a MsgB-RNTI, which may be a similar process for the additional uplink carrier 315-a as for the uplink carrier 310-a.

In some cases, based on successful contention resolution at the conclusion of the random access procedure 301, the network node may enter a connected mode with a second network node (e.g., a network entity) and transmit subsequent uplink transmissions, which is described herein with reference to FIG. 4. In this way, the network node may perform the random access procedure 301 based on the additional uplink carrier 315-b. It should be noted that the network node may perform the random access procedure 301 based on the uplink carrier 310-b in a similar manner.

FIG. 4 shows an example of a communication framework 400 that supports capability signaling for downlink and uplink carriers and cells in different frequency bands and also a framework for SUL and uplink CA (e.g., an eSUL framework) in accordance with one or more aspects of the present disclosure. In some aspects, the communication framework 400 may implement aspects of the wireless communications systems 100 and 200 or may be implemented by aspects of the wireless communications systems 100 and 200. For example, network nodes (e.g., UEs 115, network entities 105) may use the communication framework 400 to communication uplink transmissions based on uplink carriers 410 or additional uplink carriers 415 and a downlink carrier 405 of an associated cell.

As described herein with reference to FIGS. 2 and 3, a network node (e.g., a UE 115) may be configured with a downlink carrier 405-a paired with an uplink carrier 410-a. In addition, the network node may be configured with one or more additional uplink carriers, which may be additional uplink carriers 415, including an additional uplink carrier 415-a. The additional uplink carriers 415 may include eSUL carriers, SUL carriers of SUL frequency bands, uplink carriers of an FDD cell, carrier, or band, or uplink resources of TDD cell, carrier, or band. The network node may perform a random access procedure 420 as described herein with reference to FIG. 3 using the downlink carrier 405-a and a first candidate uplink carrier, which is determined to be either the uplink carrier 410-a or the additional uplink carrier 415-a (a selected candidate uplink carrier of the associated cell). Based on successful contention resolution at the conclusion of the random access procedure 420, the network node may enter a connected mode (e.g., may establish a wireless connection with a network entity or other network node).

While in the connected mode, the network node may determine a second candidate uplink carrier for an uplink transmission. If the random access procedure was based on the additional uplink carrier 415-a, the network node may use an uplink carrier 410 (a normal uplink carrier) or an additional uplink carrier 415 for the uplink transmissions. For example, for an uplink transmission 425-a, the network node may use an uplink carrier 410-b (paired with a downlink carrier 405-b of the associated cell) instead of an additional uplink carrier 415-b, by default, unless otherwise is configured for or indicated to the network node. That is, the network node may determine the uplink carrier 410-b as the second candidate uplink carrier based on the additional uplink carrier 415-a being selected as the first candidate uplink carrier for the random access procedure 420. As such, the additional uplink carrier 415-b may be an additional uplink carrier for the uplink transmission 425-a.

In such cases, the network node may transmit a feedback message (e.g., HARQ-acknowledgment (ACK) feedback) for Msg4 or Msg B physical downlink shared channel (PDSCH) reception on the uplink carrier 410-b of the serving cell. That is, the network node may transmit a feedback message via the uplink carrier 410-b in response to conclusion of the random access procedure 420 and transmit the uplink transmission 425-a via the uplink carrier 410-b. Alternatively, the network node may transmit a feedback message (e.g., HARQ-ACK feedback) for Msg4 or Msg B PDSCH reception on the additional uplink carrier 415-b of the serving cell. After transmitting the feedback message via the additional uplink carrier 415-b in response to the conclusion of the random access procedure 420, the network node may return to transmitting the uplink transmission 425-a via at least the uplink carrier 410-b of the cell, which is the default carrier. In such cases, the uplink transmission 425-a may include one or more of a PUCCH transmission, a PUSCH transmission scheduled by a DCI format 0_0 via the downlink carrier 405-b of the associated cell, or a PRACH/Msg A transmission triggered by a DCI format 1_0 vi the downlink carrier 405-b of the associated cell.

Alternatively, for an uplink transmission 425-b, the network node may continue to use an additional uplink carrier 415-c (paired with a downlink carrier 405-c of the associated cell) instead of an uplink carrier 410-c, by default, unless otherwise is configured for or indicated to the network node. That is, the network node may determine the additional uplink carrier 415-c as the second candidate uplink carrier based on the additional uplink carrier 415-b being selected as the first candidate uplink carrier for the random access procedure 420. As such, the uplink carrier 410-c may be considered as an additional uplink carrier for the uplink transmission 425-b.

In such cases, the network node may transmit a feedback message (e.g., HARQ-ACK feedback) for Msg4 or Msg B PDSCH reception on the additional uplink carrier 415-c of the serving cell. That is, the network node may transmit a feedback message via the additional uplink carrier 415-c in response to conclusion of the random access procedure 420 and transmit the uplink transmission 425-b also via the additional uplink carrier 415-c. The uplink transmission 425-b may include one or more of a PUCCH transmission, a PUSCH transmission scheduled by a DCI format 0_0 via the downlink carrier 405-c of the associated cell, or a PRACH/Msg A transmission triggered by a DCI format 1_0 vi the downlink carrier 405-c of the associated cell.

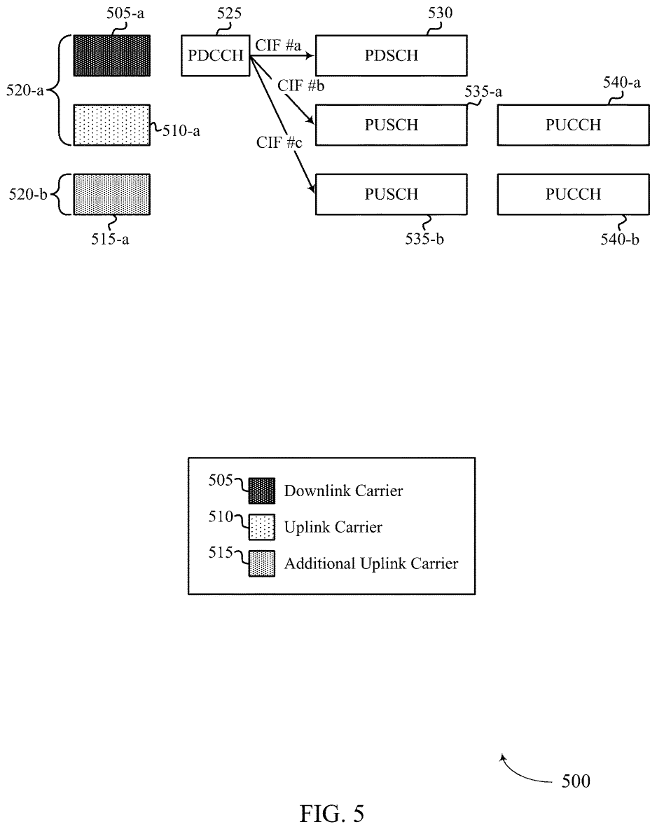

FIG. 5 shows an example of a communication framework 500 that supports capability signaling for downlink and uplink carriers and cells in different frequency bands and also a framework for SUL and uplink CA (e.g., an eSUL framework) in accordance with one or more aspects of the present disclosure. In some aspects, the communication framework 500 may implement aspects of the wireless communications systems 100 and 200 or may be implemented by aspects of the wireless communications systems 100 and 200. For example, network nodes (e.g., UEs 115, network entities 105) may use the communication framework 500 to communication uplink transmissions based on uplink carriers 510 or additional uplink carriers 515 and a downlink carrier 505 of an associated cell.

As described herein with reference to FIGS. 2 and 3, a network node (e.g., a UE 115) may be configured with a downlink carrier 505-a paired with an uplink carrier 510-a. In addition, the network node may be configured with one or more additional uplink carriers, which may be additional uplink carriers 515, including an additional uplink carrier 515-a. The additional uplink carriers 515 may include eSUL carriers, SUL carriers of SUL frequency bands, uplink carriers of an FDD cell, carrier, or band, or uplink resources of TDD cell, carrier, or band. The network node may perform a random access procedure as described herein with reference to FIG. 3 using the downlink carrier 505-a and a first candidate uplink carrier, which is determined to be either the uplink carrier 510-a or the additional uplink carrier 515-a (a selected candidate uplink carrier of the associated cell). Based on successful contention resolution at the conclusion of the random access procedure 420, the network node may enter a connected mode (e.g., may establish a wireless connection with a network entity or other network node) and transmit uplink messages.

While in a connected mode, the network node may use additional uplink carriers 515 as regular uplink component carriers for uplink CA. That is, the uplink carrier 510-a or the additional uplink carrier 515-a may be selected as a second candidate uplink carrier for uplink transmissions, which may be treated as an uplink component carrier for uplink CA while the network node is in the connected mode. The downlink carrier 505-a and the uplink carrier 510-a, which may correspond to a downlink and uplink carrier pair, may be associated with a component carrier 520-a (e.g., CC #1) and the additional uplink carrier 515-a, which supports uplink communications only, may be associated with a component carrier 520-b (e.g., CC #2). In some cases, a second network node (e.g., a network entity) may schedule an uplink transmission (e.g., a PUSCH 535) on the uplink carrier 510-a or the additional uplink carrier 515-a for the cell.

In such cases, the uplink carrier 510-a and each additional uplink carrier 515 may be treated as a regular uplink component carrier of uplink CA that is scheduled by a PDCCH 525 via the downlink carrier 505-a of the associated cell. In some aspects, timing and power control information of each of the uplink carrier 510-a and the additional uplink carriers 515 (e.g., each second candidate uplink carrier) may be based on a downlink measurement of the PDCCH 525 in the downlink carrier 505-a. In addition, each of the uplink carrier 510-a and the additional uplink carriers 515 may be associated with a corresponding set of feedback processes. That is, each uplink carrier 510 and additional uplink carrier 515 may have its own HARQ space independently of each other (which may be the same as for uplink CA).

In some aspects, the network node may support simultaneous transmissions across the uplink carrier 510-a and the additional uplink carrier 515-a based on a UE capability (e.g., a capability of the network node), which may also be the case for uplink CA. In this way, the network node may support a combination of one or more second candidate uplink carriers, which may include a combination of the uplink carrier 510-a and one or more additional uplink carriers 515. In some aspects, the network node may support uplink transmit switching across the uplink carrier 510-a and the additional uplink carriers 515 of the cell based on the capability (which may be the same as uplink CA uplink transmit switching). That is, the network node may switch the uplink transmit (Tx) chain(s) to be used for uplink transmissions from the uplink carrier 510-a (a second candidate uplink carrier) to the additional uplink carrier 515-a (a different second candidate uplink carrier), or the network node may switch from the additional uplink carrier 515-a to the uplink carrier 510-a based on the capability. Alternatively, the network node may switch the uplink Tx chains to be used for uplink transmissions from one or multiple of the uplink carrier 510-a and the additional uplink carrier 515-a (e.g., an eSUL carrier) to the other one or multiple of the uplink carrier 510-a and the additional uplink carriers 515 based on the capability. In some aspects, the network node may support half-duplex communications or full-duplex communications between the downlink carrier 505-a and each of the uplink carrier 510-a and the additional uplink carriers 515 based on the capability (the same as for uplink CA).

In some cases, the uplink carrier 510-a and the additional uplink carriers 515 may be scheduled by the PDCCH 525 via the downlink carrier 505-a of the associated cell, which may be the same as uplink CA cross-carrier scheduling. In such cases, the network node may monitor different sets of PDCCH candidates in search space sets for different scheduled uplink carriers 510 and additional uplink carriers 515. In addition, a DCI format 0_1 or a DCI format 0_2 may include a CIF field indicating on which of the uplink carrier 510-a or the additional uplink carriers 515 the DCI format is scheduling an uplink transmission. For example, if the uplink carrier 510-a is selected as a default uplink carrier for an uplink transmission (e.g., the uplink carrier 410-a for the uplink transmission 425-a as described herein with reference to FIG. 4), a PUCCH 540-a may be scheduled on the uplink carrier 510-a (a normal uplink carrier) by default unless otherwise explicitly configured or indicated to the network node.

In such cases, a CIF value (e.g., CIF #a) for a DCI format 1_1 or DCI format 1_2 scheduling a PDSCH 530 on the component carrier 520-a may be used for a DCI format 0_1 or a DCI format 0_2 scheduling a PUSCH 535- a on the component carrier 520-a (via the uplink carrier 510-a). In some aspects, the CIF value may be 0. In addition, a different CIF value may be assigned to or configured for a DCI format 0_1 or a DCI format 0_2 scheduling a PUSCH 535-b on the component carrier 520-b (via the additional uplink carrier 515-a). In such aspects, the network node may transmit multiple uplink transmissions via at least the uplink carrier 510-a, where a first value of the CIF #a used to schedule a PDSCH 530 on the downlink carrier 505-a is the same as a second value of the CIF #b used to schedule one of the uplink transmissions via the uplink carrier 510-a, and where the first value of the CIF #a is different from a third value of a CIF #c used to schedule another of the uplink transmissions via the additional uplink carrier 515-a.

Alternatively, if the additional uplink carrier 515-a is selected as the default uplink carrier for an uplink transmission (e.g., the additional uplink carrier 415-c for the uplink transmission 425-b as described herein with reference to FIG. 4), and if the additional uplink carrier 515-a is used for a random access procedure while the network node is operating in an idle mode, a PUCCH 540-b may be scheduled on the additional uplink carrier 515-a by default unless otherwise explicitly configured or indicated to the network node. In this way, the PUSCHs 535 may be dynamically scheduled by DCI, and the PUCCHs 540 may be semi-statically selected.

In such cases, a CIF value (e.g., CIF #a) for a DCI format 1_1 or DCI format 1_2 scheduling a PDSCH 530 on the component carrier 520-a may be used for a DCI format 0_1 or a DCI format 0_2 scheduling a PUSCH 535-b on the component carrier 520-b (via the additional uplink carrier 515-a). In some aspects, the CIF value may be 0. In addition, a different CIF value may be assigned to or configured for a DCI format 0_1 or a DCI format 0_2 scheduling a PUSCH 535-a on the component carrier 520-a (via the uplink carrier 510-a). In such aspects, the network node may transmit multiple uplink transmissions via at least one or more of the additional uplink carriers 515, where a first value of the CIF #a used to schedule a PDSCH 530 on the downlink carrier 505-a is the same as a second value of the CIF #b used to schedule one of the uplink transmissions via the additional uplink carrier 515-a, and where the first value of the CIF #a is different from a third value of a CIF #c used to schedule another of the uplink transmissions via another additional uplink carrier 515.

FIG. 6 shows an example of a carrier configuration 600 that supports capability signaling for downlink and uplink carriers and cells in different frequency bands (e.g., an eSUL framework) in accordance with one or more aspects of the present disclosure. In some aspects, the carrier configuration 600 may implement aspects of the wireless communications systems 100 and 200 or may be implemented by aspects of the wireless communications systems 100 and 200. For example, network nodes (e.g., UEs 115, network entities 105) may communicate via carriers and frequency bands 605 illustrated in the carrier configuration 600.

A first network node (e.g., a UE 115) may support communication over NR frequency bands or NR frequency band combinations (e.g., frequency bands 605). The first network node may report, to a second network node (e.g., a network entity), a list of frequency bands 605 that the first network node may use to communicate with the second network node. For each frequency band 605, the first network node may additionally indicate support for optional features. Additionally, or alternatively, the first network node may report a list of frequency band combinations that the first network node may be configured with CA with the second network node. In addition, for each frequency band combination, the first network node may indicate support for optional features.

For example, the first network node may support communications using the downlink and uplink carriers on a cell (e.g., respective downlink and uplink cells) in a frequency band n79 or in a frequency band n3. In some other cases, the first network node may support communications using the downlink and uplink carriers on a cell in the frequency band n79 and in the frequency band n3. In some aspects, the first network node may support CA with the frequency band combination of n79 and n3. That is, the first network node may support CA using downlink carriers, uplink carriers, or both uplink and downlink carriers in the frequency bands n79 and n3. Additionally, the first network node may support optional features for CA in the cell in the frequency bands n79 and n3.

As described herein with reference to FIG. 2, a first network node (e.g., a UE 115) may transmit capability information indicating a capability to communicate using a pair of carriers in different frequency bands 605 or in a same frequency band 605. The pair of carriers may be an uplink and downlink carrier pair, where the uplink carrier may be a normal uplink carrier or an eSUL carrier. For example, the first network node may support communication using a downlink carrier in the frequency band n79 and an uplink carrier in the frequency band n3. In addition, the first network node may support communications using a cell in an SDL carrier and uplink and eSUL carriers in different frequency bands.

In some aspects, the first network node may support communications in a frequency band 605-a and a frequency band 605-b. In such cases, the first network node may support communications via a downlink carrier of a TDD or FDD cell or band, an uplink carrier of the cell, and one or more eSUL carrier that are uplink carriers of the same TDD, FDD, or SUL cells or bands or of different TDD, FDD, or SUL cells or bands. For example, the frequency band 605-a may be a band n79 for TDD, which may be associated with a spectrum of approximately 4.5 GHz. As the first network node supports the frequency band 605-a, the first network node may support TDD operation and thus may support both downlink reception (via a downlink (DL) carrier) and uplink transmission (via an uplink (UL) carrier) for the frequency band 605-a. In addition, the frequency band 605-b may be a band n3 for FDD, which may be associated with a spectrum of approximately 1.8 GHz. By supporting the frequency band 605-b, the first network node may support FDD operation and thus may support both downlink reception (via a downlink carrier) and uplink transmission (via an eSUL carrier) for the frequency band 605-b.

In some aspects, the first network node may support communications via a downlink carrier and an uplink carrier in the same frequency band 605 (e.g., TDD operation in the frequency band 605-a). Additionally, the first network node may support optional features for the cell in the frequency bands n79 and n3. Alternatively, the first network node may support communications via the downlink carrier and an eSUL carrier via different frequency bands (e.g., the downlink carrier in the frequency band 605-a and the eSUL carrier in the frequency band 605-b).

In some other examples, the first network node may support communications in a frequency band 605-c, a frequency band 605-d, and a frequency band 605-e. In such cases, the first network node may support communications via a downlink carrier of an SDL cell or band and one or more eSUL carriers that may be uplink carriers of other TDD, FDD, or SUL cells or bands. For example, the frequency band 605-c may be a band n41 for TDD, which may be associated with a spectrum of approximately 2.5 GHz. In addition, the frequency band 605-e may be a band n29 for SDL, which may be associated with a spectrum of approximately 720 MHz. In such cases, the first network node may support a pair of carriers including an eSUL carrier (for uplink transmissions) and an SDL carrier (for downlink receptions). In some aspects, the first network node may support uplink communications using the eSUL band and downlink communications using the SDL band (e.g., FDD operation in the frequency bands 605-d and 605-e). That is, an eSUL carrier may be paired with an SDL carrier on a same or different frequency bands 605.

In some other examples, the first network node may support communication sin a frequency band 605-f and a frequency band 605-g. In such cases, the first network node may support communications via an uplink carrier of a TDD, FDD, or SUL cell or band, the uplink carrier configured as a normal uplink carrier or an eSUL carrier for more than one downlink carriers of TDD, FDD, or SDL cells or bands. For example, the frequency band 605-f may be a band n41 for TDD, which may be associated with a spectrum of approximately 2.5 GHz. In some aspects, the first network node may support uplink and downlink communications using the frequency band 605-f, or downlink communications using the frequency band 605-g and uplink communications using the frequency band 605-f. That is, an uplink carrier (e.g., an eSUL carrier) and a downlink carrier may be in different frequency bands 605 and may be paired to enable FDD operation.

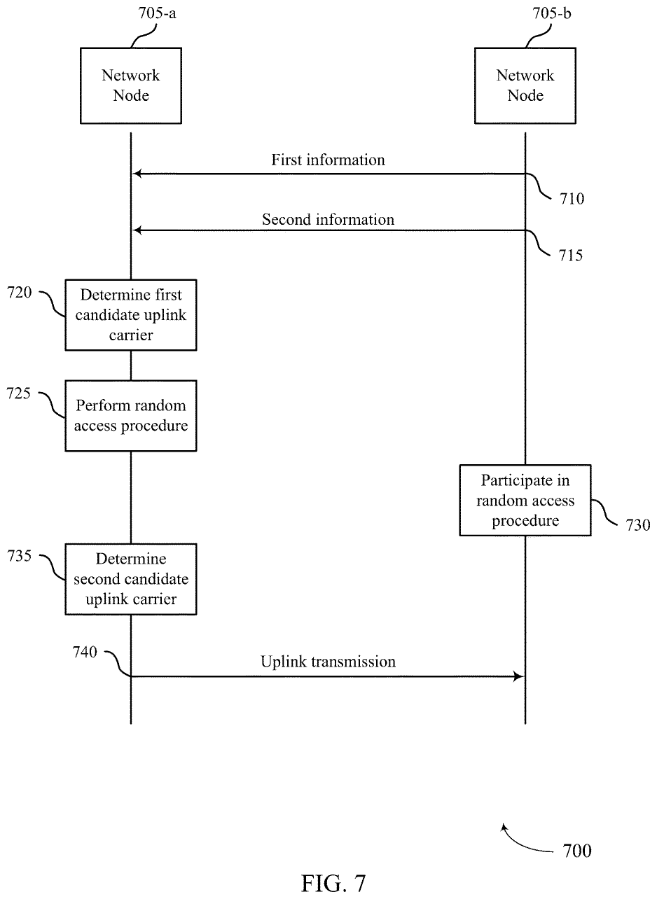

FIG. 7 shows an example of a process flow 700 that supports capability signaling for downlink and uplink carriers and cells in different frequency bands and also a framework for SUL and uplink CA (e.g., an eSUL framework) in accordance with one or more aspects of the present disclosure. The process flow 700 may implement aspects of wireless communications systems 100 and 200, or may be implemented by aspects of the wireless communications system 100 and 200. For example, the process flow 700 may illustrate operations between a network node 705-a (e.g., a UE 115) and a network node 705-b (e.g., a network entity 105) which may be examples of corresponding devices described herein. In the following description of the process flow 700, the operations between the network node 705-a and the network node 705-b may be transmitted in a different order than the example order shown, or the operations performed by the network node 705-a and the network node 705-b may be performed in different orders or at different times. Some operations may also be omitted from the process flow 700, and other operations may be added to the process flow 700.

At 710, the network node 705-a may receive, from the network node 705-b, first information indicative of first resources for use by the network node 705-a to communicate via at least one of a first uplink carrier and a first downlink carrier that is paired with the first uplink carrier in a same frequency band. The first information may be transmitted in a broadcast message (e.g., a SIB1) or a dedicated message (e.g., higher-layer signaling).

At 715, the network node 705-a may receive, from the network node 705-b, second information indicative of second resources for use by the network node 705-a to communicate via one or more second uplink carriers associated with the first downlink carrier but different from the first uplink carrier, wherein the first uplink carrier and the one or more second uplink carriers are, collectively, a set of multiple candidate uplink carriers. The second uplink carriers may include additional SUL carriers or eSUL carriers, which may be considered and used as SUL carriers when the network node 705-a is in an idle mode and as uplink component carriers in uplink CA when the network node 705-a is in an idle mode.

At 720, the network node 705-a may determine, while in an idle mode, a first candidate uplink carrier from the set of multiple candidate uplink carriers for a random access procedure. The first candidate uplink carrier may be determined as a first uplink carrier (e.g., a normal uplink carrier) or one of the second uplink carriers (e.g., an eSUL carrier).

At 725, the network node 705-a may perform the random access procedure using the first candidate uplink carrier and the first downlink carrier, wherein the first uplink carrier or one of the one or more second uplink carriers is the first candidate uplink carrier. That is, the network node 705-a may perform a 4-step or a 2-step random access procedure based on a normal uplink carrier or an eSUL carrier, and a downlink carrier of the associated cell.

At 730, the network node 705-b may participate in the random access procedure with the network node 705-a using the first candidate uplink carrier and the first downlink carrier, wherein the first uplink carrier or one of the one or more second uplink carriers is the first candidate uplink carrier. That is, the network node 705-b may participate in a 4-step or a 2-step random access procedure based on a normal uplink carrier or an eSUL carrier, and a downlink carrier of the associated cell.

At 735, the network node 705-a may determine, while in a connected mode, a second candidate uplink carrier from the set of multiple candidate uplink carriers for an uplink transmission. In some aspects, the second candidate uplink carrier may be one of a plurality of second candidate uplink carriers for a set of multiple uplink transmissions. The second candidate uplink carrier may be a normal uplink carrier or an eSUL carrier based on which type of uplink carrier was used for the random access procedure.

At 740, the network node 705-a may transmit, to the network node 705-b, after the random access procedure (e.g., based on successful contention resolution) and while the network node 705-a is still in the connected mode, an uplink transmission via the determined second candidate uplink carrier. In some aspects, the uplink transmission may occur using different component carriers based on whether the second candidate uplink carrier is the normal uplink carrier or an eSUL carrier.

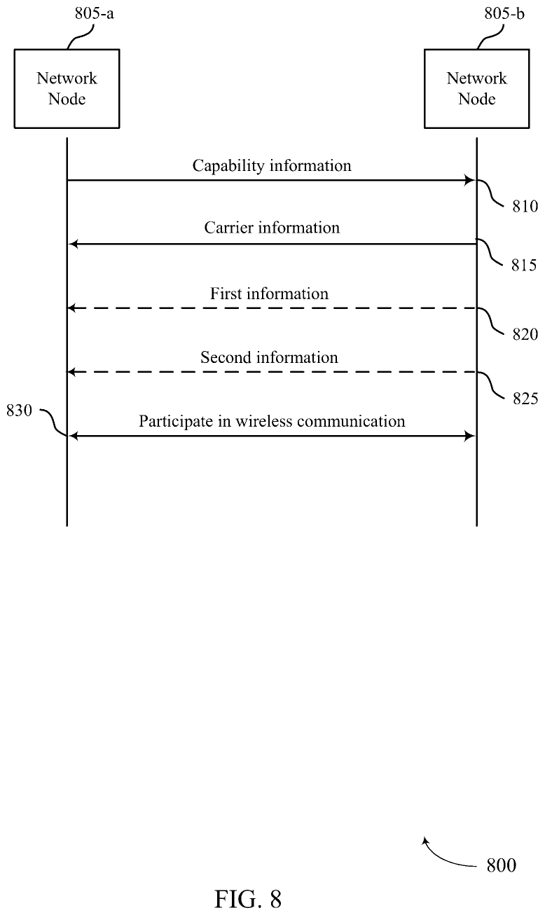

FIG. 8 shows an example of a process flow 800 that supports capability signaling for downlink and uplink carriers and cells in different frequency bands (e.g., an eSUL framework) in accordance with one or more aspects of the present disclosure. The process flow 800 may implement aspects of wireless communications systems 100 and 200, or may be implemented by aspects of the wireless communications system 100 and 200. For example, the process flow 800 may illustrate operations between a network node 805-a (e.g., a UE 115) and a network node 805-b (e.g., a network entity 105) which may be examples of corresponding devices described herein. In the following description of the process flow 800, the operations between the network node 805-a and the network node 805-b may be transmitted in a different order than the example order shown, or the operations performed by the network node 805-a and the network node 805-b may be performed in different orders or at different times. Some operations may also be omitted from the process flow 800, and other operations may be added to the process flow 800.

At 810, the network node 805-a may receive capability information from the network node 805-b. The capability information may indicate a capability of the network node 805-a to communicate using a pair of carriers in different frequency bands, where the pair of carriers includes a first downlink carrier in a first frequency band and a first uplink carrier (e.g., a normal uplink carrier, an eSUL) in a second frequency band that is different from the first frequency band. Alternatively, the capability information may indicate a capability of the network node 805-a to communicate using a pair of carriers in a same frequency band, where the pair of carriers includes a first downlink carrier in a first frequency band and a first uplink carrier in the first frequency band.

At 815, the network node 805-a may transmit carrier information to the network node 805-b that is based on the capability information. If the capability information indicated a capability of the network node 805-a to communicate using a pair of carriers in different frequency bands, the carrier information may indicate one or more downlink carriers and one or more uplink carriers for use by the network node 805-a for wireless communication, where the one or more downlink carriers includes the first downlink carrier and the one or more uplink carriers includes the first uplink carrier. Alternatively, if the capability information indicated a capability of the network node 805-a to communicate using a pair of carriers in a same frequency band, the carrier information may indicate one or more downlink carriers and one or more uplink carriers for use by the network node 805-a for wireless communication, where the one or more downlink carriers includes the first downlink carrier and the one or more uplink carriers includes the first uplink carrier and a second uplink carrier in the first frequency band, and where the carrier information includes second carrier information that is based on the capability information and based on the first uplink carrier and the second uplink carrier being in the same frequency band. That is, the second carrier information may identify an eSUL carrier.

At 820, the network node 805-a may receive, from the network node 805-b, first information indicative of first resources for use by the network node 805-a to communicate via at least one of the first uplink carrier and the first downlink carrier that is paired with the first uplink carrier. At 825, the network node 805-a may receive, from the network node 805-b, second information indicative of second resources for use by the network node 805-a to communicate via one or more second uplink carriers associated with the first downlink carrier but different from the first uplink carrier, where the first uplink carrier and the one or more second uplink carriers are, collectively, a set of multiple candidate uplink carriers. The network node 805-a may use the candidate uplink carriers for a random access procedure or an uplink transmission.

At 830, the network node 805-a may participate in wireless communication (e.g., with the network node 805-b) in accordance with the applicable carrier information, via the first downlink carrier and the first uplink carrier (e.g., a normal uplink carrier) or a second uplink carrier (e.g., an eSUL carrier).

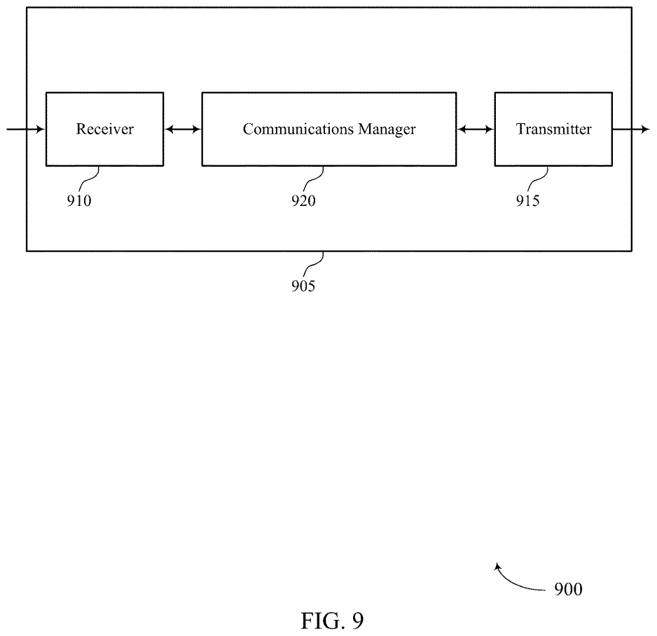

FIG. 9 shows a block diagram 900 of a device 905 that supports capability signaling for downlink and uplink carriers and cells in different frequency bands and also a framework for SUL and uplink CA (e.g., an eSUL framework) in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to a framework for SUL and uplink CA and capability signaling for downlink and uplink carriers and cells in different frequency bands). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to a framework for SUL and uplink CA and capability signaling for downlink and uplink carriers and cells in different frequency bands). In some aspects, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of a framework for SUL and uplink CA and capability signaling for downlink and uplink carriers and cells in different frequency bands as described herein. For example, the communications manager 920, the receiver 910, the transmitter 915, or various combinations or components thereof may support a method for performing one or more of the functions described herein.

In some aspects, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

For example, the communications manager 920 is capable of, configured to, or operable to support a means for receiving first information indicative of first resources for use by the first network node to communicate via at least one of a first uplink carrier and a first downlink carrier that is paired with the first uplink carrier in a same frequency band. The communications manager 920 is capable of, configured to, or operable to support a means for receiving second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers. The communications manager 920 is capable of, configured to, or operable to support a means for determining, while the first network node is in an idle mode, a first candidate uplink carrier from the set of multiple candidate uplink carriers for a random access procedure. The communications manager 920 is capable of, configured to, or operable to support a means for determining, while the first network node is in a connected mode, a second candidate uplink carrier from the set of multiple candidate uplink carriers for an uplink transmission.

For example, the communications manager 920 is capable of, configured to, or operable to support a means for transmitting capability information, the capability information indicative of a capability of the first network node to communicate using a pair of carriers in different frequency bands, where the pair of carriers includes a first downlink carrier in a first frequency band and a first uplink carrier in a second frequency band that is different from the first frequency band. The communications manager 920 is capable of, configured to, or operable to support a means for receiving carrier information indicative of one or more downlink carriers and one or more uplink carriers for use by the first network node for wireless communication, where the one or more downlink carriers includes the first downlink carrier and the one or more uplink carriers includes the first uplink carrier, where the carrier information is based on the capability information. The communications manager 920 is capable of, configured to, or operable to support a means for participating in the wireless communication, in accordance with the carrier information, via the first downlink carrier and the first uplink carrier.

For example, the communications manager 920 is capable of, configured to, or operable to support a means for transmitting capability information, the capability information indicative of a capability of the first network node to communicate using a pair of carriers in a same frequency band, where the pair of carriers includes a first downlink carrier in a first frequency band and a first uplink carrier in the first frequency band. The communications manager 920 is capable of, configured to, or operable to support a means for receiving carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band. The communications manager 920 is capable of, configured to, or operable to support a means for participating in the wireless communication, in accordance with the carrier information, via the first downlink carrier and the second uplink carrier.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for a unified framework for SUL and uplink CA and capability signaling for downlink and uplink carriers and cells in different frequency bands, which may reduce latency, increase spectral efficiency, improve resource utilization efficiency, increase signaling capacity, and improve communications between network nodes.

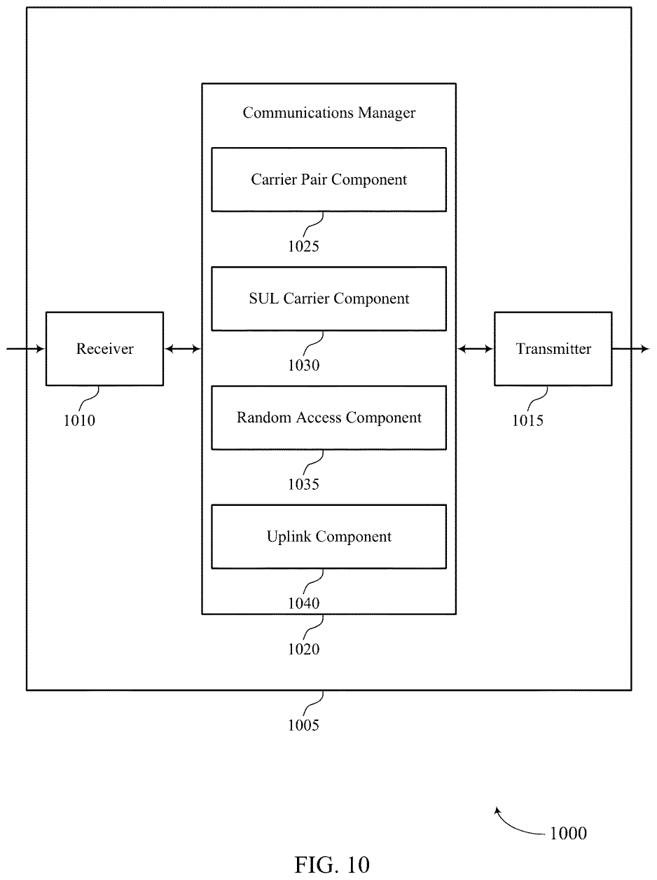

FIG. 10 shows a block diagram 1000 of a device 1005 that supports a framework for SUL and uplink CA (e.g., an eSUL framework) in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to a framework for SUL and uplink CA). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to a framework for SUL and uplink CA). In some aspects, the transmitter 1015 may be co-located with a receiver 1010 in a transceiver module. The transmitter 1015 may utilize a single antenna or a set of multiple antennas.

The device 1005, or various components thereof, may be an example of means for performing various aspects of a framework for SUL and uplink CA as described herein. For example, the communications manager 1020 may include a carrier pair component 1025, an SUL carrier component 1030, a random access component 1035, an uplink component 1040, or any combination thereof. The communications manager 1020 may be an example of aspects of a communications manager 920 as described herein. In some aspects, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The carrier pair component 1025 is capable of, configured to, or operable to support a means for receiving first information indicative of first resources for use by the first network node to communicate via at least one of a first uplink carrier and a first downlink carrier that is paired with the first uplink carrier in a same frequency band. The SUL carrier component 1030 is capable of, configured to, or operable to support a means for receiving second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers. The random access component 1035 is capable of, configured to, or operable to support a means for determining, while the first network node is in an idle mode, a first candidate uplink carrier from the set of multiple candidate uplink carriers for a random access procedure. The uplink component 1040 is capable of, configured to, or operable to support a means for determining, while the first network node is in a connected mode, a second candidate uplink carrier from the set of multiple candidate uplink carriers for an uplink transmission.

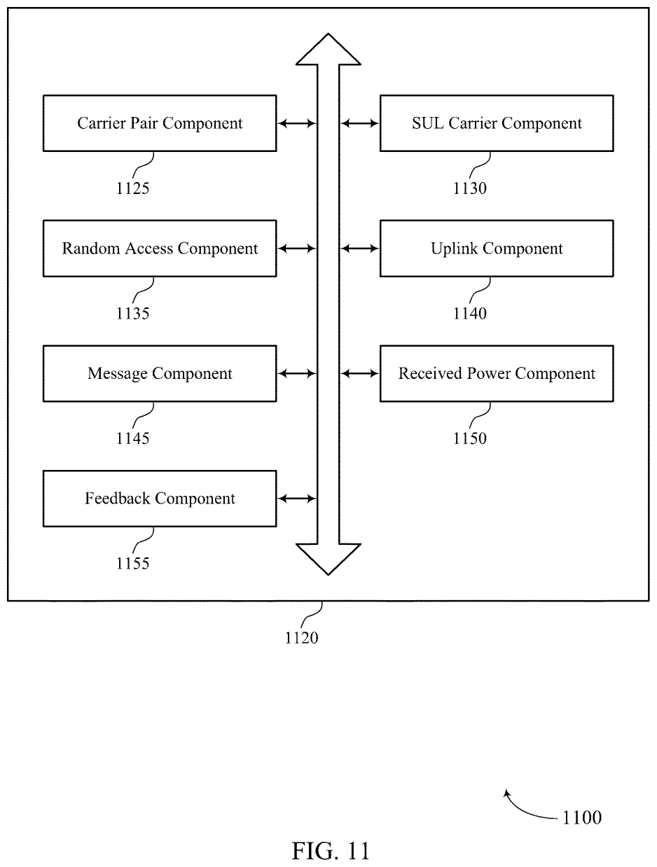

FIG. 11 shows a block diagram 1100 of a communications manager 1120 that supports a framework for SUL and uplink CA (e.g., an eSUL framework) in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of a framework for SUL and uplink CA as described herein. For example, the communications manager 1120 may include a carrier pair component 1125, an SUL carrier component 1130, a random access component 1135, an uplink component 1140, a message component 1145, a received power component 1150, a feedback component 1155, or any combination thereof. Each of these components may communicate, directly or indirectly, with one another (e.g., via one or more buses).

The carrier pair component 1125 is capable of, configured to, or operable to support a means for receiving first information indicative of first resources for use by the first network node to communicate via at least one of a first uplink carrier and a first downlink carrier that is paired with the first uplink carrier in a same frequency band. The SUL carrier component 1130 is capable of, configured to, or operable to support a means for receiving second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers. The random access component 1135 is capable of, configured to, or operable to support a means for determining, while the first network node is in an idle mode, a first candidate uplink carrier from the set of multiple candidate uplink carriers for a random access procedure. The uplink component 1140 is capable of, configured to, or operable to support a means for determining, while the first network node is in a connected mode, a second candidate uplink carrier from the set of multiple candidate uplink carriers for an uplink transmission.

In some aspects, to support receiving the second information, the message component 1145 is capable of, configured to, or operable to support a means for receiving a broadcast or dedicated message that includes the second information, where the second information is indicative of at least one of frequency information for each of the one or more second uplink carriers, uplink bandwidth part information for each of the one or more second uplink carriers, or timer information that pertains to a time alignment for each of the one or more second uplink carriers. In some aspects, the second information includes criteria for determination, by the first network node, of the first candidate uplink carrier.

In some aspects, to support determining the first candidate uplink carrier, the received power component 1150 is capable of, configured to, or operable to support a means for determining a received power value. In some aspects, to support determining the first candidate uplink carrier, the received power component 1150 is capable of, configured to, or operable to support a means for determining either the first uplink carrier or one of the one or more second uplink carriers as the first candidate uplink carrier based on a first comparison of the received power value and the first received power threshold.

In some aspects, the criteria includes one or more second received power thresholds and an association between each of the one or more second uplink carriers and a respective range of received power values, each respective range of received power values bounded by at least one of the one or more second received power thresholds.

In some aspects, the determination of the first candidate uplink carrier from among the one or more second uplink carriers is based on a second comparison of the received power value and the one or more second received power thresholds.

In some aspects, the random access component 1135 is capable of, configured to, or operable to support a means for performing the random access procedure using the first candidate uplink carrier and the first downlink carrier, where one of the one or more second uplink carriers is the first candidate uplink carrier.

In some aspects, to support performing the random access procedure, the random access component 1135 is capable of, configured to, or operable to support a means for transmitting a random access message via the first candidate uplink carrier. In some aspects, to support performing the random access procedure, the random access component 1135 is capable of, configured to, or operable to support a means for monitoring a downlink channel for a random access response message transmitted via the first downlink carrier, where the random access response message schedules transmission of an uplink shared channel message via the first candidate uplink carrier. In some aspects, to support performing the random access procedure, the random access component 1135 is capable of, configured to, or operable to support a means for transmitting the uplink shared channel message via the first candidate uplink carrier based on the random access response message. In some aspects, to support performing the random access procedure, the random access component 1135 is capable of, configured to, or operable to support a means for receiving a contention resolution downlink message via the first downlink carrier based on the uplink shared channel message.

In some aspects, to support performing the random access procedure, the random access component 1135 is capable of, configured to, or operable to support a means for transmitting a random access message via the first candidate uplink carrier. In some aspects, to support performing the random access procedure, the random access component 1135 is capable of, configured to, or operable to support a means for monitoring a downlink channel for a downlink message transmitted via the first downlink carrier based on the random access message.

In some aspects, to support determining the second candidate uplink carrier, the uplink component 1140 is capable of, configured to, or operable to support a means for determining the first uplink carrier as the second candidate uplink carrier, where determination of the first uplink carrier is based on one of the one or more second uplink carriers being determined as the first candidate uplink carrier for the random access procedure.

In some aspects, the feedback component 1155 is capable of, configured to, or operable to support a means for transmitting, via the first uplink carrier, a feedback message in response to conclusion of the random access procedure. In some aspects, the uplink component 1140 is capable of, configured to, or operable to support a means for transmitting the uplink transmission via at least the first uplink carrier.

In some aspects, the feedback component 1155 is capable of, configured to, or operable to support a means for transmitting, via the first candidate uplink carrier, a feedback message in response to conclusion of the random access procedure. In some aspects, the uplink component 1140 is capable of, configured to, or operable to support a means for transmitting the uplink transmission via at least the first candidate uplink carrier.

In some aspects, the uplink component 1140 is capable of, configured to, or operable to support a means for transmitting the set of multiple uplink transmissions via at least the first uplink carrier, where a first value of a first carrier information field used to schedule a downlink shared channel message on the first downlink carrier is a same as a second value of a second carrier information field used to schedule one of the set of multiple uplink transmissions via the first uplink carrier, and where the first value is different from a third value of a third carrier information field used to schedule another of the set of multiple uplink transmissions via one of the one or more second uplink carriers.

In some aspects, to support determining the second candidate uplink carrier, the uplink component 1140 is capable of, configured to, or operable to support a means for determining one of the one or more second uplink carriers as the second candidate uplink carrier, where determination of the one of the one or more second uplink carriers is based on the one of the one or more second uplink carriers being determined as the first candidate uplink carrier for the random access procedure.

In some aspects, the uplink component 1140 is capable of, configured to, or operable to support a means for transmitting the set of multiple uplink transmissions via at least the one of the one or more second uplink carriers, where a first value of a first carrier information field used to schedule a downlink shared channel message on the first downlink carrier is different from a second value of a second carrier information field used to schedule one of the set of multiple uplink transmissions via the one of the one or more second uplink carriers, and where the first value is different from a third value of a third carrier information field used to schedule another of the set of multiple uplink transmissions via another of the one or more second uplink carriers.

In some aspects, the feedback component 1155 is capable of, configured to, or operable to support a means for transmitting, via the one of the one or more second uplink carriers, a feedback message in response to conclusion of the random access procedure. In some aspects, the uplink component 1140 is capable of, configured to, or operable to support a means for transmitting the uplink transmission via at least the one of the one or more second uplink carriers.

In some aspects, the uplink transmission includes one or more of an uplink control channel message, an uplink shared channel message, or a random access channel message. In some aspects, the second candidate uplink carrier is an uplink component carrier for CA while the first network node is in the connected mode.

In some aspects, the second candidate uplink carrier is associated with a corresponding set of feedback processes. In some aspects, a combination of one or more second candidate uplink carriers including the second candidate uplink carrier is based on a capability of the first network node.

In some aspects, the uplink component 1140 is capable of, configured to, or operable to support a means for switching from the second candidate uplink carrier to a different second candidate uplink carrier based on a capability of the first network node.

In some aspects, the second candidate uplink carrier is scheduled based on a downlink message associated with a same cell. In some aspects, half-duplex operation or full-duplex operation between the first downlink carrier and the second candidate uplink carrier is based on a capability of the first network node.

In some aspects, the first uplink carrier and the one or more second uplink carriers are in different frequency bands. In some aspects, the first uplink carrier and the one or more second uplink carriers are in a same frequency band.

In some aspects, the first uplink carrier and the one or more second uplink carriers are for communication between the first network node and different cells. In some aspects, the first uplink carrier and the one or more second uplink carriers are for communication between the first network node and a same cell.

In some aspects, the idle mode and the connected mode are communication states of the first network node with respect to a second network node, where communications during the connected mode are over resources that are allocated for use by the first network node, and where communications during the idle mode are over resources that are allocated for common network node use. In some aspects, the second candidate uplink carrier is a set of multiple second candidate uplink carriers of the set of multiple candidate uplink carriers.

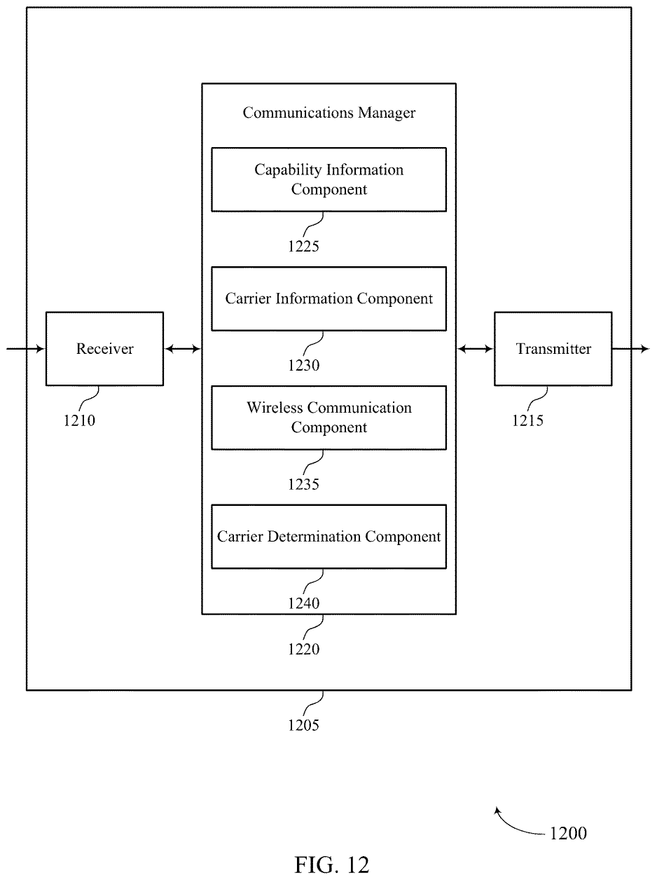

FIG. 12 shows a block diagram 1200 of a device 1205 that supports capability signaling for downlink and uplink carriers and cells in different frequency bands in accordance with one or more aspects of the present disclosure. The device 1205 may be an example of aspects of a device 1005 or a UE 115 as described herein. The device 1205 may include a receiver 1210, a transmitter 1215, and a communications manager 1220. The device 1205, or one of more components of the device 1205 (e.g., the receiver 1210, the transmitter 1215, and the communications manager 1220), may also include at least one communication interface, and at least one processor coupled to the communication interface, to support the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to capability signaling for downlink and uplink carriers and cells in different frequency bands). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to capability signaling for downlink and uplink carriers and cells in different frequency bands). In some aspects, the transmitter 1215 may be co-located with a receiver 1210 in a transceiver module. The transmitter 1215 may utilize a single antenna or a set of multiple antennas.

The device 1205, or various components thereof, may be an example of means for performing various aspects of capability signaling for downlink and uplink carriers and cells in different frequency bands as described herein. For example, the communications manager 1220 may include a capability information component 1225, a carrier information component 1230, a wireless communication component 1235, a carrier determination component 1240, or any combination thereof. The communications manager 1220 may be an example of aspects of a communications manager 1220 as described herein. In some aspects, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The capability information component 1225 is capable of, configured to, or operable to support a means for transmitting capability information, the capability information indicative of a capability of the first network node to communicate using a pair of carriers in different frequency bands, where the pair of carriers includes a first downlink carrier in a first frequency band and a first uplink carrier in a second frequency band that is different from the first frequency band. The carrier information component 1230 is capable of, configured to, or operable to support a means for receiving carrier information indicative of one or more downlink carriers and one or more uplink carriers for use by the first network node for wireless communication, where the one or more downlink carriers includes the first downlink carrier and the one or more uplink carriers includes the first uplink carrier, where the carrier information is based on the capability information. The wireless communication component 1235 is capable of, configured to, or operable to support a means for participating in the wireless communication, in accordance with the carrier information, via the first downlink carrier and the first uplink carrier.

The capability information component 1225 is capable of, configured to, or operable to support a means for transmitting capability information, the capability information indicative of a capability of the first network node to communicate using a pair of carriers in a same frequency band, where the pair of carriers includes a first downlink carrier in a first frequency band and a first uplink carrier in the first frequency band. The carrier determination component 1240 is capable of, configured to, or operable to support a means for receiving carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band. The wireless communication component 1235 is capable of, configured to, or operable to support a means for participating in the wireless communication, in accordance with the carrier information, via the first downlink carrier and the second uplink carrier.

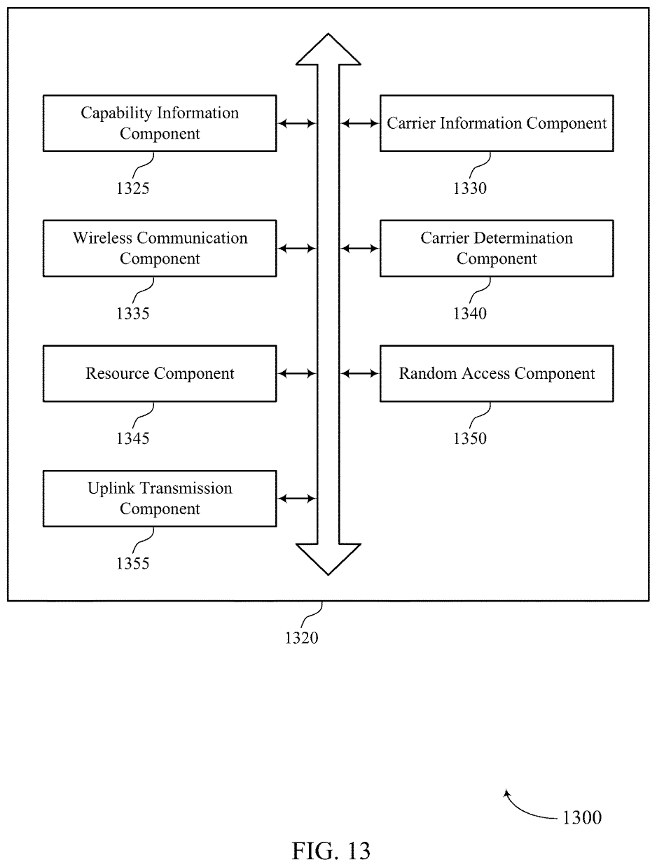

FIG. 13 shows a block diagram 1300 of a communications manager 1320 that supports capability signaling for downlink and uplink carriers and cells in different frequency bands in accordance with one or more aspects of the present disclosure. The communications manager 1320 may be an example of aspects of a communications manager 1320, a communications manager 1220, or both, as described herein. The communications manager 1320, or various components thereof, may be an example of means for performing various aspects of capability signaling for downlink and uplink carriers and cells in different frequency bands as described herein. For example, the communications manager 1320 may include a capability information component 1325, a carrier information component 1330, a wireless communication component 1335, a carrier determination component 1340, a resource component 1345, a random access component 1350, an uplink transmission component 1355, or any combination thereof. Each of these components, or components of subcomponents thereof (e.g., one or more processors, one or more memories), may communicate, directly or indirectly, with one another (e.g., via one or more buses).

The capability information component 1325 is capable of, configured to, or operable to support a means for transmitting capability information, the capability information indicative of a capability of the first network node to communicate using a pair of carriers in different frequency bands, where the pair of carriers includes a first downlink carrier in a first frequency band and a first uplink carrier in a second frequency band that is different from the first frequency band. The carrier information component 1330 is capable of, configured to, or operable to support a means for receiving carrier information indicative of one or more downlink carriers and one or more uplink carriers for use by the first network node for wireless communication, where the one or more downlink carriers includes the first downlink carrier and the one or more uplink carriers includes the first uplink carrier, where the carrier information is based on the capability information. The wireless communication component 1335 is capable of, configured to, or operable to support a means for participating in the wireless communication, in accordance with the carrier information, via the first downlink carrier and the first uplink carrier.

In some aspects, the capability information includes a first indication that the first network node supports communications in the first frequency band and a second indication that the first network node supports communications in the second frequency band. In some aspects, the capability of the first network node to communicate using the pair of carriers is indicated by the first indication and the second indication.

In some aspects, the capability information includes a first list of individual frequency bands in which the first network node supports both downlink communication and uplink communication via each of the individual frequency bands, and a second list of pairs of frequency bands in which the first network node supports, for each pair, downlink communication via a first pair component in a respective pair and uplink communication associated with the downlink communication, via a second pair component in the respective pair. In some aspects, the first frequency band and the second frequency band are one of the pairs of frequency bands included in the second list.

In some aspects, the capability information is indicative of one or more first sets of features supported by the first network node and one or more second sets of features supported by the first network node. In some aspects, individual sets of the one or more first sets of features are associated with respective downlink frequency bands in the second list of pairs of frequency bands. In some aspects, individual sets of the one or more second sets of features are associated with respective uplink frequency bands in the second list of pairs of frequency bands. In some aspects, the capability information indicates the one or more first sets of features and the one or more second sets of features separate from a third set of features supported by the first network node and each associated with a respective individual frequency band from the first list.

In some aspects, the capability information includes a list of individual frequency bands in which the first network node supports both downlink communication and uplink communication via each of the individual frequency bands. In some aspects, the list includes additional sets of uplink frequency bands, each set of uplink frequency bands associated with a respective one of the individual frequency bands in the list. In some aspects, the second frequency band is included in one of the additional sets of uplink frequency bands whose respective one of the individual frequency bands is the first frequency band.

In some aspects, the capability information is indicative of one or more first sets of features supported by the first network node and each associated with a respective individual frequency band from the list. In some aspects, the capability information is also indicative of one or more second sets of features supported by the first network node and each associated with at least one uplink frequency band of a respective set of the additional sets of uplink frequency bands.

In some aspects, the first frequency band is a TDD band and. In some aspects, the second frequency band is a FDD band or a SUL band.

In some aspects, the one or more downlink carriers includes a SDL carrier. In some aspects, the first frequency band is a SDL band that includes the SDL carrier.

In some aspects, to support receiving the carrier information, the resource component 1345 is capable of, configured to, or operable to support a means for receiving first information indicative of first resources for use by the first network node to communicate via at least one of the first uplink carrier and the first downlink carrier that is paired with the first uplink carrier. In some aspects, to support receiving the carrier information, the resource component 1345 is capable of, configured to, or operable to support a means for receiving second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers.

In some aspects, to support participating in the wireless communication, the random access component 1350 is capable of, configured to, or operable to support a means for determine, while the first network node is in an idle mode, a first candidate uplink carrier from a set of multiple candidate uplink carriers for a random access procedure. In some aspects, to support participating in the wireless communication, the uplink transmission component 1355 is capable of, configured to, or operable to support a means for determine, while the first network node is in a connected mode, a second candidate uplink carrier from the set of multiple candidate uplink carriers for an uplink transmission.

In some aspects, the idle mode and the connected mode are communication states of the first network node with respect to a second network node. In some aspects, communications during the connected mode are over resources that are allocated for use by the first network node. In some aspects, communications during the idle mode are over resources that are allocated for common network node use.

In some aspects, the capability information component 1325 is capable of, configured to, or operable to support a means for transmitting capability information, the capability information indicative of a capability of the first network node to communicate using a pair of carriers in a same frequency band, where the pair of carriers includes a first downlink carrier in a first frequency band and a first uplink carrier in the first frequency band. The 31carrier determination component 1240 is capable of, configured to, or operable to support a means for receiving carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band. In some aspects, the wireless communication component 1335 is capable of, configured to, or operable to support a means for participating in the wireless communication, in accordance with the carrier information, via the first downlink carrier and the second uplink carrier.

In some aspects, the capability information includes a first indication that the first network node supports communications in the first frequency band and a second indication that the first network node supports communications in a second frequency band. In some aspects, the capability of the first network node to communicate using the pair of carriers is indicated by the first indication and the second indication.

In some aspects, the second uplink carrier is a SUL carrier when the first network node is in an idle mode and an uplink component carrier for CA while the first network node is in a connected mode.

In some aspects, to support receiving the carrier information, the resource component 1345 is capable of, configured to, or operable to support a means for receiving first information indicative of first resources for use by the first network node to communicate via at least one of the first uplink carrier and the first downlink carrier that is paired with the first uplink carrier. In some aspects, to support receiving the carrier information, the resource component 1345 is capable of, configured to, or operable to support a means for receiving second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers.

In some aspects, to support participating in the wireless communication, the random access component 1350 is capable of, configured to, or operable to support a means for determine, while the first network node is in an idle mode, a first candidate uplink carrier from a set of multiple candidate uplink carriers for a random access procedure. In some aspects, to support participating in the wireless communication, the uplink transmission component 1355 is capable of, configured to, or operable to support a means for determine, while the first network node is in a connected mode, a second candidate uplink carrier from the set of multiple candidate uplink carriers for an uplink transmission.

In some aspects, the idle mode and the connected mode are communication states of the first network node with respect to a second network node. In some aspects, communications during the connected mode are over resources that are allocated for use by the first network node. In some aspects, communications during the idle mode are over resources that are allocated for common network node use. In some aspects, the first frequency band is a TDD band.

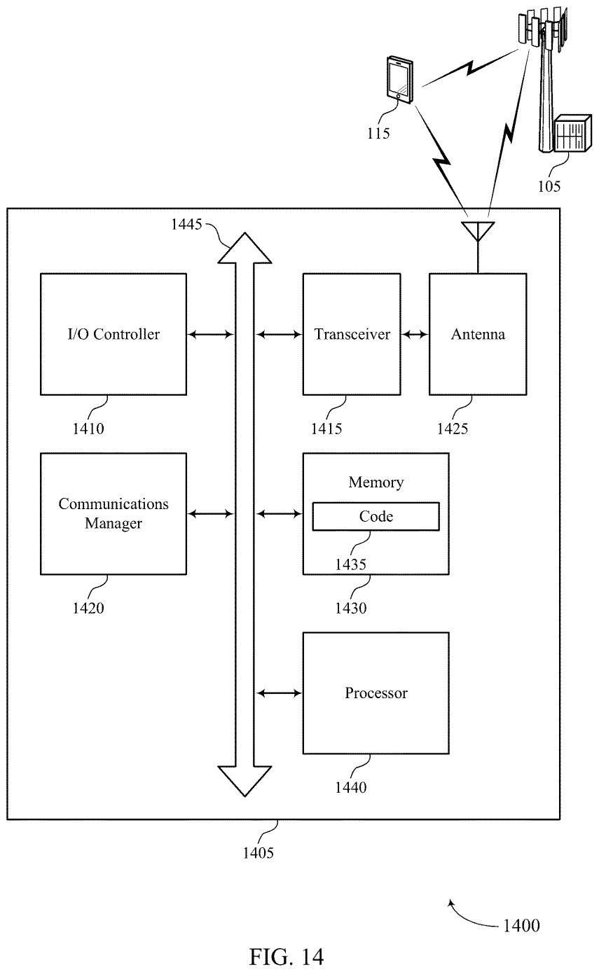

FIG. 14 shows a diagram of a system 1400 including a device 1405 that supports capability signaling for downlink and uplink carriers and cells in different frequency bands and also a framework for SUL and uplink CA (e.g., an eSUL framework) in accordance with one or more aspects of the present disclosure. The device 1405 may be an example of or include the components of a device 905, a device 1005, or a UE 115 as described herein. The device 1405 may communicate (e.g., wirelessly) with one or more network entities 105, one or more UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another operating system. Additionally, or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 915, a transmitter 1015, a receiver 910, a receiver 1010, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting a framework for SUL and uplink CA and capability signaling for downlink and uplink carriers and cells in different frequency bands). For example, the device 1405 or a component of the device 1405 may include a processor 1440 and memory 1430 coupled with or to the processor 1440, the processor 1440 and memory 1430 configured to perform various functions described herein.

For example, the communications manager 1420 is capable of, configured to, or operable to support a means for receiving first information indicative of first resources for use by the first network node to communicate via at least one of a first uplink carrier and a first downlink carrier that is paired with the first uplink carrier in a same frequency band. The communications manager 1420 is capable of, configured to, or operable to support a means for receiving second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers. The communications manager 1420 is capable of, configured to, or operable to support a means for determining, while the first network node is in an idle mode, a first candidate uplink carrier from the set of multiple candidate uplink carriers for a random access procedure. The communications manager 1420 is capable of, configured to, or operable to support a means for determining, while the first network node is in a connected mode, a second candidate uplink carrier from the set of multiple candidate uplink carriers for an uplink transmission.

For example, the communications manager 720 is capable of, configured to, or operable to support a means for transmitting capability information, the capability information indicative of a capability of the first network node to communicate using a pair of carriers in different frequency bands, where the pair of carriers includes a first downlink carrier in a first frequency band and a first uplink carrier in a second frequency band that is different from the first frequency band. The communications manager 720 is capable of, configured to, or operable to support a means for receiving carrier information indicative of one or more downlink carriers and one or more uplink carriers for use by the first network node for wireless communication, where the one or more downlink carriers includes the first downlink carrier and the one or more uplink carriers includes the first uplink carrier, where the carrier information is based on the capability information. The communications manager 720 is capable of, configured to, or operable to support a means for participating in the wireless communication, in accordance with the carrier information, via the first downlink carrier and the first uplink carrier.

For example, the communications manager 720 is capable of, configured to, or operable to support a means for transmitting capability information, the capability information indicative of a capability of the first network node to communicate using a pair of carriers in a same frequency band, where the pair of carriers includes a first downlink carrier in a first frequency band and a first uplink carrier in the first frequency band. The communications manager 720 is capable of, configured to, or operable to support a means for receiving carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band. The communications manager 720 is capable of, configured to, or operable to support a means for participating in the wireless communication, in accordance with the carrier information, via the first downlink carrier and the second uplink carrier.

By including or configuring the communications manager 1420 in accordance with examples as described herein, the device 1405 may support techniques for a unified framework for SUL and uplink CA and capability signaling for downlink and uplink carriers and cells in different frequency bands, which may reduce latency, increase spectral efficiency, improve resource utilization efficiency, increase signaling capacity, and improve communications between network nodes.

In some aspects, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some aspects, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of a framework for SUL and uplink CA and capability signaling for downlink and uplink carriers and cells in different frequency bands as described herein, or the processor 1440 and the memory 1430 may be otherwise configured to perform or support such operations.

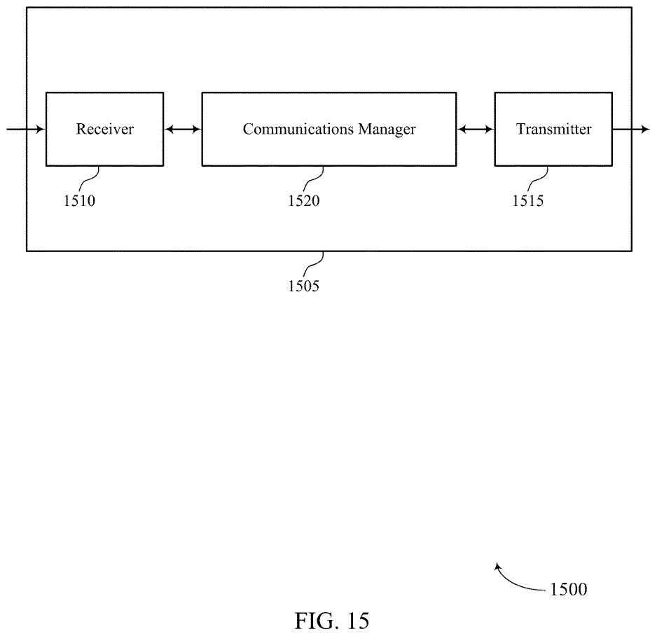

FIG. 15 shows a block diagram 1500 of a device 1505 that supports capability signaling for downlink and uplink carriers and cells in different frequency bands and also a framework for SUL and uplink CA (e.g., an eSUL framework) in accordance with one or more aspects of the present disclosure. The device 1505 may be an example of aspects of a network entity 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some aspects, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some aspects, the transmitter 1515 and the receiver 1510 may be co-located in a transceiver, which may include or be coupled with a modem.

The communications manager 1520, the receiver 1510, the transmitter 1515, or various combinations thereof or various components thereof may be examples of means for performing various aspects of a framework for SUL and uplink CA and capability signaling for downlink and uplink carriers and cells in different frequency bands as described herein. For example, the communications manager 1520, the receiver 1510, the transmitter 1515, or various combinations or components thereof may support a method for performing one or more of the functions described herein.

In some aspects, the communications manager 1520, the receiver 1510, the transmitter 1515, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 1520, the receiver 1510, the transmitter 1515, or various combinations or components thereof may be implemented in code (e.g., as communications management software or firmware) executed by a processor. If implemented in code executed by a processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

For example, the communications manager 1520 is capable of, configured to, or operable to support a means for transmitting first information indicative of first resources for use by a second network node to communicate via at least one of a first uplink carrier and a first downlink carrier that is paired with the first uplink carrier in a same frequency band. The communications manager 1520 is capable of, configured to, or operable to support a means for transmitting second information indicative of second resources for use by the second network node to communicate via one or more second uplink carriers associated with the first downlink carrier but different from the first uplink carrier, where the first uplink carrier and the one or more second uplink carriers are, collectively, a set of multiple candidate uplink carriers. The communications manager 1520 is capable of, configured to, or operable to support a means for participating in a random access procedure with the second network node using a first candidate uplink carrier of the set of multiple candidate uplink carriers. The communications manager 1520 is capable of, configured to, or operable to support a means for receiving, after the random access procedure and while the second network node is in a connected mode, an uplink transmission via a second candidate uplink carrier from the set of multiple candidate uplink carriers.

For example, the communications manager 920 is capable of, configured to, or operable to support a means for receiving capability information, the capability information indicative of a capability of a second network node to communicate using a pair of carriers in different frequency bands, where the pair of carriers includes a first downlink carrier in a first frequency band and a first uplink carrier in a second frequency band that is different from the first frequency band. The communications manager 920 is capable of, configured to, or operable to support a means for transmitting carrier information indicative of one or more downlink carriers and one or more uplink carriers for use by the second network node for wireless communication, where the one or more downlink carriers includes the first downlink carrier and the one or more uplink carriers includes the first uplink carrier, where the carrier information is based on the capability information. The communications manager 920 is capable of, configured to, or operable to support a means for participating in the wireless communication, in accordance with the carrier information, via the first downlink carrier and the first uplink carrier.

For example, the communications manager 920 is capable of, configured to, or operable to support a means for receiving capability information, the capability information indicative of a capability of a second network node to communicate using a pair of carriers in a same frequency band, where the pair of carriers includes a first downlink carrier in a first frequency band and a first uplink carrier in the first frequency band. The communications manager 920 is capable of, configured to, or operable to support a means for transmitting carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band. The communications manager 920 is capable of, configured to, or operable to support a means for participating in the wireless communication, in accordance with the carrier information, via the first downlink carrier and the second uplink carrier.

By including or configuring the communications manager 1520 in accordance with examples as described herein, the device 1505 (e.g., a processor controlling or otherwise coupled with the receiver 1510, the transmitter 1515, the communications manager 1520, or a combination thereof) may support techniques for a unified framework for SUL and uplink CA and capability signaling for uplink and downlink carriers in different frequency bands, which may reduce latency, increase spectral efficiency, improve resource utilization efficiency, increase signaling capacity, and improve communications between network nodes.

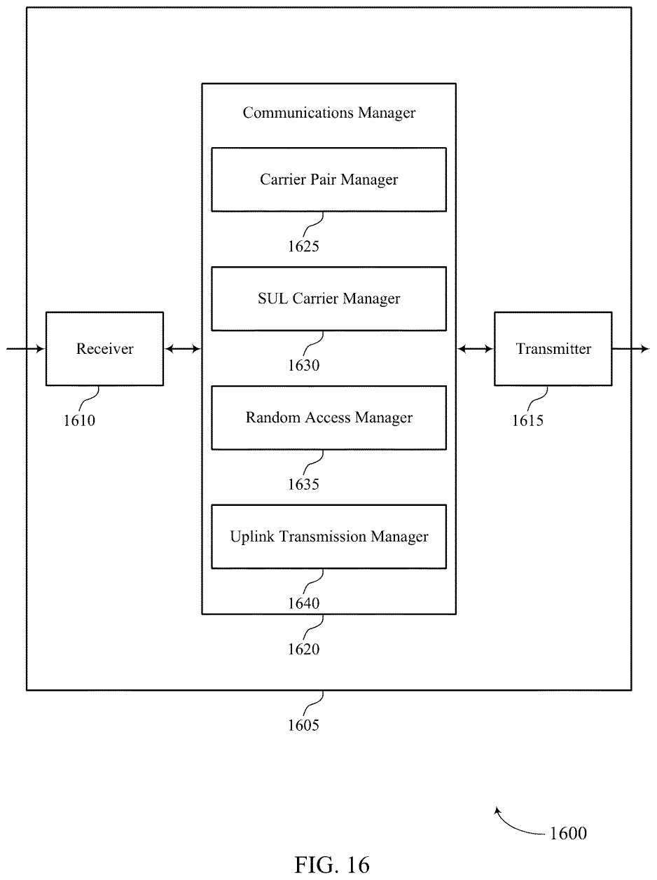

FIG. 16 shows a block diagram 1600 of a device 1605 that supports capability signaling for downlink and uplink carriers and cells in different frequency bands (e.g., an eSUL framework) in accordance with one or more aspects of the present disclosure. The device 1605 may be an example of aspects of a device 1505 or a network entity 105 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some aspects, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some aspects, the transmitter 1615 and the receiver 1610 may be co-located in a transceiver, which may include or be coupled with a modem.

The device 1605, or various components thereof, may be an example of means for performing various aspects of a framework for SUL and uplink CA as described herein. For example, the communications manager 1620 may include a carrier pair manager 1625, an SUL carrier manager 1630, a random access manager 1635, an uplink transmission manager 1640, or any combination thereof. The communications manager 1620 may be an example of aspects of a communications manager 1520 as described herein. In some aspects, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The carrier pair manager 1625 is capable of, configured to, or operable to support a means for transmitting first information indicative of first resources for use by a second network node to communicate via at least one of a first uplink carrier and a first downlink carrier that is paired with the first uplink carrier in a same frequency band. The SUL carrier manager 1630 is capable of, configured to, or operable to support a means for transmitting second information indicative of second resources for use by the second network node to communicate via one or more second uplink carriers associated with the first downlink carrier but different from the first uplink carrier, where the first uplink carrier and the one or more second uplink carriers are, collectively, a set of multiple candidate uplink carriers. The random access manager 1635 is capable of, configured to, or operable to support a means for participating in a random access procedure with the second network node using a first candidate uplink carrier of the set of multiple candidate uplink carriers. The uplink transmission manager 1640 is capable of, configured to, or operable to support a means for receiving, after the random access procedure and while the second network node is in a connected mode, an uplink transmission via a second candidate uplink carrier from the set of multiple candidate uplink carriers.

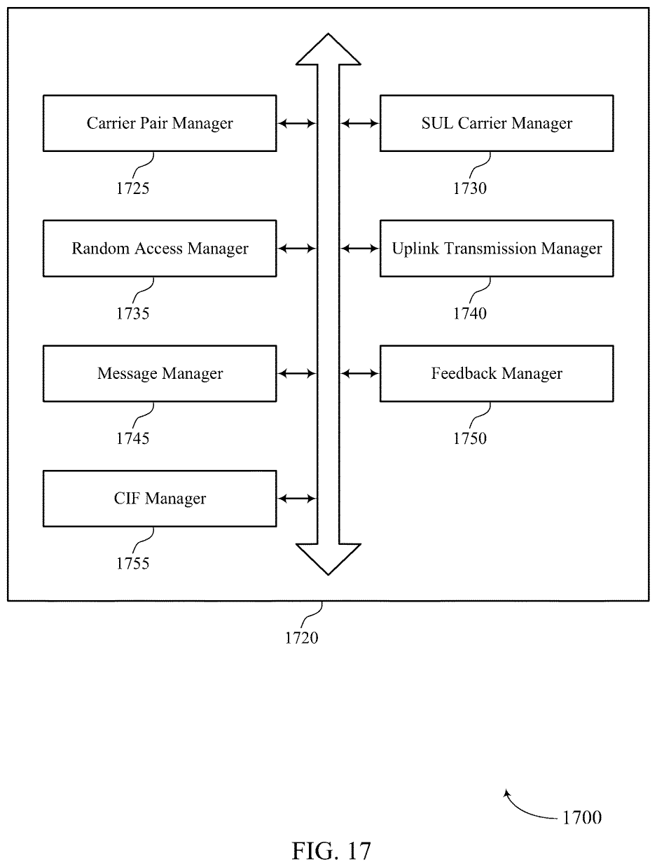

FIG. 17 shows a block diagram 1700 of a communications manager 1720 that supports a framework for SUL and uplink CA (e.g., an eSUL framework) in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of a framework for SUL and uplink CA as described herein. For example, the communications manager 1720 may include a carrier pair manager 1725, an SUL carrier manager 1730, a random access manager 1735, an uplink transmission manager 1740, a message manager 1745, a feedback manager 1750, a CIF manager 1755, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The carrier pair manager 1725 is capable of, configured to, or operable to support a means for transmitting first information indicative of first resources for use by a second network node to communicate via at least one of a first uplink carrier and a first downlink carrier that is paired with the first uplink carrier in a same frequency band. The SUL carrier manager 1730 is capable of, configured to, or operable to support a means for transmitting second information indicative of second resources for use by the second network node to communicate via one or more second uplink carriers associated with the first downlink carrier but different from the first uplink carrier, where the first uplink carrier and the one or more second uplink carriers are, collectively, a set of multiple candidate uplink carriers. The random access manager 1735 is capable of, configured to, or operable to support a means for participating in a random access procedure with the second network node using a first candidate uplink carrier of the set of multiple candidate uplink carriers. The uplink transmission manager 1740 is capable of, configured to, or operable to support a means for receiving, after the random access procedure and while the second network node is in a connected mode, an uplink transmission via a second candidate uplink carrier from the set of multiple candidate uplink carriers.

In some aspects, to support transmitting the second information, the message manager 1745 is capable of, configured to, or operable to support a means for transmitting a broadcast or dedicated message that includes the second information, where the second information is indicative of at least one of frequency information for each of the one or more second uplink carriers, uplink bandwidth part information for each of the one or more second uplink carriers, or timer information that pertains to a time alignment for each of the one or more second uplink carriers. In some aspects, the second information includes criteria for determination, by the second network node, of the first candidate uplink carrier.

In some aspects, the criteria includes a first received power threshold, and where the determination of either the first uplink carrier or one of the one or more second uplink carriers as the first candidate uplink carrier is based on a first comparison of a received power value and the first received power threshold.

In some aspects, the criteria includes one or more second received power thresholds and an association between each of the one or more second uplink carriers and a respective range of received power values, each respective range of received power values bounded by at least one of the one or more second received power thresholds.

In some aspects, the determination of the first candidate uplink carrier from among the one or more second uplink carriers is based on a second comparison of the received power value and the one or more second received power thresholds.

In some aspects, to support participating in the random access procedure, the random access manager 1735 is capable of, configured to, or operable to support a means for participating in the random access procedure using the first candidate uplink carrier and the first downlink carrier, where one of the one or more second uplink carriers is the first candidate uplink carrier.

In some aspects, to support participating in the random access procedure, the random access manager 1735 is capable of, configured to, or operable to support a means for receiving a random access message via the first candidate uplink carrier. In some aspects, to support participating in the random access procedure, the random access manager 1735 is capable of, configured to, or operable to support a means for transmitting a random access response message via the first downlink carrier, where the random access response message schedules transmission of an uplink shared channel message via the first candidate uplink carrier. In some aspects, to support participating in the random access procedure, the random access manager 1735 is capable of, configured to, or operable to support a means for receiving the uplink shared channel message via the first candidate uplink carrier based on the random access response message. In some aspects, to support participating in the random access procedure, the random access manager 1735 is capable of, configured to, or operable to support a means for transmitting a contention resolution downlink message via the first downlink carrier for a contention resolution procedure based on the uplink shared channel message.

In some aspects, to support participating in the random access procedure, the random access manager 1735 is capable of, configured to, or operable to support a means for receiving a random access message via the first candidate uplink carrier. In some aspects, to support participating in the random access procedure, the random access manager 1735 is capable of, configured to, or operable to support a means for transmitting a downlink message via the first downlink carrier based on the random access message.

In some aspects, at least the first uplink carrier is determined as the second candidate uplink carrier based on one of the one or more second uplink carriers being determined as the first candidate uplink carrier for the random access procedure.

In some aspects, the feedback manager 1750 is capable of, configured to, or operable to support a means for receiving, via the first uplink carrier, a feedback message in response to conclusion of the random access procedure. In some aspects, the uplink transmission manager 1740 is capable of, configured to, or operable to support a means for receiving the uplink transmission via at least the first uplink carrier.

In some aspects, the feedback manager 1750 is capable of, configured to, or operable to support a means for receiving, via the first candidate uplink carrier, a feedback message in response to conclusion of the random access procedure. In some aspects, the uplink transmission manager 1740 is capable of, configured to, or operable to support a means for receiving the uplink transmission via at least the first candidate uplink carrier.

In some aspects, the CIF manager 1755 is capable of, configured to, or operable to support a means for receiving the set of multiple uplink transmissions via at least the first uplink carrier, where a first value of a first carrier information field used to schedule a downlink shared channel message on the first downlink carrier is a same as a second value of a second carrier information field used to schedule one of the set of multiple uplink transmissions via the first uplink carrier, and where the first value is different from a third value of a third carrier information field used to schedule another of the set of multiple uplink transmissions via one of the one or more second uplink carriers.

In some aspects, at least one of the one or more second uplink carriers is determined as the second candidate uplink carrier based on the one of the one or more second uplink carriers being determined as the first candidate uplink carrier for the random access procedure.

In some aspects, the CIF manager 1755 is capable of, configured to, or operable to support a means for receiving the set of multiple uplink transmissions via at least the one of the one or more second uplink carriers, where a first value of a first carrier information field used to schedule a downlink shared channel message on the first downlink carrier is different from a second value of a second carrier information field used to schedule one of the set of multiple uplink transmissions via the one of the one or more second uplink carriers, and where the first value is different from a third value of a third carrier information field used to schedule another of the set of multiple uplink transmissions via another of the one or more second uplink carriers.

In some aspects, the feedback manager 1750 is capable of, configured to, or operable to support a means for receiving, via the one of the one or more second uplink carriers, a feedback message in response to conclusion of the random access procedure. In some aspects, the uplink transmission manager 1740 is capable of, configured to, or operable to support a means for receiving the uplink transmission via at least the one of the one or more second uplink carriers.

In some aspects, the uplink transmission includes one or more of an uplink control channel message, an uplink shared channel message, or a random access channel message. In some aspects, the second candidate uplink carrier is an uplink component carrier for CA while the second network node is in the connected mode.

In some aspects, the second candidate uplink carrier is associated with a corresponding set of feedback processes. In some aspects, a combination of one or more second candidate uplink carriers including the second candidate uplink carrier is based on a capability of the second network node.

In some aspects, the second candidate uplink carrier is scheduled based on a downlink message associated with a same cell. In some aspects, half-duplex operation or full-duplex operation between the first downlink carrier and the second candidate uplink carrier is based on a capability of the second network node.

In some aspects, the first uplink carrier and the one or more second uplink carriers are in different frequency bands. In some aspects, the first uplink carrier and the one or more second uplink carriers are in a same frequency band.

In some aspects, the first uplink carrier and the one or more second uplink carriers are for communication between the second network node and different cells. In some aspects, the first uplink carrier and the one or more second uplink carriers are for communication between the second network node and a same cell.

In some aspects, an idle mode and the connected mode are communication states of the first network node with respect to the second network node, where communications during the connected mode are over resources that are allocated for use by the second network node, and where communications during the idle mode are over resources that are allocated for common network node use.

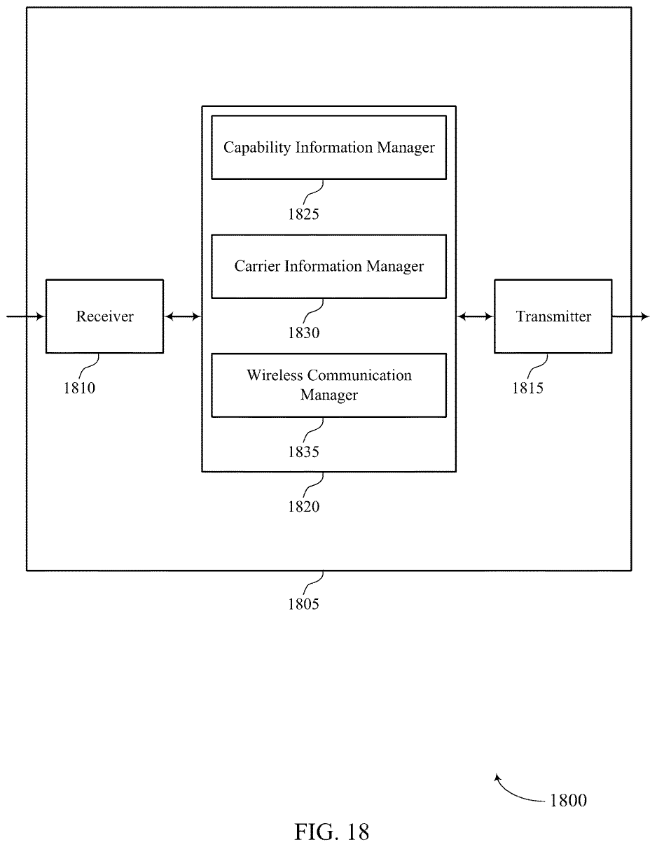

FIG. 18 shows a block diagram 1800 of a device 1805 that supports capability signaling for downlink and uplink carriers and cells in different frequency bands in accordance with one or more aspects of the present disclosure. The device 1805 may be an example of aspects of a device 905 or a network entity 105 as described herein. The device 1805 may include a receiver 1810, a transmitter 1815, and a communications manager 1820. The device 1805, or one of more components of the device 1805 (e.g., the receiver 1810, the transmitter 1815, and the communications manager 1820), may also include at least one communication interface, and at least one processor coupled to the communication interface, to support the described techniques. Each of these components may be in communication with one another (e.g., via one or more buses).

The receiver 1810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1805. In some aspects, the receiver 1810 may support obtaining information by receiving signals via one or more antennas. Additionally, or alternatively, the receiver 1810 may support obtaining information by receiving signals via one or more wired (e.g., electrical, fiber optic) interfaces, wireless interfaces, or any combination thereof.

The transmitter 1815 may provide a means for outputting (e.g., transmitting, providing, conveying, sending) information generated by other components of the device 1805. For example, the transmitter 1815 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1815 may support outputting information by transmitting signals via one or more antennas. Additionally, or alternatively, the transmitter 1815 may support outputting information by transmitting signals via one or more wired (e.g., electrical, fiber optic) interfaces, wireless interfaces, or any combination thereof. In some aspects, the transmitter 1815 and the receiver 1810 may be co-located in a transceiver, which may include or be coupled with a modem.

The device 1805, or various components thereof, may be an example of means for performing various aspects of capability signaling for downlink and uplink carriers and cells in different frequency bands as described herein. For example, the communications manager 1820 may include a capability information manager 1825, a carrier information manager 1830, a wireless communication manager 1835, or any combination thereof. The communications manager 1820 may be an example of aspects of a communications manager 1720 as described herein. In some aspects, the communications manager 1820, or various components thereof, may be configured to perform various operations (e.g., receiving, obtaining, monitoring, outputting, transmitting) using or otherwise in cooperation with the receiver 1810, the transmitter 1815, or both. For example, the communications manager 1820 may receive information from the receiver 1810, send information to the transmitter 1815, or be integrated in combination with the receiver 1810, the transmitter 1815, or both to obtain information, output information, or perform various other operations as described herein.

The capability information manager 1825 is capable of, configured to, or operable to support a means for receiving capability information, the capability information indicative of a capability of a second network node to communicate using a pair of carriers in different frequency bands, where the pair of carriers includes a first downlink carrier in a first frequency band and a first uplink carrier in a second frequency band that is different from the first frequency band. The carrier information manager 1830 is capable of, configured to, or operable to support a means for transmitting carrier information indicative of one or more downlink carriers and one or more uplink carriers for use by the second network node for wireless communication, where the one or more downlink carriers includes the first downlink carrier and the one or more uplink carriers includes the first uplink carrier, where the carrier information is based on the capability information. The wireless communication manager 1835 is capable of, configured to, or operable to support a means for participating in the wireless communication, in accordance with the carrier information, via the first downlink carrier and the first uplink carrier.

The capability information manager 1825 is capable of, configured to, or operable to support a means for receiving capability information, the capability information indicative of a capability of a second network node to communicate using a pair of carriers in a same frequency band, where the pair of carriers includes a first downlink carrier in a first frequency band and a first uplink carrier in the first frequency band. The carrier information manager 1830 is capable of, configured to, or operable to support a means for transmitting carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band. The wireless communication manager 1835 is capable of, configured to, or operable to support a means for participating in the wireless communication, in accordance with the carrier information, via the first downlink carrier and the second uplink carrier.

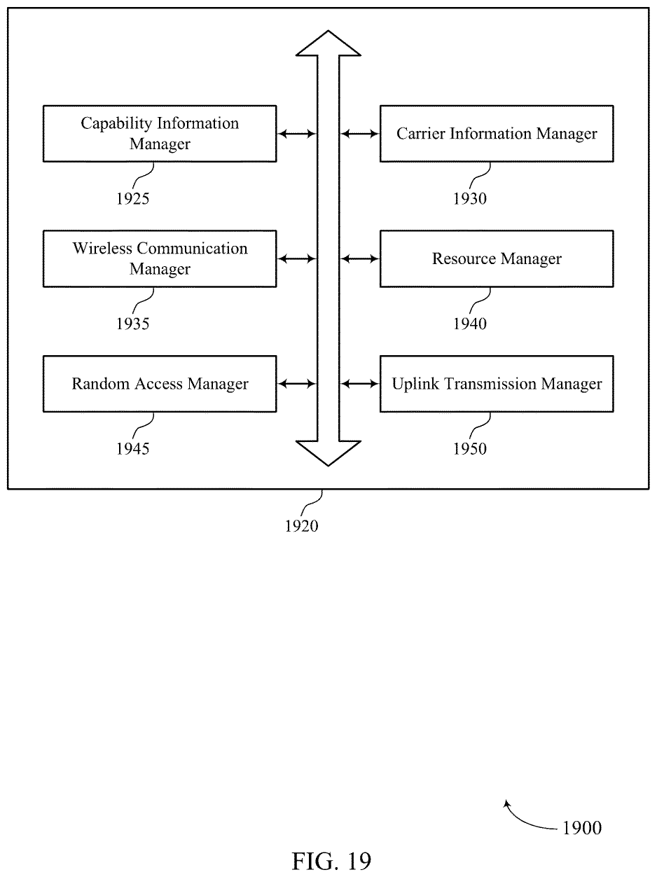

FIG. 19 shows a block diagram 1900 of a communications manager 1920 that supports capability signaling for downlink and uplink carriers and cells in different frequency bands in accordance with one or more aspects of the present disclosure. The communications manager 1920 may be an example of aspects of a communications manager 1720, a communications manager 1820, or both, as described herein. The communications manager 1920, or various components thereof, may be an example of means for performing various aspects of capability signaling for downlink and uplink carriers and cells in different frequency bands as described herein. For example, the communications manager 1920 may include a capability information manager 1925, a carrier information manager 1930, a wireless communication manager 1935, a resource manager 1940, a random access manager 1945, an uplink transmission manager 1950, or any combination thereof. Each of these components, or components of subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The capability information manager 1925 is capable of, configured to, or operable to support a means for receiving capability information, the capability information indicative of a capability of a second network node to communicate using a pair of carriers in different frequency bands, where the pair of carriers includes a first downlink carrier in a first frequency band and a first uplink carrier in a second frequency band that is different from the first frequency band. The carrier information manager 1930 is capable of, configured to, or operable to support a means for transmitting carrier information indicative of one or more downlink carriers and one or more uplink carriers for use by the second network node for wireless communication, where the one or more downlink carriers includes the first downlink carrier and the one or more uplink carriers includes the first uplink carrier, where the carrier information is based on the capability information. The wireless communication manager 1935 is capable of, configured to, or operable to support a means for participating in the wireless communication, in accordance with the carrier information, via the first downlink carrier and the first uplink carrier.

In some aspects, the capability information includes a first indication that the second network node supports communications in the first frequency band and a second indication that the second network node supports communications in the second frequency band. In some aspects, the capability of the second network node to communicate using the pair of carriers is indicated by the first indication and the second indication.

In some aspects, the capability information includes a first list of individual frequency bands in which the second network node supports both downlink communication and uplink communication via each of the individual frequency bands, and a second list of pairs of frequency bands in which the second network node supports, for each pair, downlink communication via a first pair component in a respective pair and uplink communication associated with the downlink communication, via a second pair component in the respective pair. In some aspects, the first frequency band and the second frequency band are one of the pairs of frequency bands included in the second list.

In some aspects, the capability information is indicative of one or more first sets of features supported by the second network node and one or more second sets of features supported by the second network node. In some aspects, individual sets of the one or more first sets of features are associated with respective downlink frequency bands in the second list of pairs of frequency bands. In some aspects, individual sets of the one or more second sets of features are associated with respective uplink frequency bands in the second list of pairs of frequency bands. In some aspects, the capability information indicates the one or more first sets of features and the one or more second sets of features separate from a third set of features supported by the second network node and each associated with a respective individual frequency band from the first list.

In some aspects, the capability information includes a list of individual frequency bands in which the second network node supports both downlink communication and uplink communication via each of the individual frequency bands. In some aspects, the list includes additional sets of uplink frequency bands, each set of uplink frequency bands associated with a respective one of the individual frequency bands in the list. In some aspects, the second frequency band is included in one of the additional sets of uplink frequency bands whose respective one of the individual frequency bands is the first frequency band.

In some aspects, the capability information is indicative of one or more first sets of features supported by the second network node and each associated with a respective individual frequency band from the list. In some aspects, the capability information is also indicative of one or more second sets of features supported by the second network node and each associated with at least one uplink frequency band of a respective set of the additional sets of uplink frequency bands.

In some aspects, the first frequency band is a TDD band and. In some aspects, the second frequency band is a FDD band or a SUL band.

In some aspects, the one or more downlink carriers includes a SDL carrier. In some aspects, the first frequency band is a SDL band that includes the SDL carrier.

In some aspects, to support transmitting the carrier information, the resource manager 1940 is capable of, configured to, or operable to support a means for transmitting first information indicative of first resources for use by the first network node to communicate via at least one of the first uplink carrier and the first downlink carrier that is paired with the first uplink carrier. In some aspects, to support transmitting the carrier information, the resource manager 1940 is capable of, configured to, or operable to support a means for transmitting second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers.

In some aspects, to support participating in the wireless communication, the random access manager 1945 is capable of, configured to, or operable to support a means for participating in a random access procedure with the second network node using a first candidate uplink carrier of a set of multiple candidate uplink carriers. In some aspects, to support participating in the wireless communication, the uplink transmission manager 1950 is capable of, configured to, or operable to support a means for receiving, after the random access procedure and while the second network node is in a connected mode, an uplink transmission via a second candidate uplink carrier from the set of multiple candidate uplink carriers.

In some aspects, an idle mode and the connected mode are communication states of the second network node with respect to the first network node. In some aspects, communications during the connected mode are over resources that are allocated for use by the second network node. In some aspects, communications during the idle mode are over resources that are allocated for common network node use.

In some aspects, the capability information manager 1925 is capable of, configured to, or operable to support a means for receiving capability information, the capability information indicative of a capability of a second network node to communicate using a pair of carriers in a same frequency band, where the pair of carriers includes a first downlink carrier in a first frequency band and a first uplink carrier in the first frequency band. In some aspects, the carrier information manager 1930 is capable of, configured to, or operable to support a means for transmitting carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band. In some aspects, the wireless communication manager 1935 is capable of, configured to, or operable to support a means for participating in the wireless communication, in accordance with the carrier information, via the first downlink carrier and the second uplink carrier.

In some aspects, the capability information includes a first indication that the first network node supports communications in the first frequency band and a second indication that the first network node supports communications in a second frequency band. In some aspects, the capability of the first network node to communicate using the pair of carriers is indicated by the first indication and the second indication.

In some aspects, the second uplink carrier is a SUL carrier when the second network node is in an idle mode and an uplink component carrier for CA while the second network node is in a connected mode.

In some aspects, to support receiving the carrier information, the resource manager 1940 is capable of, configured to, or operable to support a means for transmitting first information indicative of first resources for use by the second network node to communicate via at least one of the first uplink carrier and the first downlink carrier that is paired with the first uplink carrier. In some aspects, to support receiving the carrier information, the resource manager 1940 is capable of, configured to, or operable to support a means for transmitting second information indicative of second resources for use by the second network node to communicate via one or more second uplink carriers associated with the first downlink carrier but different from the first uplink carrier, where the first uplink carrier and the one or more second uplink carriers are, collectively, a set of multiple candidate uplink carriers.

In some aspects, to support participating in the wireless communication, the random access manager 1945 is capable of, configured to, or operable to support a means for participating in a random access procedure with the second network node using a first candidate uplink carrier of a set of multiple candidate uplink carriers. In some aspects, to support participating in the wireless communication, the uplink transmission manager 1950 is capable of, configured to, or operable to support a means for receiving, after the random access procedure and while the second network node is in a connected mode, an uplink transmission via a second candidate uplink carrier from the set of multiple candidate uplink carriers.

In some aspects, an idle mode and the connected mode are communication states of the second network node with respect to the first network node. In some aspects, communications during the connected mode are over resources that are allocated for use by the second network node. In some aspects, communications during the idle mode are over resources that are allocated for common network node use. In some aspects, the first frequency band is a TDD band.

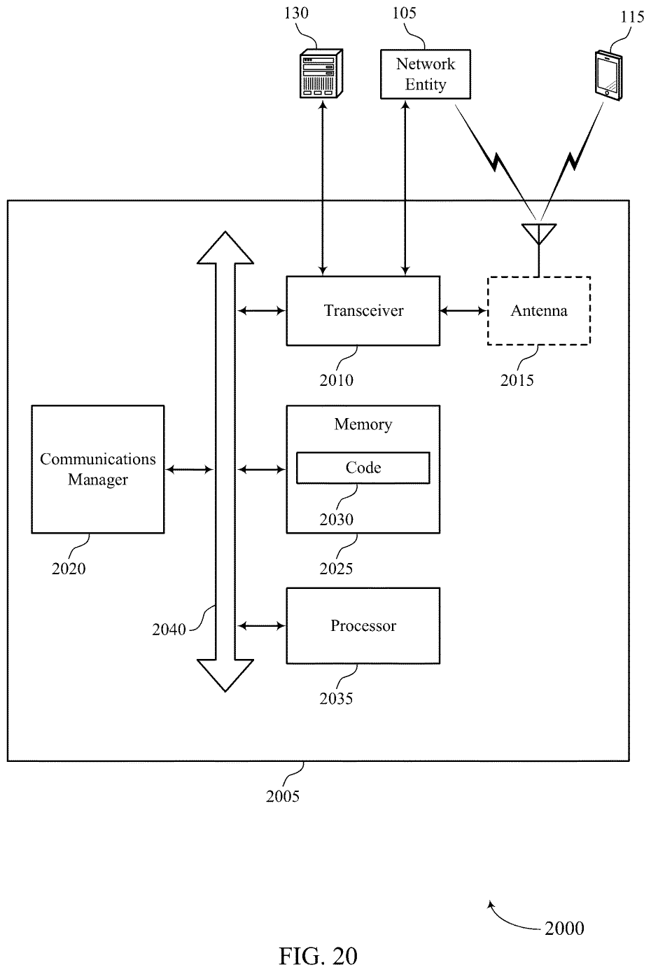

FIG. 20 shows a diagram of a system 2000 including a device 2005 that supports capability signaling for downlink and uplink carriers and cells in different frequency bands and also a framework for SUL and uplink CA (e.g., an eSUL framework) in accordance with one or more aspects of the present disclosure. The device 2005 may be an example of or include the components of a device 1505, a device 1605, or a network entity 105 as described herein. The device 2005 may communicate with one or more network entities 105, one or more UEs 115, or any combination thereof, which may include communications over one or more wired interfaces, over one or more wireless interfaces, or any combination thereof. The device 2005 may include components that support outputting and obtaining communications, such as a communications manager 2020, a transceiver 2010, an antenna 2015, a memory 2025, code 2030, and a processor 2035. These components may be in electronic communication or otherwise coupled (e.g., operatively, communicatively, functionally, electronically, electrically) via one or more buses (e.g., a bus 2040).

The transceiver 2010 may support bi-directional communications via wired links, wireless links, or both as described herein. In some aspects, the transceiver 2010 may include a wired transceiver and may communicate bi-directionally with another wired transceiver. Additionally, or alternatively, in some aspects, the transceiver 2010 may include a wireless transceiver and may communicate bi-directionally with another wireless transceiver. In some aspects, the device 2005 may include one or more antennas 2015, which may be capable of transmitting or receiving wireless transmissions (e.g., concurrently). The transceiver 2010 may also include a modem to modulate signals, to provide the modulated signals for transmission (e.g., by one or more antennas 2015, by a wired transmitter), to receive modulated signals (e.g., from one or more antennas 2015, from a wired receiver), and to demodulate signals. In some implementations, the transceiver 2010 may include one or more interfaces, such as one or more interfaces coupled with the one or more antennas 2015 that are configured to support various receiving or obtaining operations, or one or more interfaces coupled with the one or more antennas 2015 that are configured to support various transmitting or outputting operations, or a combination thereof. In some implementations, the transceiver 2010 may include or be configured for coupling with one or more processors or memory components that are operable to perform or support operations based on received or obtained information or signals, or to generate information or other signals for transmission or other outputting, or any combination thereof. In some implementations, the transceiver 2010, or the transceiver 2010 and the one or more antennas 2015, or the transceiver 2010 and the one or more antennas 2015 and one or more processors or memory components (for example, the processor 2035, or the memory 2025, or both), may be included in a chip or chip assembly that is installed in the device 2005. In some aspects, the transceiver may be operable to support communications via one or more communications links (e.g., a communication link 125, a backhaul communication link 120, a midhaul communication link 162, a fronthaul communication link 168).

The memory 2025 may include RAM and ROM. The memory 2025 may store computer-readable, computer-executable code 2030 including instructions that, when executed by the processor 2035, cause the device 2005 to perform various functions described herein. The code 2030 may be stored in a non-transitory computer-readable medium such as system memory or another type of memory. In some cases, the code 2030 may not be directly executable by the processor 2035 but may cause a computer (e.g., when compiled and executed) to perform functions described herein. In some cases, the memory 2025 may contain, among other things, a BIOS which may control basic hardware or software operation such as the interaction with peripheral components or devices.

The processor 2035 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 2035 may be configured to operate a memory array using a memory controller. In some other cases, a memory controller may be integrated into the processor 2035. The processor 2035 may be configured to execute computer-readable instructions stored in a memory (e.g., the memory 2025) to cause the device 2005 to perform various functions (e.g., functions or tasks supporting a framework for SUL and uplink CA and capability signaling for downlink and uplink carriers and cells in different frequency bands). For example, the device 2005 or a component of the device 2005 may include a processor 2035 and memory 2025 coupled with the processor 2035, the processor 2035 and memory 2025 configured to perform various functions described herein. The processor 2035 may be an example of a cloud-computing platform (e.g., one or more physical nodes and supporting software such as operating systems, virtual machines, or container instances) that may host the functions (e.g., by executing code 2030) to perform the functions of the device 2005. The processor 2035 may be any one or more suitable processors capable of executing scripts or instructions of one or more software programs stored in the device 2005 (such as within the memory 2025). In some implementations, the processor 2035 may be a component of a processing system. A processing system may generally refer to a system or series of machines or components that receives inputs and processes the inputs to produce a set of outputs (which may be passed to other systems or components of, for example, the device 2005). For example, a processing system of the device 2005 may refer to a system including the various other components or subcomponents of the device 2005, such as the processor 2035, or the transceiver 2010, or the communications manager 2020, or other components or combinations of components of the device 2005. The processing system of the device 2005 may interface with other components of the device 2005, and may process information received from other components (such as inputs or signals) or output information to other components. For example, a chip or modem of the device 2005 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 2005 may transmit information output from the chip or modem. Additionally, or alternatively, in some implementations, the one or more interfaces may refer to an interface between the processing system of the chip or modem and a receiver, such that the device 2005 may obtain information or signal inputs, and the information may be passed to the processing system. A person having ordinary skill in the art will readily recognize that a first interface also may obtain information or signal inputs, and a second interface also may output information or signal outputs.

In some aspects, a bus 2040 may support communications of (e.g., within) a protocol layer of a protocol stack. In some aspects, a bus 2040 may support communications associated with a logical channel of a protocol stack (e.g., between protocol layers of a protocol stack), which may include communications performed within a component of the device 2005, or between different components of the device 2005 that may be co-located or located in different locations (e.g., where the device 2005 may refer to a system in which one or more of the communications manager 2020, the transceiver 2010, the memory 2025, the code 2030, and the processor 2035 may be located in one of the different components or divided between different components).

In some aspects, the communications manager 2020 may manage aspects of communications with a core network 130 (e.g., via one or more wired or wireless backhaul links). For example, the communications manager 2020 may manage the transfer of data communications for client devices, such as one or more UEs 115. In some aspects, the communications manager 2020 may manage communications with other network entities 105, and may include a controller or scheduler for controlling communications with UEs 115 in cooperation with other network entities 105. In some aspects, the communications manager 2020 may support an X2 interface within an LTE/LTE-A wireless communications network technology to provide communication between network entities 105.

For example, the communications manager 2020 is capable of, configured to, or operable to support a means for transmitting first information indicative of first resources for use by a second network node to communicate via at least one of a first uplink carrier and a first downlink carrier that is paired with the first uplink carrier in a same frequency band. The communications manager 2020 is capable of, configured to, or operable to support a means for transmitting second information indicative of second resources for use by the second network node to communicate via one or more second uplink carriers associated with the first downlink carrier but different from the first uplink carrier, where the first uplink carrier and the one or more second uplink carriers are, collectively, a set of multiple candidate uplink carriers. The communications manager 2020 is capable of, configured to, or operable to support a means for participating in a random access procedure with the second network node using a first candidate uplink carrier of the set of multiple candidate uplink carriers. The communications manager 2020 is capable of, configured to, or operable to support a means for receiving, after the random access procedure and while the second network node is in a connected mode, an uplink transmission via a second candidate uplink carrier from the set of multiple candidate uplink carriers.

For example, the communications manager 1420 is capable of, configured to, or operable to support a means for receiving capability information, the capability information indicative of a capability of a second network node to communicate using a pair of carriers in different frequency bands, where the pair of carriers includes a first downlink carrier in a first frequency band and a first uplink carrier in a second frequency band that is different from the first frequency band. The communications manager 1420 is capable of, configured to, or operable to support a means for transmitting carrier information indicative of one or more downlink carriers and one or more uplink carriers for use by the second network node for wireless communication, where the one or more downlink carriers includes the first downlink carrier and the one or more uplink carriers includes the first uplink carrier, where the carrier information is based on the capability information. The communications manager 1420 is capable of, configured to, or operable to support a means for participating in the wireless communication, in accordance with the carrier information, via the first downlink carrier and the first uplink carrier.

For example, the communications manager 1420 is capable of, configured to, or operable to support a means for receiving capability information, the capability information indicative of a capability of a second network node to communicate using a pair of carriers in a same frequency band, where the pair of carriers includes a first downlink carrier in a first frequency band and a first uplink carrier in the first frequency band. The communications manager 1420 is capable of, configured to, or operable to support a means for transmitting carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band. The communications manager 1420 is capable of, configured to, or operable to support a means for participating in the wireless communication, in accordance with the carrier information, via the first downlink carrier and the second uplink carrier.

By including or configuring the communications manager 2020 in accordance with examples as described herein, the device 2005 may support techniques for a unified framework for SUL and uplink CA and capability signaling for uplink and downlink carriers in different frequency bands, which may reduce latency, increase spectral efficiency, improve resource utilization efficiency, increase signaling capacity, and improve communications between network nodes.

In some aspects, the communications manager 2020 may be configured to perform various operations (e.g., receiving, obtaining, monitoring, outputting, transmitting) using or otherwise in cooperation with the transceiver 2010, the one or more antennas 2015 (e.g., where applicable), or any combination thereof. Although the communications manager 2020 is illustrated as a separate component, in some aspects, one or more functions described with reference to the communications manager 2020 may be supported by or performed by the transceiver 2010, the processor 2035, the memory 2025, the code 2030, or any combination thereof. For example, the code 2030 may include instructions executable by the processor 2035 to cause the device 2005 to perform various aspects of a framework for SUL and uplink CA and capability signaling for downlink and uplink carriers and cells in different frequency bands as described herein, or the processor 2035 and the memory 2025 may be otherwise configured to perform or support such operations.

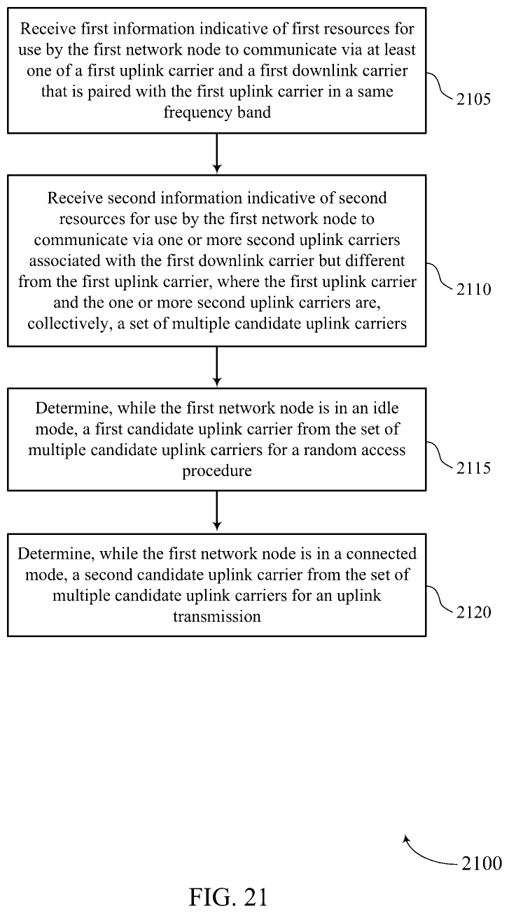

FIG. 21 shows a flowchart illustrating a method 2100 that supports a framework for SUL and uplink CA (e.g., an eSUL framework) in accordance with aspects of the present disclosure. The operations of the method 2100 may be implemented by a UE or its components as described herein. For example, the operations of the method 2100 may be performed by a UE 115 as described with reference to FIGS. 1 through 10. In some aspects, a UE may execute a set of instructions to control the functional elements of the wireless UE to perform the described functions. Additionally, or alternatively, the wireless UE may perform aspects of the described functions using special-purpose hardware.

At 2105, the method may include receiving first information indicative of first resources for use by the first network node to communicate via at least one of a first uplink carrier and a first downlink carrier that is paired with the first uplink carrier in a same frequency band. The operations of 2105 may be performed in accordance with examples as disclosed herein. In some aspects, aspects of the operations of 2105 may be performed by a carrier pair component 1025 as described with reference to FIG. 10.

At 2110, the method may include receiving second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers. The operations of 2110 may be performed in accordance with examples as disclosed herein. In some aspects, aspects of the operations of 2110 may be performed by an SUL carrier component 1030 as described with reference to FIG. 10.

At 2115, the method may include determining, while the first network node is in an idle mode, a first candidate uplink carrier from the set of multiple candidate uplink carriers for a random access procedure. The operations of 2115 may be performed in accordance with examples as disclosed herein. In some aspects, aspects of the operations of 2115 may be performed by a random access component 1035 as described with reference to FIG. 10.

At 2120, the method may include determining, while the first network node is in a connected mode, a second candidate uplink carrier from the set of multiple candidate uplink carriers for an uplink transmission. The operations of 2120 may be performed in accordance with examples as disclosed herein. In some aspects, aspects of the operations of 2120 may be performed by an uplink component 1040 as described with reference to FIG. 10.

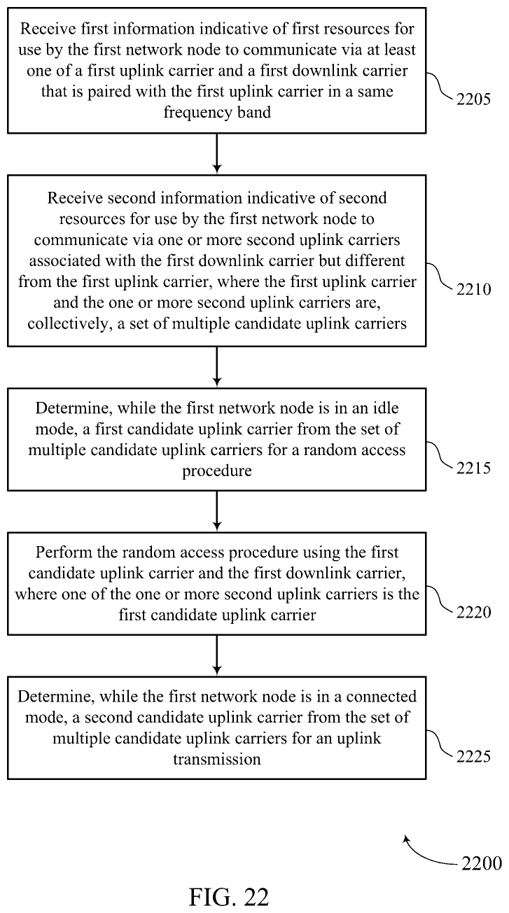

FIG. 22 shows a flowchart illustrating a method 2200 that supports a framework for SUL and uplink CA (e.g., an eSUL framework) in accordance with aspects of the present disclosure. The operations of the method 2200 may be implemented by a UE or its components as described herein. For example, the operations of the method 2200 may be performed by a UE 115 as described with reference to FIGs. FIG. 1 through 14. In some aspects, a UE may execute a set of instructions to control the functional elements of the wireless UE to perform the described functions. Additionally, or alternatively, the wireless UE may perform aspects of the described functions using special-purpose hardware.

At 2205, the method may include receiving first information indicative of first resources for use by the first network node to communicate via at least one of a first uplink carrier and a first downlink carrier that is paired with the first uplink carrier in a same frequency band. The operations of 2205 may be performed in accordance with examples as disclosed herein. In some aspects, aspects of the operations of 2205 may be performed by a carrier pair component 1125 as described with reference to FIG. 11.

At 2210, the method may include receiving second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers. The operations of 2210 may be performed in accordance with examples as disclosed herein. In some aspects, aspects of the operations of 2210 may be performed by an SUL carrier component 1130 as described with reference to FIG. 11.

At 2215, the method may include determining, while the first network node is in an idle mode, a first candidate uplink carrier from the set of multiple candidate uplink carriers for a random access procedure. The operations of 2215 may be performed in accordance with examples as disclosed herein. In some aspects, aspects of the operations of 2215 may be performed by a random access component 1135 as described with reference to FIG. 11.

At 2220, the method may include performing the random access procedure using the first candidate uplink carrier and the first downlink carrier, where one of the one or more second uplink carriers is the first candidate uplink carrier. The operations of 2220 may be performed in accordance with examples as disclosed herein. In some aspects, aspects of the operations of 2220 may be performed by a random access component 1135 as described with reference to FIG. 11.

At 2225, the method may include determining, while the first network node is in a connected mode, a second candidate uplink carrier from the set of multiple candidate uplink carriers for an uplink transmission. The operations of 2225 may be performed in accordance with examples as disclosed herein. In some aspects, aspects of the operations of 2225 may be performed by an uplink component 1140 as described with reference to FIG. 11.

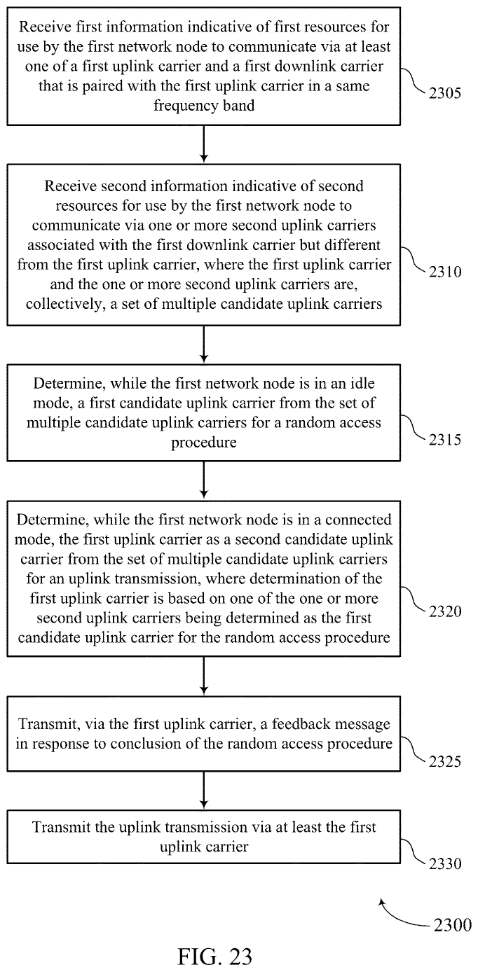

FIG. 23 shows a flowchart illustrating a method 2300 that supports a framework for SUL and uplink CA (e.g., an eSUL framework) in accordance with aspects of the present disclosure. The operations of the method 2300 may be implemented by a UE or its components as described herein. For example, the operations of the method 2300 may be performed by a UE 115 as described with reference to FIGs. FIG. 1 through 14. In some aspects, a UE may execute a set of instructions to control the functional elements of the wireless UE to perform the described functions. Additionally, or alternatively, the wireless UE may perform aspects of the described functions using special-purpose hardware.

At 2305, the method may include receiving first information indicative of first resources for use by the first network node to communicate via at least one of a first uplink carrier and a first downlink carrier that is paired with the first uplink carrier in a same frequency band. The operations of 2305 may be performed in accordance with examples as disclosed herein. In some aspects, aspects of the operations of 2305 may be performed by a carrier pair component 1125 as described with reference to FIG. 11.

At 2310, the method may include receiving second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers. The operations of 2310 may be performed in accordance with examples as disclosed herein. In some aspects, aspects of the operations of 2310 may be performed by an SUL carrier component 1130 as described with reference to FIG. 11.

At 2315, the method may include determining, while the first network node is in an idle mode, a first candidate uplink carrier from the set of multiple candidate uplink carriers for a random access procedure. The operations of 2315 may be performed in accordance with examples as disclosed herein. In some aspects, aspects of the operations of 2315 may be performed by a random access component 1135 as described with reference to FIG. 11.

At 2320, the method may include determining, while the first network node is in a connected mode, the first uplink carrier as a second candidate uplink carrier from the set of multiple candidate uplink carriers for an uplink transmission, where determination of the first uplink carrier is based on one of the one or more second uplink carriers being determined as the first candidate uplink carrier for the random access procedure. The operations of 2320 may be performed in accordance with examples as disclosed herein. In some aspects, aspects of the operations of 2320 may be performed by an uplink component 1140 as described with reference to FIG. 11.

At 2325, the method may include transmitting, via the first uplink carrier, a feedback message in response to conclusion of the random access procedure. The operations of 2325 may be performed in accordance with examples as disclosed herein. In some aspects, aspects of the operations of 2325 may be performed by a feedback component 1155 as described with reference to FIG. 11.

At 2330, the method may include transmitting the uplink transmission via at least the first uplink carrier. The operations of 2330 may be performed in accordance with examples as disclosed herein. In some aspects, aspects of the operations of 2330 may be performed by an uplink component 1140 as described with reference to FIG. 11.

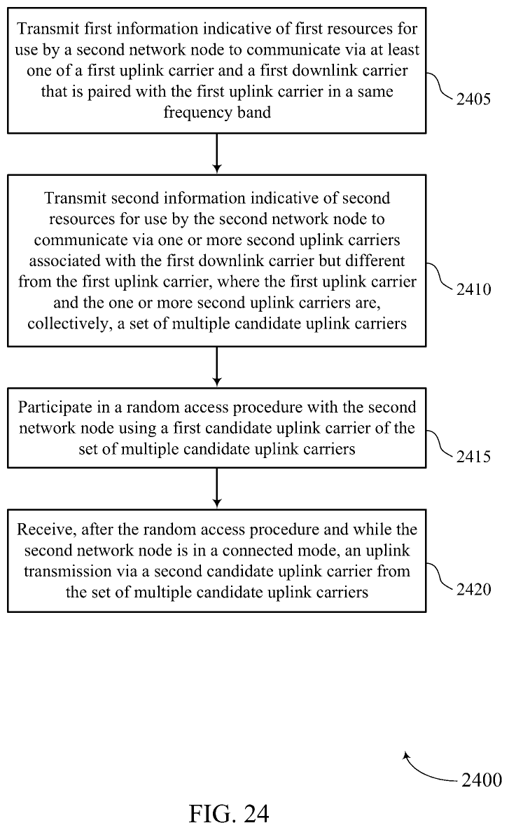

FIG. 24 shows a flowchart illustrating a method 2400 that supports a framework for SUL and uplink CA (e.g., an eSUL framework) in accordance with aspects of the present disclosure. The operations of the method 2400 may be implemented by a network entity or its components as described herein. For example, the operations of the method 2400 may be performed by a network entity as described with reference to FIGs. FIG. 1 through 7 and 15 through 20. In some aspects, a network entity may execute a set of instructions to control the functional elements of the wireless network entity to perform the described functions. Additionally, or alternatively, the wireless network entity may perform aspects of the described functions using special-purpose hardware.

At 2405, the method may include transmitting first information indicative of first resources for use by a second network node to communicate via at least one of a first uplink carrier and a first downlink carrier that is paired with the first uplink carrier in a same frequency band. The operations of 2405 may be performed in accordance with examples as disclosed herein. In some aspects, aspects of the operations of 2405 may be performed by a carrier pair manager 1725 as described with reference to FIG. 17.

At 2410, the method may include transmitting second information indicative of second resources for use by the second network node to communicate via one or more second uplink carriers associated with the first downlink carrier but different from the first uplink carrier, where the first uplink carrier and the one or more second uplink carriers are, collectively, a set of multiple candidate uplink carriers. The operations of 2410 may be performed in accordance with examples as disclosed herein. In some aspects, aspects of the operations of 2410 may be performed by an SUL carrier manager 1730 as described with reference to FIG. 17.

At 2415, the method may include participating in a random access procedure with the second network node using a first candidate uplink carrier of the set of multiple candidate uplink carriers. The operations of 2415 may be performed in accordance with examples as disclosed herein. In some aspects, aspects of the operations of 2415 may be performed by a random access manager 1735 as described with reference to FIG. 17.

At 2420, the method may include receiving, after the random access procedure and while the second network node is in a connected mode, an uplink transmission via a second candidate uplink carrier from the set of multiple candidate uplink carriers. The operations of 2420 may be performed in accordance with examples as disclosed herein. In some aspects, aspects of the operations of 2420 may be performed by an uplink transmission manager 1740 as described with reference to FIG. 17.

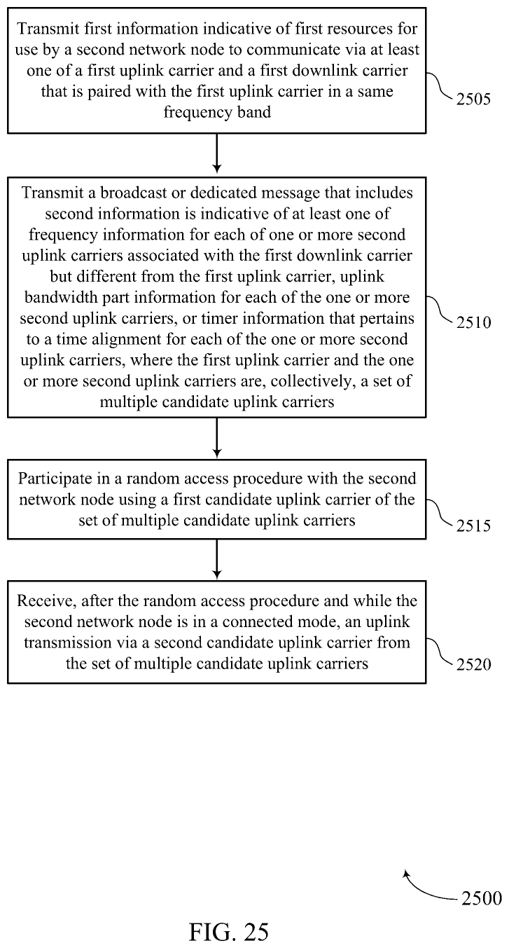

FIG. 25 shows a flowchart illustrating a method 2500 that supports a framework for SUL and uplink CA (e.g., an eSUL framework) in accordance with aspects of the present disclosure. The operations of the method 2500 may be implemented by a network entity or its components as described herein. For example, the operations of the method 2500 may be performed by a network entity as described with reference to FIGs. FIGS. 1 through 7 and 15 through 20. In some aspects, a network entity may execute a set of instructions to control the functional elements of the wireless network entity to perform the described functions. Additionally, or alternatively, the wireless network entity may perform aspects of the described functions using special-purpose hardware.

At 2505, the method may include transmitting first information indicative of first resources for use by a second network node to communicate via at least one of a first uplink carrier and a first downlink carrier that is paired with the first uplink carrier in a same frequency band. The operations of 2505 may be performed in accordance with examples as disclosed herein. In some aspects, aspects of the operations of 2505 may be performed by a carrier pair manager 1725 as described with reference to FIG. 17.

At 2510, the method may include transmitting a broadcast or dedicated message that includes second information indicative of at least one of frequency information for each of one or more second uplink carriers associated with the first downlink carrier but different from the first uplink carrier, uplink bandwidth part information for each of the one or more second uplink carriers, or timer information that pertains to a time alignment for each of the one or more second uplink carriers, where the first uplink carrier and the one or more second uplink carriers are, collectively, a set of multiple candidate uplink carriers. The operations of 2510 may be performed in accordance with examples as disclosed herein. In some aspects, aspects of the operations of 2510 may be performed by a message manager 1745 as described with reference to FIG. 17.

At 2515, the method may include participating in a random access procedure with the second network node using a first candidate uplink carrier of the set of multiple candidate uplink carriers. The operations of 2515 may be performed in accordance with examples as disclosed herein. In some aspects, aspects of the operations of 2515 may be performed by a random access manager 1735 as described with reference to FIG. 17.

At 2520, the method may include receiving, after the random access procedure and while the second network node is in a connected mode, an uplink transmission via a second candidate uplink carrier from the set of multiple candidate uplink carriers. The operations of 2520 may be performed in accordance with examples as disclosed herein. In some aspects, aspects of the operations of 2520 may be performed by an uplink transmission manager 1740 as described with reference to FIG. 17.

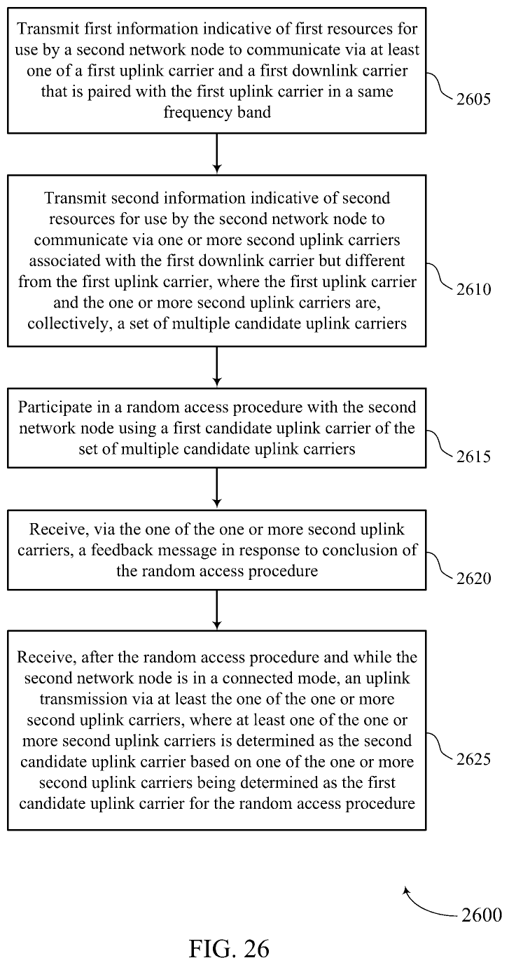

FIG. 26 shows a flowchart illustrating a method 2600 that supports capability signaling for downlink and uplink carriers and cells in different frequency bands and also a framework for SUL and uplink CA (e.g., an eSUL framework) in accordance with aspects of the present disclosure. The operations of the method 2600 may be implemented by a network entity or its components as described herein. For example, the operations of the method 2600 may be performed by a network entity as described with reference to FIGs. FIG. 1 through 7 and 15 through 20. In some aspects, a network entity may execute a set of instructions to control the functional elements of the wireless network entity to perform the described functions. Additionally, or alternatively, the wireless network entity may perform aspects of the described functions using special-purpose hardware.

At 2605, the method may include transmitting first information indicative of first resources for use by a second network node to communicate via at least one of a first uplink carrier and a first downlink carrier that is paired with the first uplink carrier in a same frequency band. The operations of 2605 may be performed in accordance with examples as disclosed herein. In some aspects, aspects of the operations of 2605 may be performed by a carrier pair manager 1725 as described with reference to FIG. 17.

At 2610, the method may include transmitting second information indicative of second resources for use by the second network node to communicate via one or more second uplink carriers associated with the first downlink carrier but different from the first uplink carrier, where the first uplink carrier and the one or more second uplink carriers are, collectively, a set of multiple candidate uplink carriers. The operations of 2610 may be performed in accordance with examples as disclosed herein. In some aspects, aspects of the operations of 2610 may be performed by an SUL carrier manager 1730 as described with reference to FIG. 17.

At 2615, the method may include participating in a random access procedure with the second network node using a first candidate uplink carrier of the set of multiple candidate uplink carriers. The operations of 2615 may be performed in accordance with examples as disclosed herein. In some aspects, aspects of the operations of 2615 may be performed by a random access manager 1735 as described with reference to FIG. 17.

At 2620, the method may include receiving, via the one of the one or more second uplink carriers, a feedback message in response to conclusion of the random access procedure. The operations of 2620 may be performed in accordance with examples as disclosed herein. In some aspects, aspects of the operations of 2620 may be performed by a feedback manager 1750 as described with reference to FIG. 17.

At 2625, the method may include receiving, after the random access procedure and while the second network node is in a connected mode, an uplink transmission via at least one of the one or more second uplink carriers, where at least one of the one or more second uplink carriers is determined as the second candidate uplink carrier based on the one of the one or more second uplink carriers being determined as the first candidate uplink carrier for the random access procedure. The operations of 2625 may be performed in accordance with examples as disclosed herein. In some aspects, aspects of the operations of 2625 may be performed by an uplink transmission manager 1740 as described with reference to FIG. 17.

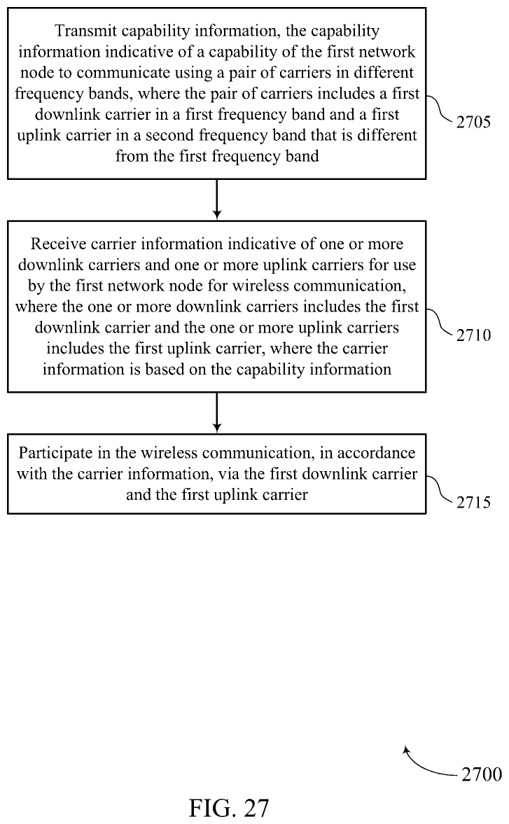

FIG. 27 shows a flowchart illustrating a method 2700 that supports capability signaling for downlink and uplink carriers and cells in different frequency bands in accordance with aspects of the present disclosure. The operations of the method 2700 may be implemented by a UE or its components as described herein. For example, the operations of the method 2700 may be performed by a UE 115 as described with reference to FIGS. 9 through 20. In some aspects, a UE may execute a set of instructions to control the functional elements of the UE to perform the described functions. Additionally, or alternatively, the UE may perform aspects of the described functions using special-purpose hardware.

At 2705, the method may include transmitting capability information, the capability information indicative of a capability of the first network node to communicate using a pair of carriers in different frequency bands, where the pair of carriers includes a first downlink carrier in a first frequency band and a first uplink carrier in a second frequency band that is different from the first frequency band. The operations of 2705 may be performed in accordance with examples as disclosed herein. In some aspects, aspects of the operations of 2705 may be performed by a capability information component 1325 as described with reference to FIG. 13.

At 2710, the method may include receiving carrier information indicative of one or more downlink carriers and one or more uplink carriers for use by the first network node for wireless communication, where the one or more downlink carriers includes the first downlink carrier and the one or more uplink carriers includes the first uplink carrier, where the carrier information is based on the capability information. The operations of 2710 may be performed in accordance with examples as disclosed herein. In some aspects, aspects of the operations of 2710 may be performed by a carrier information component 1330 as described with reference to FIG. 13.

At 2715, the method may include participating in the wireless communication, in accordance with the carrier information, via the first downlink carrier and the first uplink carrier. The operations of 2715 may be performed in accordance with examples as disclosed herein. In some aspects, aspects of the operations of 2715 may be performed by a wireless communication component 1335 as described with reference to FIG. 13.

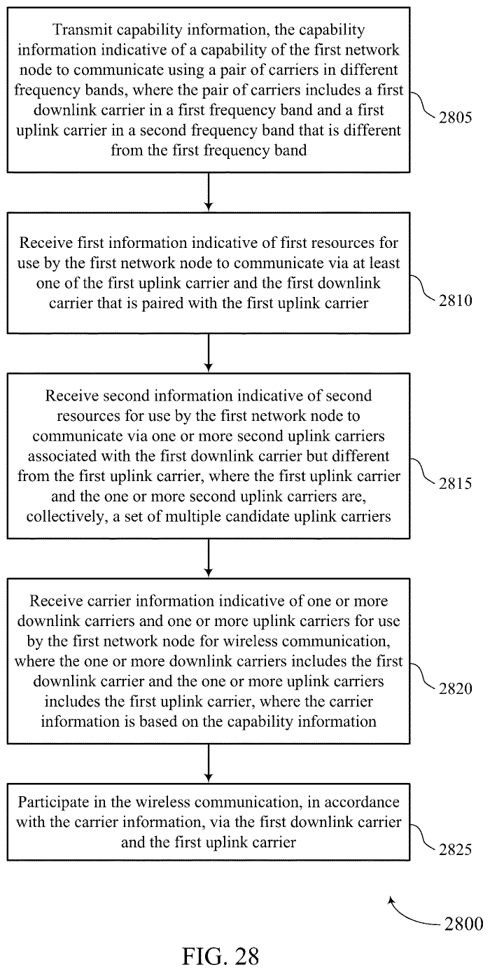

FIG. 28 shows a flowchart illustrating a method 2800 that supports capability signaling for downlink and uplink carriers and cells in different frequency bands in accordance with aspects of the present disclosure. The operations of the method 2800 may be implemented by a UE or its components as described herein. For example, the operations of the method 2800 may be performed by a UE 115 as described with reference to FIGS. 9 through 20. In some aspects, a UE may execute a set of instructions to control the functional elements of the UE to perform the described functions. Additionally, or alternatively, the UE may perform aspects of the described functions using special-purpose hardware.

At 2805, the method may include transmitting capability information, the capability information indicative of a capability of the first network node to communicate using a pair of carriers in different frequency bands, where the pair of carriers includes a first downlink carrier in a first frequency band and a first uplink carrier in a second frequency band that is different from the first frequency band. The operations of 2805 may be performed in accordance with examples as disclosed herein. In some aspects, aspects of the operations of 2805 may be performed by a capability information component 1325 as described with reference to FIG. 13.

At 2810, the method may include receiving first information indicative of first resources for use by the first network node to communicate via at least one of the first uplink carrier and the first downlink carrier that is paired with the first uplink carrier. The operations of 2810 may be performed in accordance with examples as disclosed herein. In some aspects, aspects of the operations of 2810 may be performed by a resource component 1345 as described with reference to FIG. 13.

At 2815, the method may include receiving second information indicative of second resources for use by the first network node to communicate via one or more second uplink carriers associated with the first downlink carrier but different from the first uplink carrier, where the first uplink carrier and the one or more second uplink carriers are, collectively, a set of multiple candidate uplink carriers. The operations of 2815 may be performed in accordance with examples as disclosed herein. In some aspects, aspects of the operations of 2815 may be performed by a resource component 1345 as described with reference to FIG. 13.

At 2820, the method may include receiving carrier information indicative of one or more downlink carriers and one or more uplink carriers for use by the first network node for wireless communication, where the one or more downlink carriers includes the first downlink carrier and the one or more uplink carriers includes the first uplink carrier, where the carrier information is based on the capability information. The operations of 2820 may be performed in accordance with examples as disclosed herein. In some aspects, aspects of the operations of 2820 may be performed by a carrier information component 1330 as described with reference to FIG. 13.

At 2825, the method may include participating in the wireless communication, in accordance with the carrier information, via the first downlink carrier and the first uplink carrier. The operations of 2825 may be performed in accordance with examples as disclosed herein. In some aspects, aspects of the operations of 2825 may be performed by a wireless communication component 1335 as described with reference to FIG. 13.

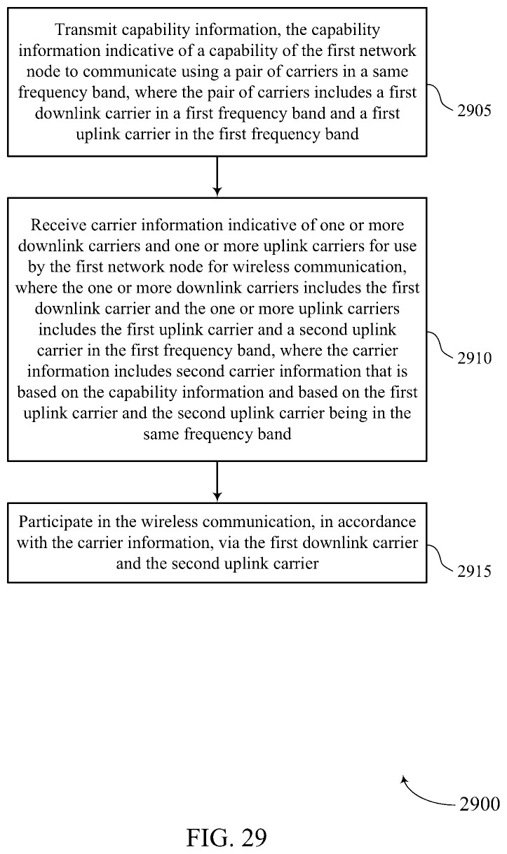

FIG. 29 shows a flowchart illustrating a method 2900 that supports capability signaling for downlink and uplink carriers and cells in different frequency bands in accordance with aspects of the present disclosure. The operations of the method 2900 may be implemented by a UE or its components as described herein. For example, the operations of the method 2900 may be performed by a UE 115 as described with reference to FIGS. 9 through 30. In some aspects, a UE may execute a set of instructions to control the functional elements of the UE to perform the described functions. Additionally, or alternatively, the UE may perform aspects of the described functions using special-purpose hardware.

At 2905, the method may include transmitting capability information, the capability information indicative of a capability of the first network node to communicate using a pair of carriers in a same frequency band, where the pair of carriers includes a first downlink carrier in a first frequency band and a first uplink carrier in the first frequency band. The operations of 2905 may be performed in accordance with examples as disclosed herein. In some aspects, aspects of the operations of 2905 may be performed by a capability information component 1325 as described with reference to FIG. 13.

At 2910, the method may include receiving carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band. The operations of 2910 may be performed in accordance with examples as disclosed herein. In some aspects, aspects of the operations of 2910 may be performed by a 31carrier determination component 1240 as described with reference to FIG. 13.

At 2915, the method may include participating in the wireless communication, in accordance with the carrier information, via the first downlink carrier and the second uplink carrier. The operations of 2915 may be performed in accordance with examples as disclosed herein. In some aspects, aspects of the operations of 2915 may be performed by a wireless communication component 1335 as described with reference to FIG. 13.

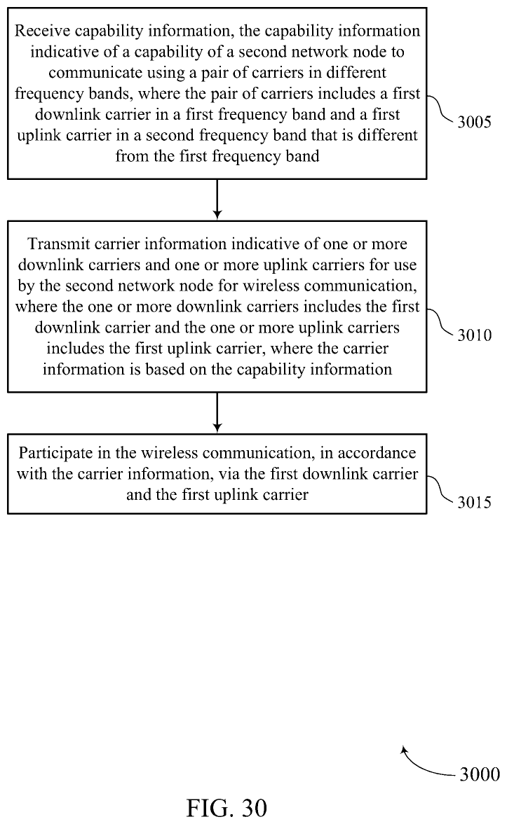

FIG. 30 shows a flowchart illustrating a method 3000 that supports capability signaling for downlink and uplink carriers and cells in different frequency bands in accordance with aspects of the present disclosure. The operations of the method 3000 may be implemented by a network entity or its components as described herein. For example, the operations of the method 3000 may be performed by a network entity as described with reference to FIGS. 9 through 14. In some aspects, a network entity may execute a set of instructions to control the functional elements of the network entity to perform the described functions. Additionally, or alternatively, the network entity may perform aspects of the described functions using special-purpose hardware.

At 3005, the method may include receiving capability information, the capability information indicative of a capability of a second network node to communicate using a pair of carriers in different frequency bands, where the pair of carriers includes a first downlink carrier in a first frequency band and a first uplink carrier in a second frequency band that is different from the first frequency band. The operations of 3005 may be performed in accordance with examples as disclosed herein. In some aspects, aspects of the operations of 3005 may be performed by a capability information manager 1925 as described with reference to FIG. 19.

At 3010, the method may include transmitting carrier information indicative of one or more downlink carriers and one or more uplink carriers for use by the second network node for wireless communication, where the one or more downlink carriers includes the first downlink carrier and the one or more uplink carriers includes the first uplink carrier, where the carrier information is based on the capability information. The operations of 3010 may be performed in accordance with examples as disclosed herein. In some aspects, aspects of the operations of 3010 may be performed by a carrier information manager 1930 as described with reference to FIG. 19.

At 3015, the method may include participating in the wireless communication, in accordance with the carrier information, via the first downlink carrier and the first uplink carrier. The operations of 3015 may be performed in accordance with examples as disclosed herein. In some aspects, aspects of the operations of 3015 may be performed by a wireless communication manager 1935 as described with reference to FIG. 19.

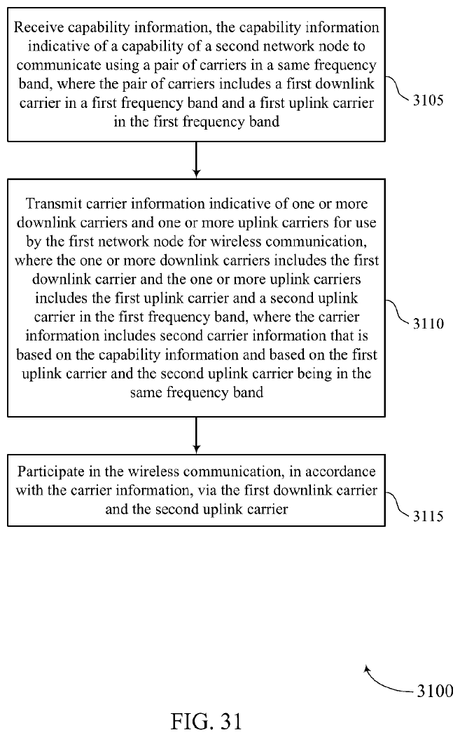

FIG. 31 shows a flowchart illustrating a method 3100 that supports capability signaling for downlink and uplink carriers and cells in different frequency bands in accordance with aspects of the present disclosure. The operations of the method 3100 may be implemented by a network entity or its components as described herein. For example, the operations of the method 3100 may be performed by a network entity as described with reference to FIGS. 9 through 20. In some aspects, a network entity may execute a set of instructions to control the functional elements of the network entity to perform the described functions. Additionally, or alternatively, the network entity may perform aspects of the described functions using special-purpose hardware.

At 3105, the method may include receiving capability information, the capability information indicative of a capability of a second network node to communicate using a pair of carriers in a same frequency band, where the pair of carriers includes a first downlink carrier in a first frequency band and a first uplink carrier in the first frequency band. The operations of 3105 may be performed in accordance with examples as disclosed herein. In some aspects, aspects of the operations of 3105 may be performed by a capability information manager 1925 as described with reference to FIG. 19.

At 3110, the method may include transmitting carrier information indicative of one or more downlink carriers and one or more uplink carriers for use by the first network node for wireless communication, where the one or more downlink carriers includes the first downlink carrier and the one or more uplink carriers includes the first uplink carrier and a second uplink carrier in the first frequency band, where the carrier information includes second carrier information that is based on the capability information and based on the first uplink carrier and the second uplink carrier being in the same frequency band. The operations of 3110 may be performed in accordance with examples as disclosed herein. In some aspects, aspects of the operations of 3110 may be performed by a carrier information manager 1930 as described with reference to FIG. 19.

At 3115, the method may include participating in the wireless communication, in accordance with the carrier information, via the first downlink carrier and the second uplink carrier. The operations of 3115 may be performed in accordance with examples as disclosed herein. In some aspects, aspects of the operations of 3115 may be performed by a wireless communication manager 1935 as described with reference to FIG. 19.

The following provides an overview of aspects of the present disclosure:
Aspect 1: A method of wireless communication performed by a first network node, comprising: transmitting capability information, the capability information indicative of a capability of the first network node to communicate using a pair of carriers in different frequency bands, wherein the pair of carriers includes a first downlink carrier in a first frequency band and a first uplink carrier in a second frequency band that is different from the first frequency band; receiving carrier information indicative of one or more downlink carriers and one or more uplink carriers for use by the first network node for wireless communication, wherein the one or more downlink carriers includes the first downlink carrier and the one or more uplink carriers includes the first uplink carrier, wherein the carrier information is based on the capability information; and participating in the wireless communication, in accordance with the carrier information, via the first downlink carrier and the first uplink carrier.
Aspect 2: The method of aspect 1, wherein the capability information includes a first indication that the first network node supports communications in the first frequency band and a second indication that the first network node supports communications in the second frequency band, the capability of the first network node to communicate using the pair of carriers is indicated by the first indication and the second indication.
Aspect 3: The method of any of aspects 1 through 2, wherein the capability information includes a first list of individual frequency bands in which the first network node supports both downlink communication and uplink communication via each of the individual frequency bands, and a second list of pairs of frequency bands in which the first network node supports, for each pair, downlink communication via a first pair component in a respective pair and uplink communication associated with the downlink communication, via a second pair component in the respective pair, the first frequency band and the second frequency band are one of the pairs of frequency bands included in the second list.
Aspect 4: The method of aspect 3, wherein the capability information is indicative of one or more first sets of features supported by the first network node and one or more second sets of features supported by the first network node, individual sets of the one or more first sets of features are associated with respective downlink frequency bands in the second list of pairs of frequency bands, and individual sets of the one or more second sets of features are associated with respective uplink frequency bands in the second list of pairs of frequency bands, the capability information indicates the one or more first sets of features and the one or more second sets of features separate from a third set of features supported by the first network node and each associated with a respective individual frequency band from the first list.
Aspect 5: The method of any of aspects 1 through 4, wherein the capability information includes a list of individual frequency bands in which the first network node supports both downlink communication and uplink communication via each of the individual frequency bands, and the list includes additional sets of uplink frequency bands, each set of uplink frequency bands associated with a respective one of the individual frequency bands in the list, the second frequency band is included in one of the additional sets of uplink frequency bands whose respective one of the individual frequency bands is the first frequency band.
Aspect 6: The method of aspect 5, wherein the capability information is indicative of one or more first sets of features supported by the first network node and each associated with a respective individual frequency band from the list, and the capability information is also indicative of one or more second sets of features supported by the first network node and each associated with at least one uplink frequency band of a respective set of the additional sets of uplink frequency bands.
Aspect 7: The method of any of aspects 1 through 6, wherein the first frequency band is a TDD band and the second frequency band is a FDD band or a SUL band.
Aspect 8: The method of any of aspects 1 through 7, wherein the one or more downlink carriers comprises a SDL carrier, and the first frequency band is a SDL band that includes the SDL carrier.
Aspect 9: The method of any of aspects 1 through 8, wherein receiving the carrier information comprises: receiving first information indicative of first resources for use by the first network node to communicate via at least one of the first uplink carrier and the first downlink carrier that is paired with the first uplink carrier; and receiving second information indicative of second resources for use by the first network node to communicate via one or more second uplink carriers associated with the first downlink carrier but different from the first uplink carrier, wherein the first uplink carrier and the one or more second uplink carriers are, collectively, a plurality of candidate uplink carriers.

Aspect 10: The method of any of aspects 1 through 9, wherein participating in the wireless communication comprises: determine, while the first network node is in an idle mode, a first candidate uplink carrier from a plurality of candidate uplink carriers for a random access procedure; and determine, while the first network node is in a connected mode, a second candidate uplink carrier from the plurality of candidate uplink carriers for an uplink transmission.
Aspect 11: The method of aspect 10, wherein the idle mode and the connected mode are communication states of the first network node with respect to a second network node, communications during the connected mode are over resources that are allocated for use by the first network node, and communications during the idle mode are over resources that are allocated for common network node use.
Aspect 12: A method of wireless communication performed by a first network node, comprising: transmitting capability information, the capability information indicative of a capability of the first network node to communicate using a pair of carriers in a same frequency band, wherein the pair of carriers includes a first downlink carrier in a first frequency band and a first uplink carrier in the first frequency band; receiving carrier information indicative of one or more downlink carriers and one or more uplink carriers for use by the first network node for wireless communication, wherein the one or more downlink carriers includes the first downlink carrier and the one or more uplink carriers includes the first uplink carrier and a second uplink carrier in the first frequency band, wherein the carrier information includes second carrier information that is based on the capability information and based on the first uplink carrier and the second uplink carrier being in the same frequency band; and participating in the wireless communication, in accordance with the carrier information, via the first downlink carrier and the second uplink carrier.
Aspect 13: The method of aspect 12, wherein the capability information includes a first indication that the first network node supports communications in the first frequency band and a second indication that the first network node supports communications in a second frequency band, the capability of the first network node to communicate using the pair of carriers is indicated by the first indication and the second indication.
Aspect 14: The method of any of aspects 12 through 13, wherein the second uplink carrier is a SUL carrier when the first network node is in an idle mode and an uplink component carrier for CA while the first network node is in a connected mode.
Aspect 15: The method of any of aspects 12 through 14, wherein receiving the carrier information comprises: receiving first information indicative of first resources for use by the first network node to communicate via at least one of the first uplink carrier and the first downlink carrier that is paired with the first uplink carrier; and receiving second information indicative of second resources for use by the first network node to communicate via one or more second uplink carriers associated with the first downlink carrier but different from the first uplink carrier, wherein the first uplink carrier and the one or more second uplink carriers are, collectively, a plurality of candidate uplink carriers.
Aspect 16: The method of any of aspects 12 through 15, wherein participating in the wireless communication comprises: determine, while the first network node is in an idle mode, a first candidate uplink carrier from a plurality of candidate uplink carriers for a random access procedure; and determine, while the first network node is in a connected mode, a second candidate uplink carrier from the plurality of candidate uplink carriers for an uplink transmission.
Aspect 17: The method of aspect 16, wherein the idle mode and the connected mode are communication states of the first network node with respect to a second network node, communications during the connected mode are over resources that are allocated for use by the first network node, and communications during the idle mode are over resources that are allocated for common network node use.
Aspect 18: The method of any of aspects 12 through 17, wherein the first frequency band is a TDD band.
Aspect 19: A method of wireless communication performed by a first network node, comprising: receiving capability information, the capability information indicative of a capability of a second network node to communicate using a pair of carriers in different frequency bands, wherein the pair of carriers includes a first downlink carrier in a first frequency band and a first uplink carrier in a second frequency band that is different from the first frequency band; transmitting carrier information indicative of one or more downlink carriers and one or more uplink carriers for use by the second network node for wireless communication, wherein the one or more downlink carriers includes the first downlink carrier and the one or more uplink carriers includes the first uplink carrier, wherein the carrier information is based on the capability information; and participating in the wireless communication, in accordance with the carrier information, via the first downlink carrier and the first uplink carrier.
Aspect 20: The method of aspect 19, wherein the capability information includes a first indication that the second network node supports communications in the first frequency band and a second indication that the second network node supports communications in the second frequency band, the capability of the second network node to communicate using the pair of carriers is indicated by the first indication and the second indication.
Aspect 21: The method of any of aspects 19 through 20, wherein the capability information includes a first list of individual frequency bands in which the second network node supports both downlink communication and uplink communication via each of the individual frequency bands, and a second list of pairs of frequency bands in which the second network node supports, for each pair, downlink communication via a first pair component in a respective pair and uplink communication associated with the downlink communication, via a second pair component in the respective pair, the first frequency band and the second frequency band are one of the pairs of frequency bands included in the second list.
Aspect 22: The method of aspect 21, wherein the capability information is indicative of one or more first sets of features supported by the second network node and one or more second sets of features supported by the second network node, individual sets of the one or more first sets of features are associated with respective downlink frequency bands in the second list of pairs of frequency bands, and individual sets of the one or more second sets of features are associated with respective uplink frequency bands in the second list of pairs of frequency bands, the capability information indicates the one or more first sets of features and the one or more second sets of features separate from a third set of features supported by the second network node and each associated with a respective individual frequency band from the first list.
Aspect 23: The method of any of aspects 19 through 22, wherein the capability information includes a list of individual frequency bands in which the second network node supports both downlink communication and uplink communication via each of the individual frequency bands, and the list includes additional sets of uplink frequency bands, each set of uplink frequency bands associated with a respective one of the individual frequency bands in the list, the second frequency band is included in one of the additional sets of uplink frequency bands whose respective one of the individual frequency bands is the first frequency band.
Aspect 24: The method of aspect 23, wherein the capability information is indicative of one or more first sets of features supported by the second network node and each associated with a respective individual frequency band from the list, and the capability information is also indicative of one or more second sets of features supported by the second network node and each associated with at least one uplink frequency band of a respective set of the additional sets of uplink frequency bands.
Aspect 25: The method of any of aspects 19 through 24, wherein the first frequency band is a TDD band and the second frequency band is a FDD band or a SUL band.
Aspect 26: The method of any of aspects 19 through 25, wherein the one or more downlink carriers comprises a SDL carrier, and the first frequency band is a SDL band that includes the SDL carrier.
Aspect 27: The method of any of aspects 19 through 26, wherein transmitting the carrier information comprises: transmitting first information indicative of first resources for use by the first network node to communicate via at least one of the first uplink carrier and the first downlink carrier that is paired with the first uplink carrier; and transmitting second information indicative of second resources for use by the first network node to communicate via one or more second uplink carriers associated with the first downlink carrier but different from the first uplink carrier, wherein the first uplink carrier and the one or more second uplink carriers are, collectively, a plurality of candidate uplink carriers.
Aspect 28: The method of any of aspects 19 through 27, wherein participating in the wireless communication comprises: participating in a random access procedure with the second network node using a first candidate uplink carrier of a plurality of candidate uplink carriers; and receiving, after the random access procedure and while the second network node is in a connected mode, an uplink transmission via a second candidate uplink carrier from the plurality of candidate uplink carriers.
Aspect 29: The method of aspect 28, wherein an idle mode and the connected mode are communication states of the second network node with respect to the first network node, communications during the connected mode are over resources that are allocated for use by the second network node, and communications during the idle mode are over resources that are allocated for common network node use.
Aspect 30: A method of wireless communication performed by a first network node, comprising: receiving capability information, the capability information indicative of a capability of a second network node to communicate using a pair of carriers in a same frequency band, wherein the pair of carriers includes a first downlink carrier in a first frequency band and a first uplink carrier in the first frequency band; transmitting carrier information indicative of one or more downlink carriers and one or more uplink carriers for use by the first network node for wireless communication, wherein the one or more downlink carriers includes the first downlink carrier and the one or more uplink carriers includes the first uplink carrier and a second uplink carrier in the first frequency band, wherein the carrier information includes second carrier information that is based on the capability information and based on the first uplink carrier and the second uplink carrier being in the same frequency band; and participating in the wireless communication, in accordance with the carrier information, via the first downlink carrier and the second uplink carrier.
Aspect 31: The method of aspect 30, wherein the capability information includes a first indication that the first network node supports communications in the first frequency band and a second indication that the first network node supports communications in a second frequency band, the capability of the first network node to communicate using the pair of carriers is indicated by the first indication and the second indication.
Aspect 32: The method of any of aspects 30 through 31, wherein the second uplink carrier is a SUL carrier when the second network node is in an idle mode and an uplink component carrier for CA while the second network node is in a connected mode.
Aspect 33: The method of any of aspects 30 through 32, wherein receiving the carrier information comprises: transmitting first information indicative of first resources for use by the second network node to communicate via at least one of the first uplink carrier and the first downlink carrier that is paired with the first uplink carrier; and transmitting second information indicative of second resources for use by the second network node to communicate via one or more second uplink carriers associated with the first downlink carrier but different from the first uplink carrier, wherein the first uplink carrier and the one or more second uplink carriers are, collectively, a plurality of candidate uplink carriers.
Aspect 34: The method of any of aspects 30 through 33, wherein participating in the wireless communication comprises: participating in a random access procedure with the second network node using a first candidate uplink carrier of a plurality of candidate uplink carriers; and receiving, after the random access procedure and while the second network node is in a connected mode, an uplink transmission via a second candidate uplink carrier from the plurality of candidate uplink carriers.
Aspect 35: The method of aspect 34, wherein an idle mode and the connected mode are communication states of the second network node with respect to the first network node, communications during the connected mode are over resources that are allocated for use by the second network node, and communications during the idle mode are over resources that are allocated for common network node use.
Aspect 36: The method of any of aspects 30 through 35, wherein the first frequency band is a TDD band.
Aspect 37: A first network node for wireless communication, comprising: at least one communication interface; and at least one processor coupled to the communication interface, wherein the first network node is configured to perform a method of any of aspects 1 through 11.
Aspect 38: An apparatus comprising at least one means for performing a method of any of aspects 1 through 11.
Aspect 39: A non-transitory computer-readable medium having code for wireless communication stored thereon that, when executed by a first network node, causes the first network node to perform a method of any of aspects 1 through 11.
Aspect 40: A first network node for wireless communication, comprising: at least one communication interface; and at least one processor coupled to the communication interface, wherein the first network node is configured to perform a method of any of aspects 12 through 18.
Aspect 41: An apparatus comprising at least one means for performing a method of any of aspects 12 through 18.
Aspect 42: A non-transitory computer-readable medium having code for wireless communication stored thereon that, when executed by a first network node, causes the first network node to perform a method of any of aspects 12 through 18.
Aspect 43: A first network node for wireless communication, comprising: at least one communication interface; and at least one processor coupled to the communication interface, wherein the first network node is configured to perform a method of any of aspects 19 through 29.
Aspect 44: An apparatus comprising at least one means for performing a method of any of aspects 19 through 29.
Aspect 45: A non-transitory computer-readable medium having code for wireless communication stored thereon that, when executed by a first network node, causes the first network node to perform a method of any of aspects 19 through 29.
Aspect 46: A first network node for wireless communication, comprising: at least one communication interface; and at least one processor coupled to the communication interface, wherein the first network node is configured to perform a method of any of aspects 30 through 36.
Aspect 47: An apparatus comprising at least one means for performing a method of any of aspects 30 through 36.
Aspect 48: A non-transitory computer-readable medium having code for wireless communication stored thereon that, when executed by a first network node, causes the first network node to perform a method of any of aspects 30 through 36.
Aspect 49: A method of wireless communication performed by a first network node, comprising: receiving first information indicative of first resources for use by the first network node to communicate via at least one of a first uplink carrier and a first downlink carrier that is paired with the first uplink carrier in a same frequency band; receiving second information indicative of second resources for use by the first network node to communicate via one or more second uplink carriers associated with the first downlink carrier but different from the first uplink carrier, wherein the first uplink carrier and the one or more second uplink carriers are, collectively, a plurality of candidate uplink carriers; determining, while the first network node is in an idle mode, a first candidate uplink carrier from the plurality of candidate uplink carriers for a random access procedure; and determining, while the first network node is in a connected mode, a second candidate uplink carrier from the plurality of candidate uplink carriers for an uplink transmission.
Aspect 50: The method of aspect 49, wherein receiving the second information comprises: receiving a broadcast or dedicated message that includes the second information, wherein the second information is indicative of at least one of frequency information for each of the one or more second uplink carriers, uplink bandwidth part information for each of the one or more second uplink carriers, or timer information that pertains to a time alignment for each of the one or more second uplink carriers.
Aspect 51: The method of any of aspects 49 through 50, wherein the second information includes criteria for determination, by the first network node, of the first candidate uplink carrier.
Aspect 52: The method of aspect 51, wherein the criteria includes a first received power threshold, and wherein determining the first candidate uplink carrier comprises: determining a received power value; and determining either the first uplink carrier or one of the one or more second uplink carriers as the first candidate uplink carrier based on a first comparison of the received power value and the first received power threshold.
Aspect 53: The method of aspect 52, wherein the criteria includes one or more second received power thresholds and an association between each of the one or more second uplink carriers and a respective range of received power values, each respective range of received power values bounded by at least one of the one or more second received power thresholds.
Aspect 54: The method of aspect 53, wherein the determination of the first candidate uplink carrier from among the one or more second uplink carriers is based on a second comparison of the received power value and the one or more second received power thresholds.
Aspect 55: The method of any of aspects 49 through 54, further comprising: performing the random access procedure using the first candidate uplink carrier and the first downlink carrier, wherein one of the one or more second uplink carriers is the first candidate uplink carrier.
Aspect 56: The method of aspect 55, wherein performing the random access procedure comprises: transmitting a random access message via the first candidate uplink carrier; monitoring a downlink channel for a random access response message transmitted via the first downlink carrier, wherein the random access response message schedules transmission of an uplink shared channel message via the first candidate uplink carrier; transmitting the uplink shared channel message via the first candidate uplink carrier based on the random access response message; and receiving a contention resolution downlink message via the first downlink carrier based on the uplink shared channel message.
Aspect 57: The method of any of aspects 55 through 56, wherein performing the random access procedure comprises: transmitting a random access message via the first candidate uplink carrier; and monitoring a downlink channel for a downlink message transmitted via the first downlink carrier based on the random access message.
Aspect 58: The method of any of aspects 49 through 57, wherein determining the second candidate uplink carrier comprises: determining the first uplink carrier as the second candidate uplink carrier, wherein determination of the first uplink carrier is based on one of the one or more second uplink carriers being determined as the first candidate uplink carrier for the random access procedure.
Aspect 59: The method of aspect 58, further comprising: transmitting, via the first uplink carrier, a feedback message in response to conclusion of the random access procedure; and transmitting the uplink transmission via at least the first uplink carrier.
Aspect 60: The method of any of aspects 58 through 59, further comprising: transmitting, via the first candidate uplink carrier, a feedback message in response to conclusion of the random access procedure; and transmitting the uplink transmission via at least the first candidate uplink carrier.
Aspect 61: The method of any of aspects 58 through 60, wherein the uplink transmission is a plurality of uplink transmissions, further comprising: transmitting the plurality of uplink transmissions via at least the first uplink carrier, wherein a first value of a first carrier information field used to schedule a downlink shared channel message on the first downlink carrier is a same as a second value of a second carrier information field used to schedule one of the plurality of uplink transmissions via the first uplink carrier, and wherein the first value is different from a third value of a third carrier information field used to schedule another of the plurality of uplink transmissions via one of the one or more second uplink carriers.
Aspect 62: The method of any of aspects 49 through 61, wherein determining the second candidate uplink carrier comprises: determining one of the one or more second uplink carriers as the second candidate uplink carrier, wherein determination of the one of the one or more second uplink carriers is based on the one of the one or more second uplink carriers being determined as the first candidate uplink carrier for the random access procedure.
Aspect 63: The method of aspect 62, wherein the uplink transmission is a plurality of uplink transmissions, further comprising: transmitting the plurality of uplink transmissions via at least the one of the one or more second uplink carriers, wherein a first value of a first carrier information field used to schedule a downlink shared channel message on the first downlink carrier is different from a second value of a second carrier information field used to schedule one of the plurality of uplink transmissions via the one of the one or more second uplink carriers, and wherein the first value is different from a third value of a third carrier information field used to schedule another of the plurality of uplink transmissions via another of the one or more second uplink carriers.
Aspect 64: The method of any of aspects 62 through 63, further comprising: transmitting, via the one of the one or more second uplink carriers, a feedback message in response to conclusion of the random access procedure; and transmitting the uplink transmission via at least the one of the one or more second uplink carriers.
Aspect 65: The method of any of aspects 49 through 64, wherein the uplink transmission includes one or more of an uplink control channel message, an uplink shared channel message, or a random access channel message.
Aspect 66: The method of any of aspects 49 through 65, wherein the second candidate uplink carrier is an uplink component carrier for carrier aggregation while the first network node is in the connected mode.
Aspect 67: The method of any of aspects 49 through 66, wherein the second candidate uplink carrier is associated with a corresponding set of feedback processes.
Aspect 68: The method of any of aspects 49 through 67, wherein a combination of one or more second candidate uplink carriers including the second candidate uplink carrier is based on a capability of the first network node.
Aspect 69: The method of any of aspects 49 through 68, further comprising: switching from the second candidate uplink carrier to a different second candidate uplink carrier based on a capability of the first network node.
Aspect 70: The method of any of aspects 49 through 69, wherein the second candidate uplink carrier is scheduled based on a downlink message associated with a same cell.
Aspect 71: The method of any of aspects 49 through 70, wherein half-duplex operation or full-duplex operation between the first downlink carrier and the second candidate uplink carrier is based on a capability of the first network node.
Aspect 72: The method of any of aspects 49 through 71, wherein the first uplink carrier and the one or more second uplink carriers are in different frequency bands.
Aspect 73: The method of any of aspects 49 through 72, wherein the first uplink carrier and the one or more second uplink carriers are in a same frequency band.
Aspect 74: The method of any of aspects 49 through 73, wherein the first uplink carrier and the one or more second uplink carriers are for communication between the first network node and different cells.
Aspect 75: The method of any of aspects 49 through 74, wherein the first uplink carrier and the one or more second uplink carriers are for communication between the first network node and a same cell.
Aspect 76: The method of any of aspects 49 through 75, wherein the idle mode and the connected mode are communication states of the first network node with respect to a second network node, wherein communications during the connected mode are over resources that are allocated for use by the first network node, and wherein communications during the idle mode are over resources that are allocated for common network node use.
Aspect 77: The method of any of aspects 49 through 76, wherein the second candidate uplink carrier is a plurality of second candidate uplink carriers of the plurality of candidate uplink carriers.
Aspect 78: A method of wireless communication performed by a first network node, comprising: transmitting first information indicative of first resources for use by a second network node to communicate via at least one of a first uplink carrier and a first downlink carrier that is paired with the first uplink carrier in a same frequency band; transmitting second information indicative of second resources for use by the second network node to communicate via one or more second uplink carriers associated with the first downlink carrier but different from the first uplink carrier, wherein the first uplink carrier and the one or more second uplink carriers are, collectively, a plurality of candidate uplink carriers; participating in a random access procedure with the second network node using a first candidate uplink carrier of the plurality of candidate uplink carriers; and receiving, after the random access procedure and while the second network node is in a connected mode, an uplink transmission via a second candidate uplink carrier from the plurality of candidate uplink carriers.
Aspect 79: The method of aspect 78, wherein transmitting the second information, comprises: transmitting a broadcast or dedicated message that includes the second information, wherein the second information is indicative of at least one of frequency information for each of the one or more second uplink carriers, uplink bandwidth part information for each of the one or more second uplink carriers, or timer information that pertains to a time alignment for each of the one or more second uplink carriers.
Aspect 80: The method of any of aspects 78 through 79, wherein the second information includes criteria for determination, by the second network node, of the first candidate uplink carrier.
Aspect 81: The method of aspect 80, wherein the criteria includes a first received power threshold, and wherein the determination of either the first uplink carrier or one of the one or more second uplink carriers as the first candidate uplink carrier is based on a first comparison of a received power value and the first received power threshold.
Aspect 82: The method of aspect 81, wherein the criteria includes one or more second received power thresholds and an association between each of the one or more second uplink carriers and a respective range of received power values, each respective range of received power values bounded by at least one of the one or more second received power thresholds.
Aspect 83: The method of aspect 82, wherein the determination of the first candidate uplink carrier from among the one or more second uplink carriers is based on a second comparison of the received power value and the one or more second received power thresholds.
Aspect 84: The method of any of aspects 78 through 83, wherein participating in the random access procedure comprises: participating in the random access procedure using the first candidate uplink carrier and the first downlink carrier, wherein one of the one or more second uplink carriers is the first candidate uplink carrier.
Aspect 85: The method of aspect 84, wherein participating in the random access procedure comprises: receiving a random access message via the first candidate uplink carrier; transmitting a random access response message via the first downlink carrier, wherein the random access response message schedules transmission of an uplink shared channel message via the first candidate uplink carrier; receiving the uplink shared channel message via the first candidate uplink carrier based on the random access response message; and transmitting a contention resolution downlink message via the first downlink carrier for a contention resolution procedure based on the uplink shared channel message.
Aspect 86: The method of any of aspects 84 through 85, wherein participating in the random access procedure comprises: receiving a random access message via the first candidate uplink carrier; and transmitting a downlink message via the first downlink carrier based on the random access message.
Aspect 87: The method of any of aspects 78 through 86, wherein at least the first uplink carrier is determined as the second candidate uplink carrier based on one of the one or more second uplink carriers being determined as the first candidate uplink carrier for the random access procedure.
Aspect 88: The method of aspect 87, further comprising: receiving, via the first uplink carrier, a feedback message in response to conclusion of the random access procedure; and receiving the uplink transmission via at least the first uplink carrier.
Aspect 89: The method of any of aspects 87 through 88, further comprising: receiving, via the first candidate uplink carrier, a feedback message in response to conclusion of the random access procedure; and receiving the uplink transmission via at least the first candidate uplink carrier.
Aspect 90: The method of any of aspects 87 through 89, wherein the uplink transmission is a plurality of uplink transmissions, further comprising: receiving the plurality of uplink transmissions via at least the first uplink carrier, wherein a first value of a first carrier information field used to schedule a downlink shared channel message on the first downlink carrier is a same as a second value of a second carrier information field used to schedule one of the plurality of uplink transmissions via the first uplink carrier, and wherein the first value is different from a third value of a third carrier information field used to schedule another of the plurality of uplink transmissions via one of the one or more second uplink carriers.
Aspect 91: The method of any of aspects 78 through 90, wherein at least one of the one or more second uplink carriers is determined as the second candidate uplink carrier based on the one of the one or more second uplink carriers being determined as the first candidate uplink carrier for the random access procedure.
Aspect 92: The method of aspect 91, wherein the uplink transmission is a plurality of uplink transmissions, further comprising: receiving the plurality of uplink transmissions via at least the one of the one or more second uplink carriers, wherein a first value of a first carrier information field used to schedule a downlink shared channel message on the first downlink carrier is different from a second value of a second carrier information field used to schedule one of the plurality of uplink transmissions via the one of the one or more second uplink carriers, and wherein the first value is different from a third value of a third carrier information field used to schedule another of the plurality of uplink transmissions via another of the one or more second uplink carriers.
Aspect 93: The method of any of aspects 91 through 92, further comprising: receiving, via the one of the one or more second uplink carriers, a feedback message in response to conclusion of the random access procedure; and receiving the uplink transmission via at least the one of the one or more second uplink carriers.
Aspect 94: The method of any of aspects 78 through 93, wherein the uplink transmission includes one or more of an uplink control channel message, an uplink shared channel message, or a random access channel message.
Aspect 95: The method of any of aspects 78 through 94, wherein the second candidate uplink carrier is an uplink component carrier for carrier aggregation while the second network node is in the connected mode.
Aspect 96: The method of any of aspects 78 through 95, wherein the second candidate uplink carrier is associated with a corresponding set of feedback processes.
Aspect 97: The method of any of aspects 78 through 96, wherein a combination of one or more second candidate uplink carriers including the second candidate uplink carrier is based on a capability of the second network node.
Aspect 98: The method of any of aspects 78 through 97, wherein the second candidate uplink carrier is scheduled based on a downlink message associated with a same cell.
Aspect 99: The method of any of aspects 78 through 98, wherein half-duplex operation or full-duplex operation between the first downlink carrier and the second candidate uplink carrier is based on a capability of the second network node.
Aspect 100: The method of any of aspects 78 through 99, wherein the first uplink carrier and the one or more second uplink carriers are in different frequency bands.
Aspect 101: The method of any of aspects 78 through 100, wherein the first uplink carrier and the one or more second uplink carriers are in a same frequency band.
Aspect 102: The method of any of aspects 78 through 101, wherein the first uplink carrier and the one or more second uplink carriers are for communication between the second network node and different cells.
Aspect 103: The method of any of aspects 78 through 102, wherein the first uplink carrier and the one or more second uplink carriers are for communication between the second network node and a same cell.
Aspect 104: The method of any of aspects 78 through 103, wherein an idle mode and the connected mode are communication states of the first network node with respect to the second network node, wherein communications during the connected mode are over resources that are allocated for use by the second network node, and wherein communications during the idle mode are over resources that are allocated for common network node use.
Aspect 105: An apparatus comprising at least one processor; at least one memory coupled with the at least one processor; and instructions stored in the at least one memory and executable by the at least one processor to cause the apparatus to perform a method of any of aspects 49 through 77.
Aspect 106: An apparatus comprising at least one means for performing a method of any of aspects 49 through 77.
Aspect 107: A non-transitory computer-readable medium storing code the code comprising instructions executable by a processor to perform a method of any of aspects 49 through 77.
Aspect 108: An apparatus comprising at least one processor; at least one memory coupled with the at least one processor; and instructions stored in the at least one memory and executable by the at least one processor to cause the apparatus to perform a method of any of aspects 78 through 104.
Aspect 109: An apparatus comprising at least one means for performing a method of any of aspects 78 through 104.
Aspect 110: A non-transitory computer-readable medium storing code the code comprising instructions executable by a processor to perform a method of any of aspects 78 through 104. The methods described herein describe possible implementations, and the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

Any functions or operations described herein as being capable of being performed by a processor may be performed by multiple processors that, individually or collectively, are capable of performing the described functions or operations. For example, the functions described herein may be performed by multiple processors, each tasked with at least a subset of the described functions, such that, collectively, the multiple processors perform all of the described functions. As such, the described functions can be performed by a single processor or a group of processors functioning together (i.e., collectively) to perform the described functions, where any one processor performs at least a subset of the described functions.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first network node for wireless communication, comprising:
at least one communication interface; and
at least one processor coupled to the communication interface, wherein the first network node is configured to:
transmit capability information, the capability information indicative of a capability of the first network node to communicate using a pair of carriers in different frequency bands, wherein the pair of carriers includes a first downlink carrier in a first frequency band and a first uplink carrier in a second frequency band that is different from the first frequency band;
receive carrier information indicative of one or more downlink carriers and one or more uplink carriers for use by the first network node for wireless communication, wherein the one or more downlink carriers includes the first downlink carrier and the one or more uplink carriers includes the first uplink carrier, wherein the carrier information is based on the capability information; and
participate in the wireless communication, in accordance with the carrier information, via the first downlink carrier and the first uplink carrier.

2. The first network node of claim 1, wherein the capability information includes a first indication that the first network node supports communications in the first frequency band and a second indication that the first network node supports communications in the second frequency band, the capability of the first network node to communicate using the pair of carriers is indicated by the first indication and the second indication.

3. The first network node of claim 1, wherein the capability information includes a first list of individual frequency bands in which the first network node supports both downlink communication and uplink communication via each of the individual frequency bands, and a second list of pairs of frequency bands in which the first network node supports, for each pair, downlink communication via a first pair component in a respective pair and uplink communication associated with the downlink communication, via a second pair component in the respective pair, the first frequency band and the second frequency band are one of the pairs of frequency bands included in the second list.

4. The first network node of claim 3, wherein the capability information is indicative of one or more first sets of features supported by the first network node and one or more second sets of features supported by the first network node, individual sets of the one or more first sets of features are associated with respective downlink frequency bands in the second list of pairs of frequency bands, and individual sets of the one or more second sets of features are associated with respective uplink frequency bands in the second list of pairs of frequency bands, the capability information indicates the one or more first sets of features and the one or more second sets of features separate from a third set of features supported by the first network node and each associated with a respective individual frequency band from the first list.

5. The first network node of claim 1, wherein the capability information includes a list of individual frequency bands in which the first network node supports both downlink communication and uplink communication via each of the individual frequency bands, and the list includes additional sets of uplink frequency bands, each set of uplink frequency bands associated with a respective one of the individual frequency bands in the list, the second frequency band is included in one of the additional sets of uplink frequency bands whose respective one of the individual frequency bands is the first frequency band.

6. The first network node of claim 5, wherein the capability information is indicative of one or more first sets of features supported by the first network node and each associated with a respective individual frequency band from the list, and the capability information is also indicative of one or more second sets of features supported by the first network node and each associated with at least one uplink frequency band of a respective set of the additional sets of uplink frequency bands.

7. The first network node of claim 1, wherein the first frequency band is a time-division duplexing band and the second frequency band is a frequency-division duplexing band or a supplementary uplink band.

8. The first network node of claim 1, wherein the one or more downlink carriers comprises a supplementary downlink carrier, and the first frequency band is a supplementary downlink band that includes the supplementary downlink carrier.

9. A first network node for wireless communication, comprising:
at least one communication interface; and
at least one processor coupled to the communication interface, wherein the first network node is configured to:
transmit capability information, the capability information indicative of a capability of the first network node to communicate using a pair of carriers in a same frequency band, wherein the pair of carriers includes a first downlink carrier in a first frequency band and a first uplink carrier in the first frequency band;
receive carrier information indicative of one or more downlink carriers and one or more uplink carriers for use by the first network node for wireless communication, wherein the one or more downlink carriers includes the first downlink carrier and the one or more uplink carriers includes the first uplink carrier and a second uplink carrier in the first frequency band, wherein the carrier information includes second carrier information that is based on the capability information and based on the first uplink carrier and the second uplink carrier being in the same frequency band; and
participate in the wireless communication, in accordance with the carrier information, via the first downlink carrier and the second uplink carrier.

10. The first network node of claim 9, wherein the capability information includes a first indication that the first network node supports communications in the first frequency band and a second indication that the first network node supports communications in a second frequency band, the capability of the first network node to communicate using the pair of carriers is indicated by the first indication and the second indication.

11. The first network node of claim 9, wherein the second uplink carrier is a supplementary uplink carrier when the first network node is in an idle mode and an uplink component carrier for carrier aggregation while the first network node is in a connected mode.

12. The first network node of claim 9, wherein the first frequency band is a time-division duplexing band.

13. A first network node for wireless communication, comprising:
at least one communication interface; and
at least one processor coupled to the communication interface, wherein the first network node is configured to:
receive capability information, the capability information indicative of a capability of a second network node to communicate using a pair of carriers in different frequency bands, wherein the pair of carriers includes a first downlink carrier in a first frequency band and a first uplink carrier in a second frequency band that is different from the first frequency band;
transmit carrier information indicative of one or more downlink carriers and one or more uplink carriers for use by the second network node for wireless communication, wherein the one or more downlink carriers includes the first downlink carrier and the one or more uplink carriers includes the first uplink carrier, wherein the carrier information is based on the capability information; and
participate in the wireless communication, in accordance with the carrier information, via the first downlink carrier and the first uplink carrier.

14. The first network node of claim 13, wherein the capability information includes a first indication that the second network node supports communications in the first frequency band and a second indication that the second network node supports communications in the second frequency band, the capability of the second network node to communicate using the pair of carriers is indicated by the first indication and the second indication.

15. The first network node of claim 13, wherein the capability information includes a first list of individual frequency bands in which the second network node supports both downlink communication and uplink communication via each of the individual frequency bands, and a second list of pairs of frequency bands in which the second network node supports, for each pair, downlink communication via a first pair component in a respective pair and uplink communication associated with the downlink communication, via a second pair component in the respective pair, the first frequency band and the second frequency band are one of the pairs of frequency bands included in the second list.

16. The first network node of claim 15, wherein the capability information is indicative of one or more first sets of features supported by the second network node and one or more second sets of features supported by the second network node, individual sets of the one or more first sets of features are associated with respective downlink frequency bands in the second list of pairs of frequency bands, and individual sets of the one or more second sets of features are associated with respective uplink frequency bands in the second list of pairs of frequency bands, the capability information indicates the one or more first sets of features and the one or more second sets of features separate from a third set of features supported by the second network node and each associated with a respective individual frequency band from the first list.

17. The first network node of claim 13, wherein the capability information includes a list of individual frequency bands in which the second network node supports both downlink communication and uplink communication via each of the individual frequency bands, and the list includes additional sets of uplink frequency bands, each set of uplink frequency bands associated with a respective one of the individual frequency bands in the list, the second frequency band is included in one of the additional sets of uplink frequency bands whose respective one of the individual frequency bands is the first frequency band.

18. The first network node of claim 17, wherein the capability information is indicative of one or more first sets of features supported by the second network node and each associated with a respective individual frequency band from the list, and the capability information is also indicative of one or more second sets of features supported by the second network node and each associated with at least one uplink frequency band of a respective set of the additional sets of uplink frequency bands.

19. The first network node of claim 13, wherein the first frequency band is a time-division duplexing band and the second frequency band is a frequency-division duplexing band or a supplementary uplink band.

20. The first network node of claim 13, wherein the one or more downlink carriers comprises a supplementary downlink carrier, and the first frequency band is a supplementary downlink band that includes the supplementary downlink carrier.

21-30. (canceled)
